(19) United States
(12) Patent Application Publication
(10) Pub. No.: US 2006/0115768 A1
(43) Pub. Date: Jun. 1, 2006

(54) Lithographic printing plate precursor, plate-making method, and lithographic printing method

(75) Inventors: Hidekazu Oohashi, Haibara-gun (JP); Yu Iwai, Haibara-gun (JP)

Correspondence Address: BIRCH STEWART KOLASCH & BIRCH, PO BOX 747, FALLS CHURCH, VA, 22040-0747, US

(73) Assignee: FUJI PHOTO FILM CO. LTD

(21) Appl. No.: 11/288,240

(22) Filed: Nov. 29, 2005

(30) Foreign Application Priority Data
Nov. 30, 2004 (JP) P.2004-346976
Jan. 31, 2005 (JP) P.2005-023390

(51) Int. Cl. G03C 1/76

(52) U.S. Cl. 430/270.1

(57) ABSTRACT

A lithographic printing plate precursor comprising a support and a layer containing a compound represented by the formula having a specific structure that is discolored by heat or a photochromic compound, and a lithographic printing method using the lithographic printing plate precursor.

### BACKGROUND OF THE INVENTION

1. Field of the Invention

The present invention relates to a lithographic printing plate precursor having a color image-forming layer, a plate making method using the same, and a lithographic printing method. Specifically, the invention relates to a lithographic printing plate precursor capable of direct plate making by infrared laser scanning based on digital signals of computer, having good visibility after exposure, and capable of printing without undergoing development process, and also relates to a plate making method using the same and a lithographic printing method.

2. Background Art

Lithographic printing plates generally comprise a lipophilic image area receiving ink and a hydrophilic non-image area receiving a fountain solution in printing process. Plate making of conventional lithographic printing plates has been generally performed by mask-exposing a PS plate comprising a hydrophilic support having provided thereon a lipophilic photosensitive resin layer through a lith film and dissolving and removing unnecessary areas with a developing solution.

In recent years, techniques of electronically processing an image as digital data, accumulating and outputting with a computer have prevailed. Accordingly, it is preferred to perform image-forming process in accordance with digital image data by scanning exposure with highly directional actinic radiations such as laser rays to directly form an image on a lithographic printing plate precursor without using a lith film. Such a technique of making a printing plate from digital image data without using a lith film is called a computer to plate (CTP) technique.

In making a printing plate of conventional PS plate by a computer to plate (CTP) technique, there is a problem that the wavelength region of laser rays and the photosensitive wavelength region of photosensitive resins do not coincide with each other.

Furthermore, a process of dissolving and removing unnecessary areas (a development process) after exposure is indispensable in conventional PS plates. In addition, post-treatment processes, such as washing a development-processed printing plate with water, processing with a rinsing solution containing a surfactant, and processing with a desensitizing solution containing gum arabic and a starch derivative are also necessary. It is an important problem under investigation of the conventional PS plates that these additional wet processes are indispensable. Even if the former half (image-forming process) of the plate-making process is simplified by the digital process, the effect by simplification is insufficient so far as the latter half (development process) is complicated by wet processes.

The consideration of the global environment is a great interest in the industry at large especially in recent years, so that it is desired to simplify wet post-processes or shift wet processes to dry processes for the environmental protection.

Accordingly, as a method of doing away with the wet processes, there is a method called on-press development comprising mounting an exposed printing plate precursor on the cylinder of a press, and removing unnecessary areas of the printing plate precursor by supplying a fountain solution and water while rotating the cylinder. That is, this is a method of mounting a printing plate precursor after exposure as it is on a press and completing the process during ordinary printing process.

A lithographic printing plate precursor suitable for the on-press development is required to have an image-forming layer (a photosensitive layer) soluble in a fountain solution and an ink solvent, and have a handling property in a bright room suitable for development on a press in a bright room.

To satisfy such a requirement was substantially impossible for conventional PS plates.

For satisfying such a requirement, a lithographic printing plate precursor comprising a hydrophilic support having provided thereon a photosensitive layer comprising thermoplastic hydrophobic polymer fine particles dispersed in a hydrophilic binder polymer is proposed (e.g., refer to patent literature 1: Japanese Patent No. 2938397). The printing plate of the lithographic printing plate precursor can be made according to on-press development by exposing the lithographic printing plate precursor with infrared laser to thereby coalesce (fuse) the thermoplastic hydrophobic polymer fine particles by the heat generated by light-heat conversion to thereby form an image, mounting the printing plate precursor on the cylinder of a press, and supplying at least either a fountain solution or ink. The photosensitive region of the lithographic printing plate precursor is in the infrared region, so that handleable in a bright room.

An image formed by coalescence (fusion) of thermoplastic hydrophobic polymer fine particles is, however, insufficient in strength and there is a problem in the span of press life as a printing plate.

Lithographic printing plate precursors containing a polymerizable compound (a polymerizable monomer) encapsulated in microcapsules in place of thermoplastic fine particles are proposed (e.g., refer to patent literatures 2 to 7: JP-A-2000-211262 (The term “JP-A” as used herein refers to an “unexamined published Japanese patent application”.), JP-A-2001-277740, JP-A-2002-29162, JP-A-2002-46361, JP-A-2002-137562, and JP-A-2002-326470, respectively). These printing plate precursors proposed are advantageous in that the images of polymers formed by the reaction of polymerizable compounds are more excellent in strength than the images formed by fusion of fine particles.

Since polymerizable compounds are high in reactivity, many methods are proposed to separate polymerizable compounds by using microcapsules (e.g., refer to patent literatures 2 to 7). It is also proposed to use a heat decomposable polymer as the shell of microcapsules.

In general, as the preprocess of mounting a printing plate on a press, the inspection and discrimination of images on a printing plate, i.e., works for ascertaining whether the images fitting for the purpose are recorded on the printing plate or not, and for what a color of ink the plate is, are operated. In ordinary lithographic printing plate precursors including a development process, an image can be easily ascertained after plate making (after development process) and before printing (before a printing plate is mounted on a press) generally by coloring an image-forming layer in advance.

However, in an on-press development type or non-processing type (a non-development type) lithographic printing plate precursor not accompanied by a development process before printing, the discrimination of a plate cannot be done, since there is no image on the printing plate when the printing plate is mounted on a press, which sometimes leads to the error in operation. In particular in multicolor printing, it is important for printing work to be capable of distinguishing whether register marks for register are clearly written or not so as to be distinguished. The invention aims at solving this problem.

### SUMMARY OF THE INVENTION

That is, an object of the invention is to provide an on-press development type or non-processing type (a non-development type) lithographic printing plate precursor capable of obtaining a printing-out image having great visibility capable of easily discriminating the plate at the stage of imagewise heating or irradiating with a laser, preferably an infrared laser. Another object of the invention is to provide a plate-making method of such an on-press development type lithographic printing plate precursor, and a further object is to provide a lithographic printing method using the lithographic printing plate precursor.

The present invention is as follows.

1. A lithographic printing plate precursor comprising a support and a layer containing a compound discolored by heat and represented by the following formula (1): 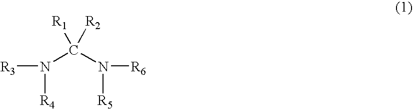
wherein R₁, R₂, R₃, R₄, R₅ and R₆ each represents a hydrogen atom, an alkyl group, an aryl group, an alkenyl group, an alkynyl group, an acyl group, an alkyloxy group, an alkenyloxy group, an alkynyloxy group, an aryloxy group, a sulfonyl group, a sulfinyl group, an alkoxycarbonyl group, an aryloxycarbonyl group, an alkylthio group, an arylthio group, an acyloxy group, a sulfonyloxy group, a carbamoyloxy group, an amino group, an imino group, a carbamoyl group, a sulfamoyl group, a hydroxyl group, a nitro group, a cyano group, a carboxyl group or a heterocyclic group, and arbitrary combination of R₁ to R₄ may be bonded to form a ring, provided that R₅ and R₆ may be bonded to each other to form a ring together, but R₅ and R₆ do not form a ring with any of R₁ to R₄.

2. The lithographic printing plate precursor as described in the item 1, wherein the compound discolored by heat and represented by formula (1) is represented by the following formula (1a): 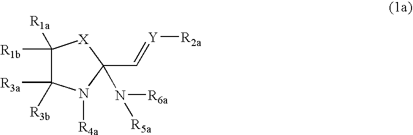
wherein R₁ₐ, R_{1b}, R₃ₐ and R_{3b} each represents a hydrogen atom, an alkyl group, an aryl group, an alkenyl group, an alkynyl group, an acyl group, an alkyloxy group, an alkenyloxy group, an alkynyloxy group, an aryloxy group, a sulfonyl group, a sulfinyl group, an alkoxycarbonyl group, an aryloxycarbonyl group, an alkylthio group, an arylthio group, an acyloxy group, a sulfonyloxy group, a carbamoyloxy group, an amino group, a carbamoyl group, a sulfamoyl group, a hydroxyl group, a nitro group, a cyano group, a carboxyl group, a heterocyclic group, or a halogen atom, and R₁ₐ, R_{1b}, R₃ₐ and R_{3b} may be bonded to each other to form a ring; R₂ₐ represents an alkyl group, an aryl group, an alkenyl group, an alkynyl group, an acyl group, an alkyloxy group, an alkenyloxy group, an alkynyloxy group, an aryloxy group, a sulfonyl group, a sulfinyl group, an alkoxycarbonyl group, an aryloxycarbonyl group, an alkylthio group, an arylthio group, an acyloxy group, a sulfonyloxy group, a carbamoyloxy group, an amino group, a carbamoyl group, a sulfamoyl group, a hydroxyl group, a nitro group, a cyano group, a carboxyl group, a heterocyclic group, or a halogen atom; R₄ₐ represents an alkyl group or an aryl group; R₅ₐ and R₆ₐ each represents a hydrogen atom or an alkyl group, and R₅ₐ and R₆ₐ may be bonded to each other to form a ring; X represents —C(CH₃)₂—, —O—, —S— or —N(R₇ₐ)—; R₇ₐ represents an alkyl group, an aryl group, an alkenyl group, an alkynyl group, an acyl group, an alkyloxy group, an alkenyloxy group, an alkynyloxy group, an aryloxy group, a sulfonyl group, a sulfinyl group, an alkoxycarbonyl group, an aryloxycarbonyl group, an alkylthio group, an arylthio group, an acyloxy group, a sulfonyloxy group, a carbamoyloxy group, an amino group, a carbamoyl group, a sulfamoyl group, a hydroxyl group, a nitro group, a cyano group, a carboxyl group, a heterocyclic group, or a halogen atom; and Y represents ═CH— or ═N—.

3. The lithographic printing plate precursor as described in the item 1 or 2, wherein the layer containing the compound discolored by heat and represented by formula (1) further contains an infrared absorber.

4. The lithographic printing plate precursor as described in the item 3, wherein the layer containing the compound discolored by heat and represented by formula (1) further contains a radical polymerization initiator and a radical polymerizable monomer.

5. The lithographic printing plate precursor as described in the item 4, wherein at least one of the compound discolored by heat and represented by formula (1), the infrared absorber, the radical polymerization initiator and the radical polymerizable monomer is encapsulated in a microcapsule.

6. The lithographic printing plate precursor as described in any one of the items 1 to 5, which is capable of printing by being mounted on a printing press without undergoing development processing after image recording, or by image recording after being mounted on a printing press.

7. A lithographic printing plate precursor comprising a support and an image-forming layer containing a compound represented by the following formula (2): 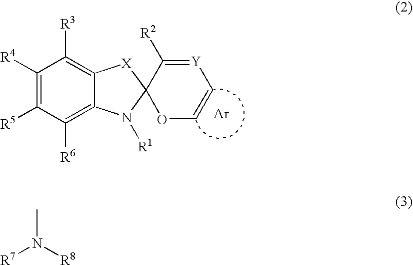
wherein X represents —C(CH₃)₂—, —S—, —SO₂—, —O—, —Se—, —Te— or —N(R¹)—; Y represents ═CH— or ═N—; Ar represents an aromatic ring or a heterocyclic aromatic ring, which contain at least one of an alkyloxy group, an aryloxy group, an alkylthio group, an arylthio group and a group represented by the above formula (3) in the ring; R², R³, R⁴, R¹ and R⁶ each represents a hydrogen atom, an alkyl group, an alkenyl group, an alkynyl group, an alkyloxy group, an aryloxy group, an alkylcarbonyloxy group, an arylcarbonyloxy group, a hydroxyl group, an alkylthio group, an arylthio group, a mercapto group, an alkylcarbonyl group, an arylcarbonyl group, an alkyloxycarbonyl group, an aryloxycarbonyl group, a carboxyl group, an amino group, a cyano group, a nitro group, an amido group, a sulfo group, an alkylsulfonyl group, an arylsulfonyl group, an alkyloxy-sulfonyl group, an aryloxysulfonyl group, an alkylsulfonyloxy group, an arylsulfonyloxy group, a silyl group, a urea group, a urethane group or a halogen atom; R¹ represents a hydrogen atom, an alkyl group, an aryl group, an alkylcarbonyl group, an arylcarbonyl group, an alkyloxycarbonyl group, an aryloxycarbonyl group, a carboxyl group, a sulfo group, an alkylsulfonyl group, an arylsulfonyl group, an alkyloxy-sulfonyl group, an aryloxysulfonyl group, or a silyl group; R³ and R⁴, R⁴ and R⁵, R⁵ and R⁶, and R⁶ and R¹ may be bonded to each other to form a ring; and R⁷ and R⁸ each represents a hydrogen atom, an alkyl group, an aryl group, an alkylcarbonyl group, an arylcarbonyl group, an alkyloxycarbonyl group, an aryloxycarbonyl group, a carboxyl group, a sulfo group, an alkylsulfonyl group or an arylsulfonyl group, and R⁷ and R⁸ may be bonded to each other to form a ring.

8. The lithographic printing plate precursor as described in the item 7, wherein the image-forming layer further contains an acid generator.

9. The lithographic printing plate precursor as described in the items 7 or 8, wherein the image-forming layer is an image-forming layer capable of image recording upon infrared laser exposure, and the lithographic printing plate precursor is capable of printing by being mounted on a printing press without undergoing development processing after image recording, or by image recording after being mounted on a printing press.

10. The lithographic printing plate precursor as described in any one of the items 7 to 9, wherein the image-forming layer further contains an infrared absorber, a radical polymerization initiator and a radical polymerizable monomer.

11. The lithographic printing plate precursor as described in any one of the items 7 to 10, wherein at least one component contained in the image-forming layer is encapsulated in a microcapsule.

12. A plate-making method of a lithographic printing plate precursor, which comprises: mounting the lithographic printing plate precursor described in any one of the items 7 to 11 on a printing press and imagewise exposing with an infrared laser or mounting the lithographic printing plate precursor on a printing press after imagewise exposure with an infrared laser; and then supplying printing ink and a fountain solution to the lithographic printing plate precursor to remove the infrared laser-unexposed area of the image-forming layer.

13. A lithographic printing method comprising: mounting the lithographic printing plate precursor described in any one of the items 1 to 11 on a printing press and imagewise exposing with an infrared laser or mounting the lithographic printing plate precursor on a printing press after imagewise exposure with an infrared laser; supplying printing ink and a fountain solution to the lithographic printing plate precursor to remove the infrared laser-unexposed area of the image-forming layer; and performing printing with the obtained printing plate.

The invention can provide a lithographic printing plate precursor capable of forming a color image having good visibility with laser exposure. Further, the invention can provide a plate making method of the lithographic printing plate precursor by on-press development, and a lithographic printing method using the lithographic printing plate precursor.

### DETAILED DESCRIPTION OF THE INVENTION

The invention is described in detail below.

### Lithographic Printing Plate Precursor

The lithographic printing plate precursor in the invention is preferably a lithographic printing plate precursor capable of printing by being mounted on a press without development process after image recording, or being mounted on a press and then undergoing image recording. As such a lithographic printing plate precursor, (1) an on-press development type lithographic printing plate precursor, and (2) a non-processing (non-development) type lithographic printing plate precursor shown below are exemplified.

(1) On-Press Development Type Lithographic Printing Plate Precursor:

A lithographic printing plate precursor having an image forming layer (a photosensitive/heat-sensitive layer) whose solubility or dispersibility in a fountain solution and/or ink changes by exposure or adhering property to the contiguous layer different in affinity for a fountain solution and/or ink changes by exposure, and capable of development on a press by supplying a fountain solution and/or ink to the printing plate after image exposure.

(2) Non-Processing Type (Non-Development Type) Lithographic Printing Plate Precursor:

A lithographic printing plate precursor having an image forming layer whose affinity for a fountain solution or ink changes by exposure on the surface, and capable of printing without being accompanied by the removal of the image-forming layer after image exposure.

As the lithographic printing plate precursor of the invention capable of printing by being mounted on a press without undergoing development process after image recording, or being mounted on a press and then undergoing image recording, the above printing plate precursors (1) and (2) can be used with no particular limitation. However, as described later, since the image-forming layer of an on-press development type lithographic printing plate precursor does not always have a crosslinking structure, a compound discolored by exposure in the image-forming layer has higher mobility and discoloration reaction is liable to be improved. Accordingly, an on-press development type lithographic printing plate precursor is preferred to non-processing type one (non-development type) in the invention.

As the specific examples of these lithographic printing plate precursors, the plate materials as disclosed in Japanese Patent No. 2938397, JP-A-2001-277740, JP-A-2001-277742, JP-A-2002-287334, JP-A-2001-96936, JP-A-2001-96938, JP-A-2001-180141, JP-A-2001-162960, WO 00/16987, WO 01/39985, EP-A-990517, EP-A-1225041, U.S. Pat. No. 6,465,152, JP-A-6-317899, WO 96/35143, EP-A-652483, JP-A-10-10737, JP-A-11-309952, U.S. Pat. Nos. 6,017,677 and 6,413,694 are exemplified.

### Constituents Forming Color Images by Exposure

The lithographic printing plate precursor in the invention comprises a support and a layer containing a compound represented by the following formula (1) that is discolored by heat. The layer containing the compound represented by formula (1) in the invention may be the image-forming layer itself of the lithographic printing plate precursor, or may be a layer contiguous to the image-forming layer, e.g., a protective layer (an overcoat layer). As another embodiment of the invention, the lithographic printing plate precursor has an image-forming layer containing at least a compound represented by formula (2) shown later.

In the first place, the compound represented by formula (1) discolored by heat is explained.

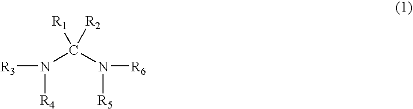

In formula (1), R₁, R₂, R₃, R₄, R₅ and R₆ each represents a hydrogen atom, an alkyl group (e.g., methyl, ethyl, propyl, isopropyl, n-butyl, isobutyl, sec-butyl, t-butyl, cyclohexyl, methoxyethyl, ethoxycarbonylethyl, cyanoethyl, diethylamino-ethyl, hydroxyethyl, chloroethyl, acetoxyethyl, benzyl, carboxybenzyl, etc.), an aryl group (e.g., phenyl, 4-methyl-phenyl, 4-methoxyphenyl, 4-carboxyphenyl, 3,5-dicarboxy-phenyl, naphthyl, anthranyl, etc.), an alkenyl group (e.g., vinyl, etc.), an alkynyl group (e.g., ethynyl, etc.), an acyl group (e.g., acetyl, propionyl, butanoyl, chloroacetyl, etc.), an alkyloxy group (e.g., methoxy, ethoxy, n-butoxy, methoxyethoxy, etc.), an alkenyloxy group (e.g., vinyloxy, etc.), an alkynyloxy group (e.g., ethenyloxy, etc.), an aryloxy group (e.g., phenoxy, 4-methoxyphenoxy, naphthyloxy, etc.), a sulfonyl group (e.g., methanesulfonyl, p-toluenesulfonyl, etc.), a sulfinyl group (e.g., methanesulfinyl, ethane-sulfinyl, octanesulfinyl, etc.), an alkoxycarbonyl group (e.g., methoxycarbonyl, ethanesulfonyl, etc.), an aryloxy-carbonyl group (e.g., phenoxycarbonyl, 4-methylphenoxy-carbonyl, 4-methoxyphenoxycarbonyl, naphthyloxycarbonyl, etc.), an alkylthio group (e.g., methylthio, ethylthio, etc.), an arylthio group (e.g., phenylthio, naphthylthio, etc.), an acyloxy group (e.g., acetoxy, ethylcarbonyloxy, cyclohexyl-carbonyloxy, benzoyloxy, chloroacetyloxy, etc.), a sulfonyl-oxy group (e.g., methanesulfonyloxy, etc.), a carbamoyloxy group (e.g., methylcarbamoyloxy, diethylcarbamoyloxy, etc.), an amino group (e.g., methylamino, dimethylamino, diethyl-amino, anilino, methoxyphenylamino, chlorophenylamino, morpholino, piperidino, pyrrolidino, pyridylamino, methoxycarbonylamino, n-butoxycarbonylamino, phenoxycarbonylamino, methylcarbamoylamino, phenylcarbamoylamino, ethylthio-carbamoylamino, methylsulfamoylamino, phenylsulfamoylamino, acetylamino, ethylcarbonylamino, ethylthiocarbonylamino, cyclohexylcarbonylamino, benzoylamino, chloroacetylamino, methanesulfonylamino, benzenesulfonylamino, etc.), an imino group (e.g., —CR₁═NR₂, wherein R₁ represents a hydrogen atom, an alkyl group, an aryl group, an alkenyl group, an alkynyl group, an acyl group, an alkyloxy group, an alkenyloxy group, an alkynyloxy group, an aryloxy group, a sulfonyl group, a sulfinyl group, an alkoxycarbonyl group, an aryloxycarbonyl group, an alkylthio group, an arylthio group, an acyloxy group, a sulfonyloxy group, a carbamoyloxy group, an amino group, a carbamoyl group, a sulfamoyl group, a hydroxyl group, a nitro group, a cyano group, a carboxyl group, a heterocyclic group, or a halogen atom, and R₂ represents an alkyl group, an aryl group, an alkenyl group, an alkynyl group, an acyl group, an alkyloxy group, an alkenyloxy group, an alkynyloxy group, an aryloxy group, a sulfonyl group, a sulfinyl group, an alkoxycarbonyl group, an aryloxycarbonyl group, an alkylthio group, an arylthio group, an acyloxy group, a sulfonyloxy group, a carbamoyloxy group, an amino group, a carbamoyl group, a sulfamoyl group, a hydroxyl group, a nitro group, a cyano group, a carboxyl group, or a heterocyclic group), a carbamoyl group (e.g., carbamoyl, methylcarbamoyl, ethylcarbamoyl, n-butyl-carbamoyl, t-butylcarbamoyl, dimethylcarbamoyl, morpholino-carbamoyl, pyrrolidinocarbamoyl, etc.), a sulfamoyl group (e.g., sulfamoyl, methylsulfamoyl, phenylsulfamoyl, etc.), a hydroxyl group, a nitro group, a cyano group, a carboxyl group or a heterocyclic group (e.g., oxazole, benzoxazole, thiazole, benzothiazole, imidazole, benzimidazole, indolenine, pyridine, sulforan, furan, thiophene, pyrazole, pyrrole, chroman, coumarin, etc.), and arbitrary combination of R₁ to R₄ may be bonded to form a ring, provided that R₅ and R₆ may be bonded to each other to form a ring, but R₅ and R₆ do not form a ring with any of R₁ to R₄.

According to the invention, the compound represented by formula (1) is decomposed by heat and discolored and an image having good visibility is formed, so that the image on a printing plate comes to be able to be easily ascertained. “Discoloration” used here means that the color difference between a layer containing the compound represented by formula (1) and a layer not containing the compound can be visually ascertained, more specifically means that the difference in color brightness (ΔL) between a layer containing the compound represented by formula (1) and a layer not containing the compound is 1 or more.

As the preferred examples of such a compound, spiropyran dyes as shown below or reaction products of spirooxazine dyes and secondary amine are exemplified.

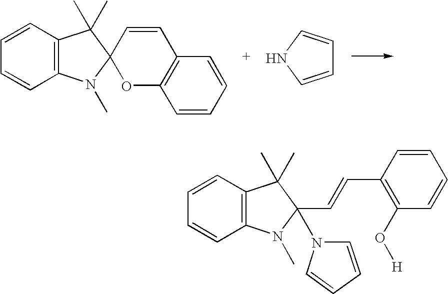

The compound represented by formula (1) is more preferably represented by the following formula (1a).

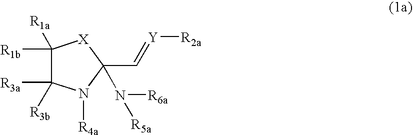

In formula (1a), R₁ₐ, R_{1b}, R₃ₐ and R_{3b} each represents a hydrogen atom, an alkyl group, an aryl group, an alkenyl group, an alkynyl group, an acyl group, an alkyloxy group, an alkenyloxy group, an alkynyloxy group, an aryloxy group, a sulfonyl group, a sulfinyl group, an alkoxycarbonyl group, an aryloxycarbonyl group, an alkylthio group, an arylthio group, an acyloxy group, a sulfonyloxy group, a carbamoyloxy group, an amino group, a carbamoyl group, a sulfamoyl group, a hydroxyl group, a nitro group, a cyano group, a carboxyl group, a heterocyclic group, or a halogen atom, and R₁ₐ, R_{1b}, R₃ₐ and R_{3b} may be bonded to each other to form a ring; R₂ₐ represents an alkyl group, an aryl group, an alkenyl group, an alkynyl group, an acyl group, an alkyloxy group, an alkenyloxy group, an alkynyloxy group, an aryloxy group, a sulfonyl group, a sulfinyl group, an alkoxycarbonyl group, an aryloxycarbonyl group, an alkylthio group, an arylthio group, an acyloxy group, a sulfonyloxy group, a carbamoyloxy group, an amino group, a carbamoyl group, a sulfamoyl group, a hydroxyl group, a nitro group, a cyano group, a carboxyl group, a heterocyclic group, or a halogen atom; R₄ₐ represents an alkyl group or an aryl group; R₅ₐ and R₆ₐ each represents a hydrogen atom or an alkyl group, and R₅ₐ and R₆ₐ may be bonded to each other to form a ring; X represents C(CH₃)₂, O, S or NR₇ₐ; R₇ₐ represents an alkyl group, an aryl group, an alkenyl group, an alkynyl group, an acyl group, an alkyloxy group, an alkenyloxy group, an alkynyloxy group, an aryloxy group, a sulfonyl group, a sulfinyl group, an alkoxycarbonyl group, an aryloxycarbonyl group, an alkylthio group, an arylthio group, an acyloxy group, a sulfonyloxy group, a carbamoyloxy group, an amino group, a carbamoyl group, a sulfamoyl group, a hydroxyl group, a nitro group, a cyano group, a carboxyl group, a heterocyclic group, or a halogen atom; and Y represents CH or N.

In formula (1a), when a ring is formed by R₁ₐ, R_{1b}, R₃ₐ and R_{3b}, it is preferred to form an aryl group having from 6 to 14 carbon atoms, e.g., a phenyl group, a naphthyl group, an anthryl group and a phenanthryl group are exemplified. The aryl group may have a substituent. As preferred substituents of the aryl group, e.g., a fluorine atom, a chlorine atom, a bromine atom, an iodine atom, a hydroxyl group, a carboxyl group, a nitro group, an alkoxyl group, and an alkoxycarbonyl group are exemplified.

The alkyl group represented by R₄ₐ to R₇ₐ is preferably a straight chain or branched alkyl group having from 1 to 5 carbon atoms, e.g., a methyl group, an ethyl group, an n-propyl group, an isopropyl group, an n-butyl group, an isobutyl group, a sec-butyl group, a pentyl group, an isopentyl group, a neopentyl group, and a t-pentyl group are exemplified. The alkyl group may have a substituent. As preferred substituents of the alkyl group, e.g., a fluorine atom, a chlorine atom, a bromine atom, an iodine atom, a hydroxyl group, a carboxyl group, a nitro group, an alkoxyl group, an alkoxycarbonyl group, an aryl group and a cycloalkyl group are exemplified.

The ring formed by R₅ₐ and R₆ₐ by bonding to each other may be a monocyclic ring or a polycyclic ring, preferably a 5- to 10-membered ring. The ring formed by R₅ₐ and R₆ₐ by bonding to each other may have a double bond, a hetero atom such as an oxygen atom or a nitrogen atom in the ring.

The preferred examples of compounds represented by formula (1) are shown below, but the invention is not limited thereto.

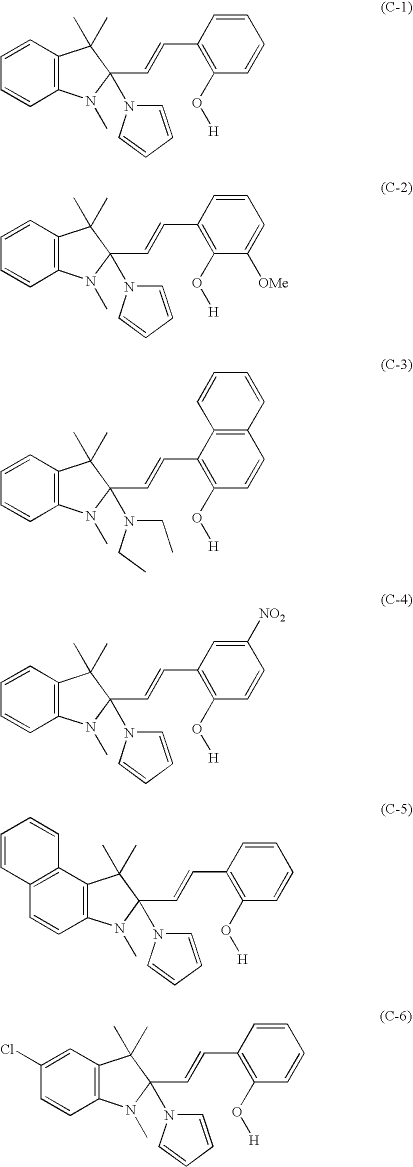

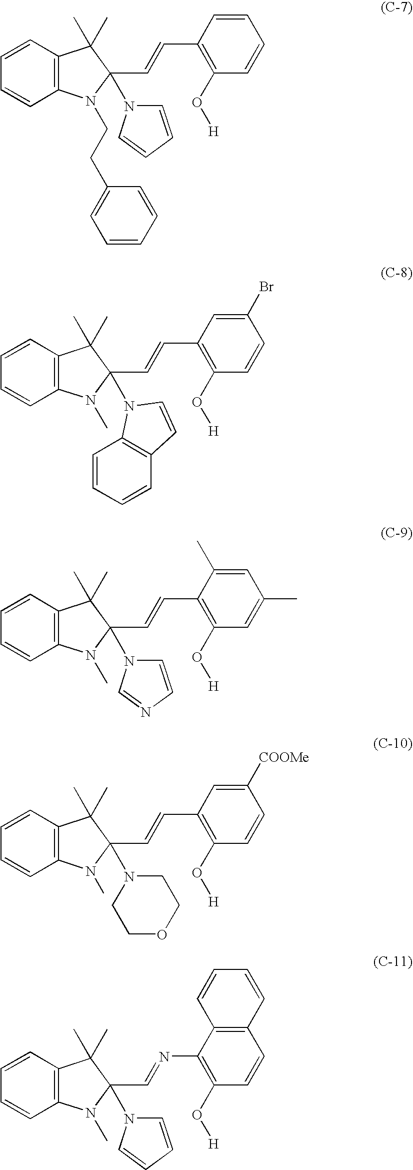

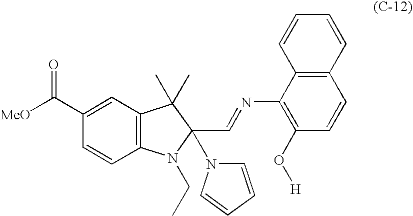

The layer containing a compound represented by formula (1) in the invention may be the image-forming layer itself of the lithographic printing plate precursor, or may be a layer contiguous to the image-forming layer, e.g., a protective layer. The addition amount of the compound is preferably from 1 to 50 mass % to the solids content of the whole layer, more preferably from 2 to 45 mass %.

The compound represented by formula (2) is explained in the next place. The compound represented by formula (2) is a spiropyran compound and this is a photochromic compound. The photochromic compound is a compound having a property such that reversible isomerization reaction is caused in the molecule by the absorption of light and the absorption band varies with the structural change. It becomes possible to obtain good visibility after exposure by making use of the photochromism. Accordingly, the compound represented by formula (2) in the invention is hereinafter also referred to as the photochromic compound in the invention. 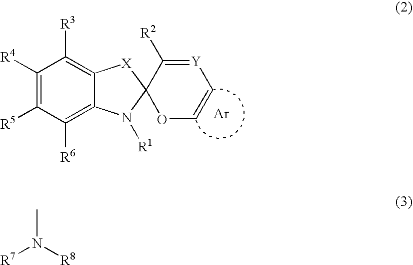
wherein X represents C(CH₃)₂, S, SO₂, O, Se, Te or N—R¹; Y represents CH or N; Ar represents an aromatic ring or a heterocyclic aromatic ring, and at least one of an alkyloxy group, an aryloxy group, an alkylthio group, an arylthio group and a group represented by the above formula (3) is contained in the ring. Ar preferably represents an aromatic ring or a heterocyclic aromatic ring having from 6 to 18 carbon atoms, more preferably a benzene ring or a naphthalene ring. The preferred substituents of Ar is an alkyloxy group having 12 or less carbon atoms, an aryloxy group having 19 or less carbon atoms, an alkylthio group having 12 or less carbon atoms, or an arylthio group having 12 or less carbon atoms.

R², R³, R⁴, R⁵ and R⁶ each represents a hydrogen atom, an alkyl group, an alkenyl group, an alkynyl group, an alkyloxy group, an aryloxy group, an alkylcarbonyloxy group, an arylcarbonyloxy group, a hydroxyl group, an alkylthio group, an arylthio group, a mercapto group, an alkylcarbonyl group, an arylcarbonyl group, an alkyloxycarbonyl group, an aryloxycarbonyl group, a carboxyl group, an amino group, a cyano group, a nitro group, an amido group, a sulfo group, an alkylsulfonyl group, an arylsulfonyl group, an alkyloxy-sulfonyl group, an aryloxysulfonyl group, an alkylsulfonyloxy group, an arylsulfonyloxy group, a silyl group, a urea group, a urethane group or a halogen atom, and preferred substituents include a hydrogen atom, an alkyl group having 12 or less carbon atoms, an alkenyl group having 12 or less carbon atoms, an alkynyl group having 12 or less carbon atoms, an alkyloxy group having 13 or less carbon atoms, an aryloxy group having 13 or less carbon atoms, an alkylcarbonyloxy group having 13 or less carbon atoms, an arylcarbonyloxy group having 19 or less carbon atoms, a hydroxyl group, an alkylthio group having 12 or less carbon atoms, an arylthio group having 18 or less carbon atoms, a mercapto group, an alkylcarbonyl group having 13 or less carbon atoms, an arylcarbonyl group having 19 or less carbon atoms, an alkyloxycarbonyl group having 13 or less carbon atoms, an aryloxycarbonyl group having 19 or less carbon atoms, a carboxyl group, an amino group, a cyano group, a nitro group, an amido group, a sulfo group, an alkylsulfonyl group having 12 or less carbon atoms, an arylsulfonyl group having 12 or less carbon atoms, an alkyloxysulfonyl group having 12 or less carbon atoms, an aryloxysulfonyl group having 12 or less carbon atoms, an alkylsulfonyloxy group having 12 or less carbon atoms, an arylsulfonyloxy group having 12 or less carbon atoms, a silyl group, a urea group, a urethane group and a halogen atom.

R¹ represents a hydrogen atom, an alkyl group, an aryl group, an alkylcarbonyl group, an arylcarbonyl group, an alkyloxycarbonyl group, an aryloxycarbonyl group, a carboxyl group, a sulfo group, an alkylsulfonyl group, an arylsulfonyl group, an alkyloxysulfonyl group, an aryloxysulfonyl group, or a silyl group, preferably an alkyl group having 12 or less carbon atoms, an aryl group having 18 or less carbon atoms, an alkylcarbonyl group having 13 or less carbon atoms, an arylcarbonyl group having 19 or less carbon atoms, an alkyloxycarbonyl group having 13 or less carbon atoms, an aryloxycarbonyl group having 19 or less carbon atoms, a carboxyl group, a sulfo group, an alkylsulfonyl group having 12 or less carbon atoms, an arylsulfonyl group having 18 or less carbon atoms, an alkyloxysulfonyl group having 12 or less carbon atoms, an aryloxysulfonyl group having 18 or less carbon atoms, or a silyl group. R³ and R⁴, R⁴ and R⁵, R⁵ and R⁶, and R⁶ and R¹ may be bonded to each other to form a ring. R⁷ and R⁸ each represents a hydrogen atom, an alkyl group, an aryl group, an alkylcarbonyl group, an arylcarbonyl group, an alkyloxycarbonyl group, an aryloxycarbonyl group, a carboxyl group, a sulfo group, an alkylsulfonyl group or an arylsulfonyl group, preferably a hydrogen atom, an alkyl group having 12 or less carbon atoms, an aryl group having 18 or less carbon atoms, an alkylcarbonyl group having 13 or less carbon atoms, an arylcarbonyl group having 19 or less carbon atoms, an alkyloxycarbonyl group having 13 or less carbon atoms, an aryloxycarbonyl group having 19 or less carbon atoms, a carboxyl group, a sulfo group, an alkylsulfonyl group having 12 or less carbon atoms, or an arylsulfonyl group having 18 or less carbon atoms. R⁷ and R⁸ may be bonded to each other to form a ring.

Of the spiropyran compounds represented by formula (2), in view of coloring property and stability, it is more preferred that in formula (2) X represents C(CH₃)₂, Y represents N, Ar represents a benzene ring or a naphthalene ring, and the substituent in Ar is a group represented by formula (3).

The specific examples of the compounds represented by formula (2) of the invention are shown below, but the invention is not limited thereto.

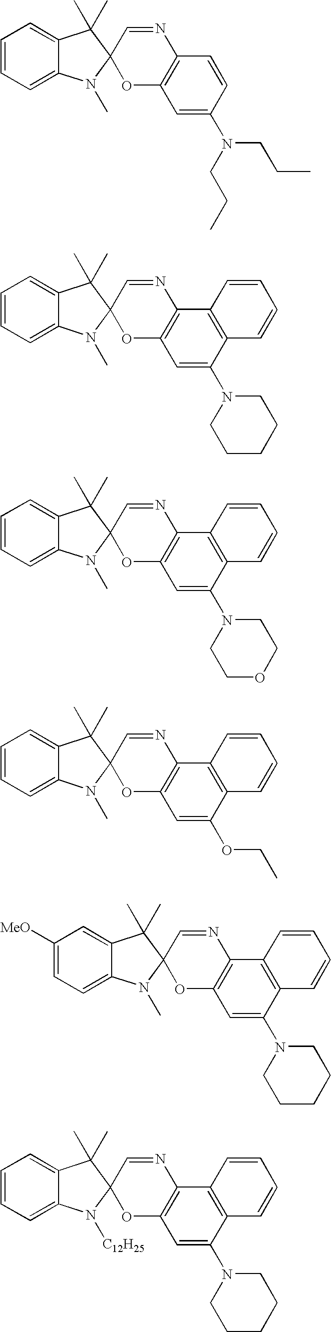

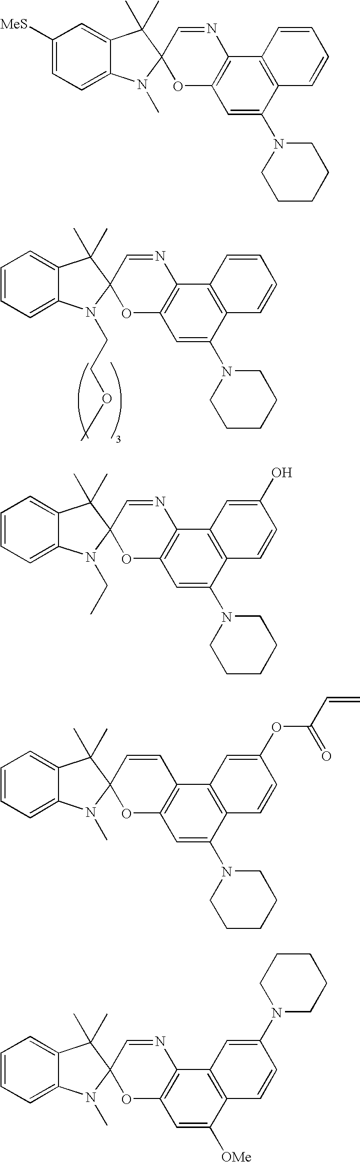

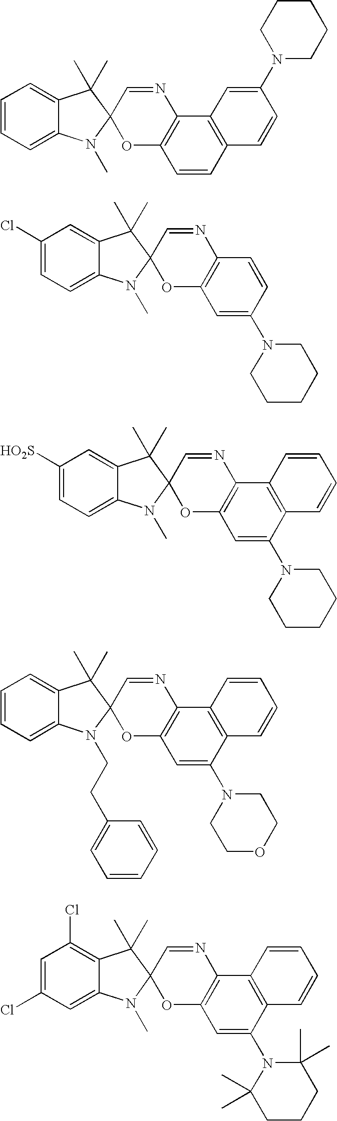

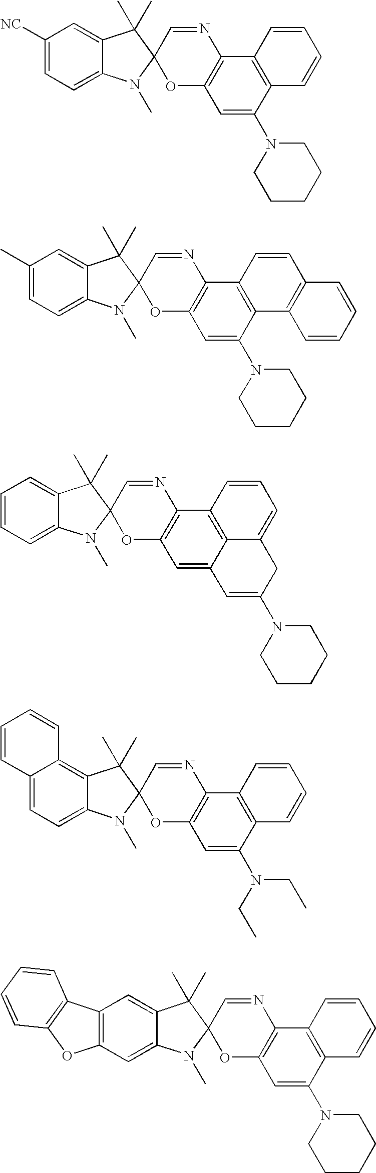

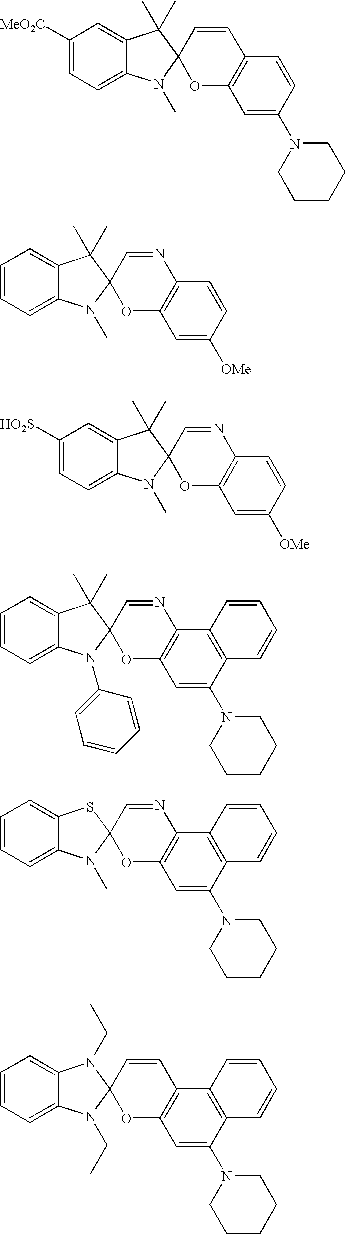

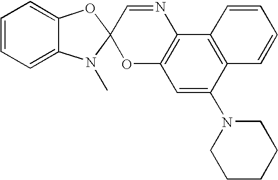

For adding the compound represented by formula (2) of the invention to the image-forming layer, a method of dissolving the compound in a proper solvent and coating the solution, and a method of encapsulating at least either the compound or an acid generator described later, preferably both, in microcapsules and adding the microcapsules to the image forming layer can be used. The latter method is more preferred for the reason that by the separation of printing-out image forming reaction system from printing image-forming reaction system with microcapsules, the impediment of mutual reaction can be avoided and good plate inspection and press life can be obtained. Microencapsulation can be performed by the method described later.

The photochromic compound in the invention can be used alone, or two or more compounds may be used in combination.

The photochromic compound in the invention is preferably used in the range of from 1 μmol/m² to 10 mmol/m² in the image-forming layer, more preferably from 10 μmol/m² to 1 mmol/m². Good visibility can be obtained in this range of the use amount.

### Acid Generator

It is preferred to use an acid generator that generates an acid upon reaction with a laser beam or the heat generated by the action of a laser beam and an infrared absorber, or both, in the image-forming layer containing the photochromic compound of the invention. The acid generators used are not restricted but onium salts (diazonium salts, iodonium salts or sulfonium salts) are preferably used.

As the onium salt compounds, onium salts, e.g., the diazonium salts described in S. I. Schlesinger, Photogr. Sci. Eng., 18, 387 (1974), and T. S. Bal et al., Polymer, 21, 423 (1980), the ammonium salts disclosed in U.S. Pat. No. 4,069,055 and JP-A-4-365049, the phosphonium salts disclosed in U.S. Pat. Nos. 4,069,055 and 4,069,056, the iodonium salts disclosed in EP 104,143, U.S. Pat. Nos. 339,049, 410,201, JP-A-2-150848 and JP-A-2-296514, the sulfonium salts disclosed in EP 370,693, EP 390,214, EP 233,567, EP 297,443, EP 297,442, U.S. Pat. Nos. 4,933,377, 161,811, 410,201, 339,049, 4,760,013, 4,734,444, 2,833,827, German Patents. 2,904,626, 3,604,580 and 3,604,581, the selenonium salts described in J. V. Crivello et al., Macromolecules, 10 (6), 1307 (1977), and J. V. Crivello et al., J. Polymer Sci., Polymer Chem. Ed., 17, 1047 (1979), and the arsonium salts described in C. S. Wen et al., Teh. Proc. Conf. Rad. Curing ASIA, p. 478, Tokyo, Oct (1988) are exemplified.

Onium salts preferably used in the invention are onium salts represented by the following formula (RI-I), (RI-II) or (RI-III):

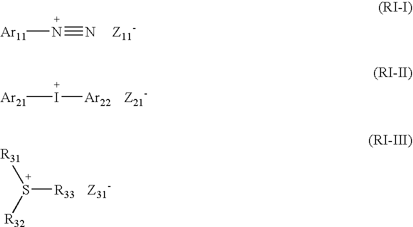

In formula (RI-I), Ar₁₁ represents an aryl group having 20 or less carbon atoms, which may have from 1 to 6 substituents, and as the preferred substituents, an alkyl group having from 1 to 12 carbon atoms, an alkenyl group having from 1 to 12 carbon atoms, an alkynyl group having from 1 to 12 carbon atoms, an aryl group having from 1 to 12 carbon atoms, an alkoxyl group having from 1 to 12 carbon atoms, an aryloxy group having from 1 to 12 carbon atoms, a halogen atom, an alkylamino group having from 1 to 12 carbon atoms, a dialkylamino group having from 1 to 12 carbon atoms, an alkylamido group or arylamido group having from 1 to 12 carbon atoms, a carbonyl group, a carboxyl group, a cyano group, a sulfonyl group, a thioalkyl group having from 1 to 12 carbon atoms, and a thioaryl group having from 1 to 12 carbon atoms are exemplified. Z₁₁⁻ represents a monovalent anion, and specifically a halogen ion, a perchlorate ion, a hexafluorophosphate ion, a tetrafluoroborate ion, a sulfonate ion, a sulfinate ion, a thiosulfonate ion and a sulfate ion are exemplified. In particular, in view of stability, a perchlorate ion, a hexafluorophosphate ion, a tetrafluoroborate ion, a sulfonate ion and a sulfinate ion are preferred.

In formula (RI-II), Ar₂₁ and Ar₂₂ each represents an aryl group having 20 or less carbon atoms, which may have from 1 to 6 substituents, and as the preferred substituents, an alkyl group having from 1 to 12 carbon atoms, an alkenyl group having from 1 to 12 carbon atoms, an alkynyl group having from 1 to 12 carbon atoms, an aryl group having from 1 to 12 carbon atoms, an alkoxyl group having from 1 to 12 carbon atoms, an aryloxy group having from 1 to 12 carbon atoms, a halogen atom, an alkylamino group having from 1 to 12 carbon atoms, a dialkylamino group having from 1 to 12 carbon atoms, an alkylamido group or arylamido group having from 1 to 12 carbon atoms, a carbonyl group, a carboxyl group, a cyano group, a sulfonyl group, a thioalkyl group having from 1 to 12 carbon atoms, and a thioaryl group having from 1 to 12 carbon atoms are exemplified. Z₂₁⁻ represents a monovalent anion, and specifically a halogen ion, a perchlorate ion, a hexafluoro-phosphate ion, a tetrafluoroborate ion, a sulfonate ion, a sulfinate ion, a thiosulfonate ion and a sulfate ion are exemplified. In view of stability and reactivity, a perchlorate ion, a hexafluorophosphate ion, a tetrafluoro-borate ion, a sulfonate ion, a sulfinate ion and a carboxylate ion are preferred.

In formula (RI-III), R₃₁, R₃₂ and R₃₃ each represents an aryl, alkyl, alkenyl or alkynyl group each having 20 or less carbon atoms, which may have from 1 to 6 substituents. Above all, in view of reactivity and stability, an aryl group is preferred. As the substituents, an alkyl group having from 1 to 12 carbon atoms, an alkenyl group having from 1 to 12 carbon atoms, an alkynyl group having from 1 to 12 carbon atoms, an aryl group having from 1 to 12 carbon atoms, an alkoxyl group having from 1 to 12 carbon atoms, an aryloxy group having from 1 to 12 carbon atoms, a halogen atom, an alkylamino group having from 1 to 12 carbon atoms, a dialkylamino group having from 1 to 12 carbon atoms, an alkylamido group or arylamido group having from 1 to 12 carbon atoms, a carbonyl group, a carboxyl group, a cyano group, a sulfonyl group, a thioalkyl group having from 1 to 12 carbon atoms, and a thioaryl group having from 1 to 12 carbon atoms are exemplified. Z₃₁⁻ represents a monovalent anion, and specifically a halogen ion, a perchlorate ion, a hexafluorophosphate ion, a tetrafluoroborate ion, a sulfonate ion, a sulfinate ion, a thiosulfonate ion, and a sulfate ion are exemplified. Above all, in view of stability and reactivity, a perchlorate ion, a hexafluorophosphate ion, a tetrafluoroborate ion, a sulfonate ion, a sulfinate ion and a carboxylate ion are preferred. The carboxylate ions disclosed in JP-A-2001-343742 are more preferred, and the carboxylate ions disclosed in JP-A-2002-148790 are especially preferred.

The specific examples of the compounds represented by formula (RI-I), (RI-II) or (RI-III) are shown below, but the invention is not limited to these compounds.

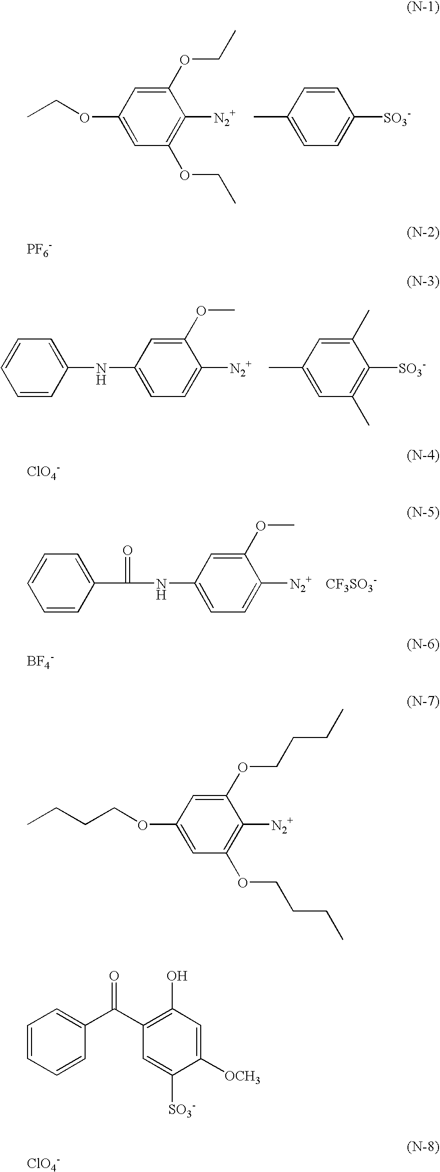

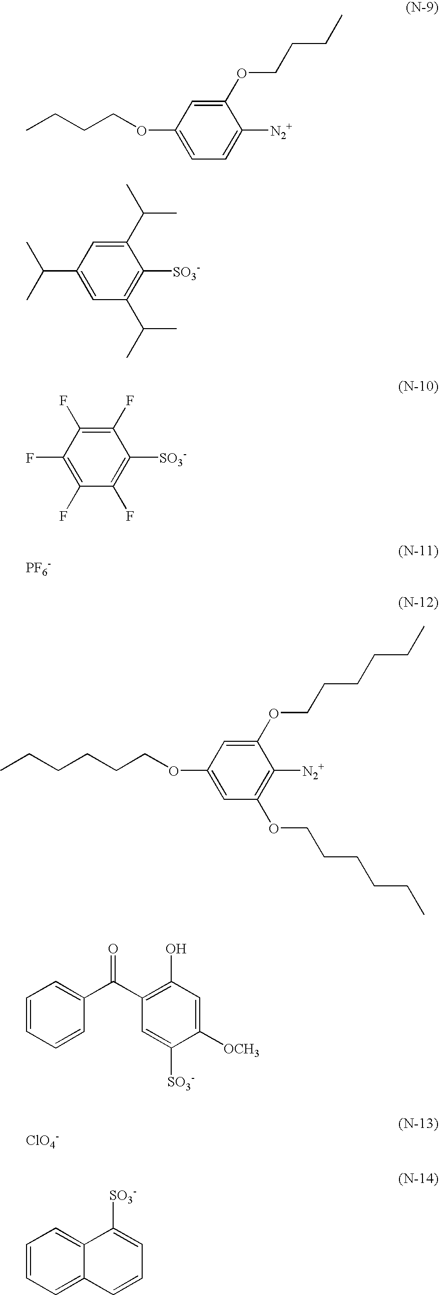

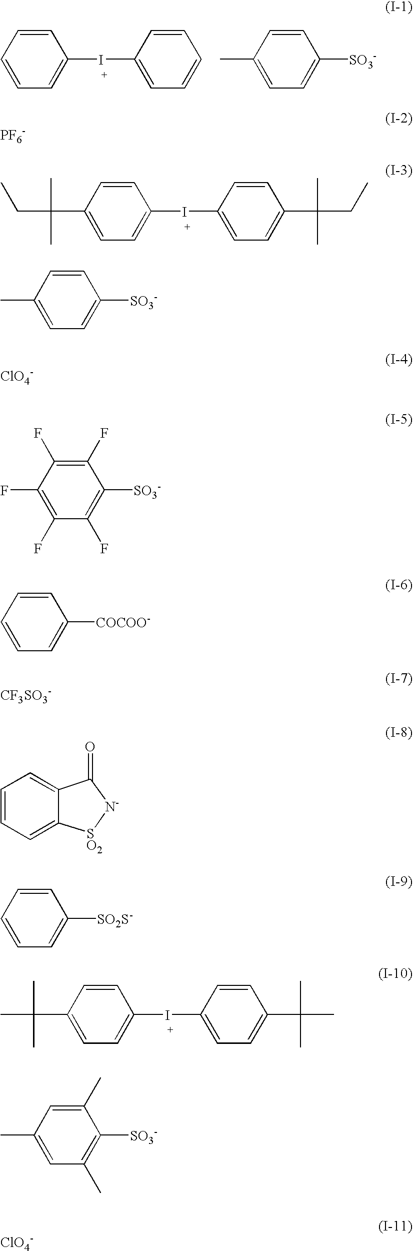

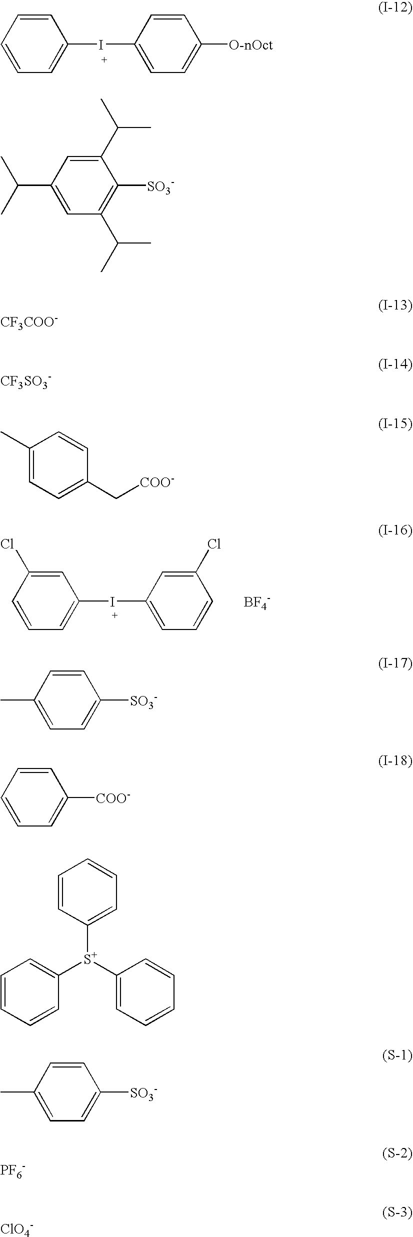

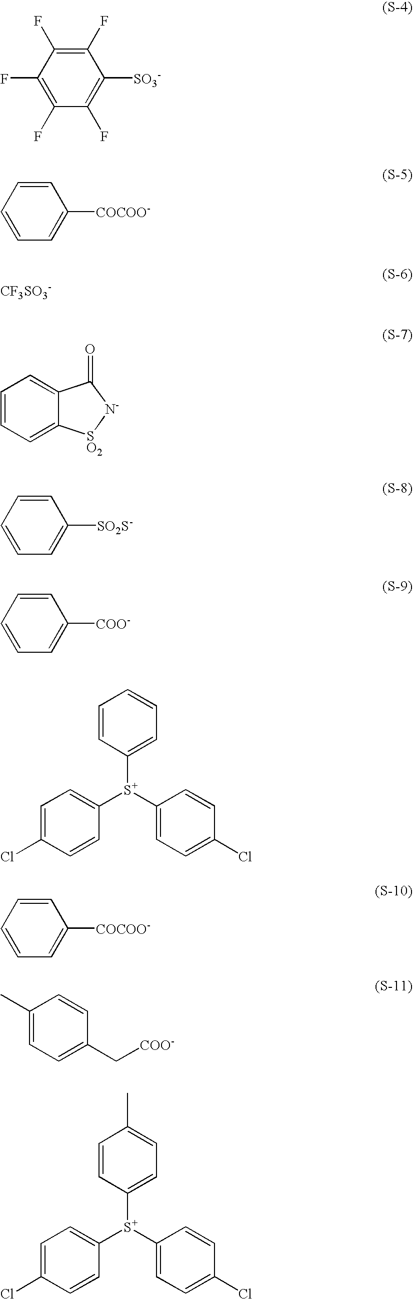

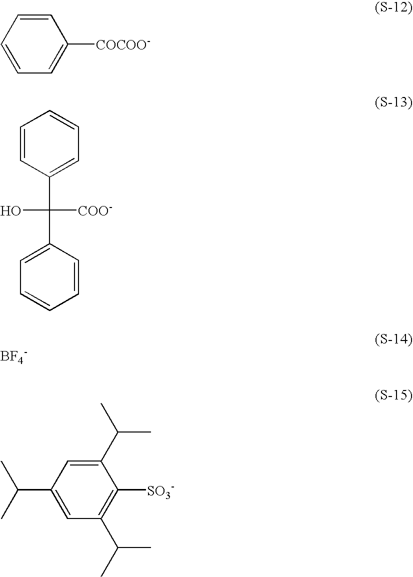

These acid generators can be used in proportion of preferably from 0.1 to 50 mass % to the total solids content constituting the image-forming layer, more preferably from 0.5 to 30 mass %, and still more preferably from 1 to 20 mass %. When the use amount of acid generators is in this range, good visibility after exposure can be obtained. Acid generators may be used alone, or two or more compounds may be used in combination. Acid generators may be added to the same layer with other constituents, or a different layer may be provided for the addition of acid generators.

### Infrared Absorber

It is preferred for the layer containing a compound represented by formula (1) or (2) to contain infrared absorbers for increasing sensitivity to infrared lasers. Infrared absorbers have a function to convert absorbed infrared rays to heat. Infrared absorbers fore use in the invention are dyes or pigments having an absorption maximum in the wavelength of from 650 to 1,200 nm.

As dyes for this purpose, commercially available dyes and well-known dyes described in literatures, e.g., Senryo Binran (Dye Handbook), compiled by Yuki Gosei Kagaku Kyokai (1970) can be used. Specifically, azo dyes, metal complex azo dyes, pyrazolone azo dyes, naphthoquinone dyes, anthraquinone dyes, phthalocyanine dyes, carbonium dyes, quinoneimine dyes, methine dyes, cyanine dyes, squarylium dyes, pyrylium salts and metal thiolate complexes are exemplified.

As preferred dyes, e.g., the cyanine dyes disclosed in JP-A-58-125246, JP-A-59-84356 and JP-A-60-78787, the methine dyes disclosed in JP-A-58-173696, JP-A-58-181690 and JP-A-58-194595, the naphthoquinone dyes disclosed in JP-A-58-112793, JP-A-58-224793, JP-A-59-48187, JP-A-59-73996, JP-A-60-52940 and JP-A-60-63744, the squarylium dyes disclosed in JP-A-58-112792, and the cyanine dyes disclosed in British Patent 434,875 are exemplified.

Further, the near infrared-absorbing sensitizers disclosed in U.S. Pat. No. 5,156,938 are also preferably used, in addition, the substituted arylbenzo(thio)pyrylium salts disclosed in U.S. Pat. No. 3,881,924, the trimethine thiapyrylium salts disclosed in JP-A-57-142645 (corresponding to U.S. Pat. No. 4,327,169), the pyrylium-based compounds disclosed in JP-A-58-181051, JP-A-58-220143, JP-A-59-41363, JP-A-59-84248, JP-A-59-84249, JP-A-59-146063 and JP-A-59-146061, the cyanine dyes disclosed in JP-A-59-216146, the pentamethine thiopyrylium salts disclosed in U.S. Pat. No. 4,283,475, and the pyrylium compounds disclosed in JP-B-5-13514 (the term “JP-B” as used herein refers to an “examined Japanese patent publication”) and JP-B-5-19702 are also preferably used in the invention. As other examples of preferred dyes, the near infrared absorbing dyes disclosed in U.S. Pat. No. 4,756,993 as the compounds represented by formulae (I) and (II) can be exemplified.

As other preferred examples of infrared absorbing dyes in the invention, the indolenine cyanine dyes disclosed in JP-A-2002-278057 as shown below are exemplified.

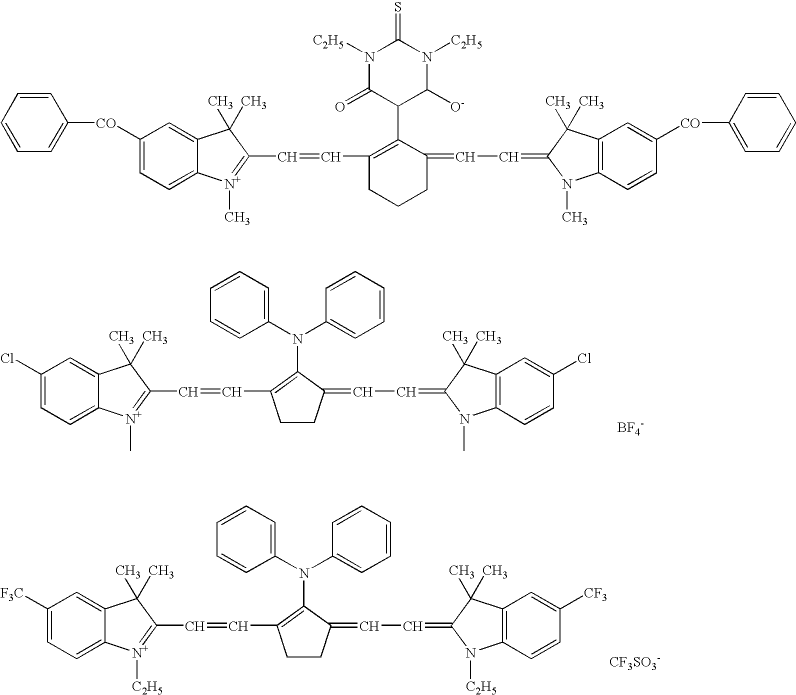

Of these dyes, cyanine dyes, squarylium dyes, pyrylium salts, nickel thiolate complexes and indolenine cyanine dyes are exemplified as particularly preferred dyes. Cyanine dyes and indolenine cyanine dyes are more preferred, and as an especially preferred example, a cyanine dye represented by the following formula (I) is exemplified.

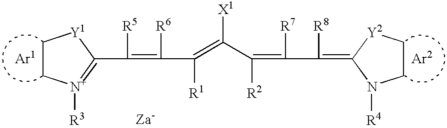

In formula (I), X¹ represents a hydrogen atom, a halogen atom, —NPh₂, X²-L¹, or a group shown below. 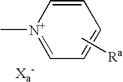
wherein Xₐ⁻ is defined as the same with the later-described Zₐ⁻, and R^{a} represents a substituent selected from a hydrogen atom, an alkyl group, an aryl group, a substituted or unsubstituted amino group and a halogen atom.

X² represents an oxygen atom, a nitrogen atom or a sulfur atom; L¹ represents a hydrocarbon group having from 1 to 12 carbon atoms, an aromatic ring having a hetero atom, or a hydrocarbon group containing a hetero atom having from 1 to 12 carbon atoms. The hetero atoms are N, S, O, a halogen atom and Se. R¹ and R² each represents a hydrocarbon group having from 1 to 12 carbon atoms. In view of the preservation stability of a recording layer coating solution, R¹ and R² each preferably represents a hydrocarbon group having 2 or more carbon atoms, and especially preferably R¹ and R² are bonded to each other to form a 5- or 6-membered ring.

Ar¹ and Ar², which may be the same or different, each represents an aromatic hydrocarbon group which may have a substituent. As preferred aromatic hydrocarbon groups, a benzene ring and a naphthalene ring are exemplified. As the preferred substituents, a hydrocarbon group having 12 or less carbon atoms, a halogen atom, and an alkoxyl group having 12 or less carbon atoms are exemplified. Y¹ and Y², which may be the same or different, each represents a sulfur atom or a dialkylmethylene group having 12 or less carbon atoms. R³ and R⁴, which may be the same or different, each represents a hydrocarbon group having 20 or less carbon atoms which may have a substituent. The preferred examples of the substituents include an alkoxyl group having 12 or less carbon atoms, a carboxyl group, and a sulfo group. R⁵, R⁶, R⁷ and R⁸, which may be the same or different, each represents a hydrogen atom or a hydrocarbon group having 12 or less carbon atoms, preferably a hydrogen atom for easy availability of the material. Zₐ⁻ represents a counter anion, provided that when a cyanine dye represented by formula (I) has an anionic substituent in the structure and the neutralization of the electric charge is not necessary, Zₐ⁻ is not necessary. Zₐ⁻ preferably represents a halogen ion, a perchlorate ion, a tetrafluoroborate ion, a hexafluorophosphate ion or a sulfonate ion for the preservation stability of a recording layer coating solution, and especially preferably, a perchlorate ion, a hexafluorophosphate ion or an arylsulfonate ion.

As the specific examples of cyanine dyes represented by formula (I) that can be preferably used in the invention, those disclosed in JP-A-2001-133969, paragraphs [0017] to [0019] are exemplified.

Further, as especially preferred other examples of dyes, the specific indolenine cyanine dyes disclosed in JP-A-2002-278057 are exemplified.

As the pigments that are used in the present invention, commercially available pigments and the pigments described in Color Index (C.I.) Binran (Color Index Bulletin), Shaishin Ganryo Binran (The Latest Pigment Handbook), compiled by Nippon Ganryo Gijutsu Kyokai (1977), Shaishin Ganryo Oyo Giiutsu (The Latest Pigment Applied Techniques), CMC Publishing Co. Ltd. (1986), and Insatsu Ink Gijutsu (Printing Ink Techniques), CMC Publishing Co. Ltd. (1984) can be used.

Various kinds of pigments can be used in the invention, e.g., black pigments, yellow pigments, orange pigments, brown pigments, red pigments, purple pigments, blue pigments, green pigments, fluorescent pigments, metallic powder pigments, and polymer-bond pigments can be exemplified. Specifically, insoluble azo pigments, azo lake pigments, condensation azo pigments, chelate azo pigments, phthalocyanine pigments, anthraquinone pigments, perylene and perinone pigments, thioindigo pigments, quinacridone pigments, dioxazine pigments, isoindolinone pigments, quinophthalone pigments, lake pigments, azine pigments, nitroso pigments, nitro pigments, natural pigments, fluorescent pigments, inorganic pigments, and carbon black can be used. Of these pigments, carbon black is preferably used.

These pigments can be used without surface treatment or the surfaces may be treated. As the methods of surface treatments, a method of coating the surfaces of pigments with resins and waxes, a method of adhering surfactants, and a method of bonding reactive substances (e.g., silane coupling agents, epoxy compounds, or polyisocyanate) on the surfaces of pigments can be exemplified. These surface treatment methods are described in Kinzoku Sekken no Seishitsu to Oyo (Natures and Applications of Metal Soaps) Saiwai Shobo Co., Ltd., Insatsu Ink Gijutsu (Printing Ink Techniques), CMC Publishing Co., Ltd. (1984), and Shaishin Ganryo Oyo Gijutsu (The Latest Pigment Applied Techniques), CMC Publishing Co., Ltd. (1986).

The particle size of pigments is preferably in the range of from 0.01 to 10 μm, more preferably from 0.05 to 1 μm, and especially preferably in the range of from 0.1 to 1 μm. When the particle size of pigments is in this range, stability of the pigment dispersion in an image-forming layer coating solution and preferred uniformity of an image-forming layer can be obtained.

Well-know dispersing techniques used in the manufacture of inks and toners can be used as the dispersing methods of pigments. The examples of dispersing apparatus include an ultrasonic wave disperser, a sand mill, an attritor, a pearl mill, a super-mill, a ball mill, an impeller, a disperser, a KD mill, a colloid mill, a dynatron, a three-roll mill and a pressure kneader, and details thereof are described in Shaishin Ganryo Oyo Gijutsu (The Latest Pigment Application Techniques), CMC Publishing Co., Ltd. (1986).

These infrared absorbers may be added to the same layer with other constituents, or a different layer may be provided for the addition of infrared absorbers. Alternatively, infrared absorbers may be added as the form of being encapsulated in microcapsules.

When a negative lithographic printing plate precursor is prepared, it is preferred that infrared absorbers be added so that the absorbance of an image-forming layer at the maximum absorption wavelength in the wavelength range of from 760 to 1,200 nm is from 0.3 to 1.2 by a reflection measuring method, more preferably from 0.4 to 1.1. In this range of the addition amount, the polymerization reaction proceeds uniformly in the depth direction of the image-forming layer and good layer strength of the image area and adhesion to the support can be obtained.

The absorbance of an image-forming layer can be adjusted by the amount of an infrared absorber added to the image-forming layer and the thickness of the image-forming layer. The absorbance can be measured by ordinary methods, e.g., a method of forming an image-forming layer having a thickness in a dry coating weight arbitrarily determined in a necessary range as a lithographic printing plate on a reflective support, e.g., an aluminum support, and measuring the reflection density with an optical densitometer, and a method of measuring the absorbance by a reflection method with a spectrophotometer using an integrating sphere are exemplified.

### Constituents for Forming Printing Image

As the constituents preferably used in the image-forming layer of the invention for forming a printing image, both of (A) image-forming constituents using radical polymerization, and (B) image-forming constituents utilizing thermal fusion and thermal reaction of a hydrophobitizing precursor can be used. These constituents are described below.

(A) Image-Forming Constituents Using Radical Polymerization:

In the image-forming constituents utilizing radical polymerization, the image-forming layer of the invention contains a radical polymerizable monomer and a radical generator in addition to the above discoloring agent.

Since radical polymerization constituents are high in image forming sensitivity, exposure energy can be effectively shared for the formation of a printing-out image, so that radical polymerization constituents are more preferred for obtaining a printing-out image having a great difference in color brightness.

### Radical Polymerizable Monomer

For efficiently perform a hardening reaction, it is preferred for the image-forming layer in the invention to contain a radical polymerizable monomer (hereinafter also referred to as merely a polymerizable monomer). The radical polymerizable monomers usable in the invention are addition polymerizable monomers having at least one ethylenic unsaturated double bond, and these monomers are selected from the compounds having at least one, preferably two or more, ethylenic unsaturated bond. These compounds are well known in the field of this industry, and the compounds can be used with no particular restriction in the invention. They have chemical forms of, e.g., a monomer or a prepolymer, i.e., a dimer, a trimer or an oligomer, and a mixture and a copolymer thereof. As the examples of monomers and copolymers of them, unsaturated carboxylic acids (e.g., acrylic acid, methacrylic acid, itaconic acid, crotonic acid, isocrotonic acid, maleic acid, etc.), and esters and amides of these unsaturated carboxylic acids are exemplified, and preferably esters of unsaturated carboxylic acids and aliphatic polyhydric alcohol compounds, and amides of unsaturated carboxylic acids and aliphatic polyhydric amine compounds are used. Further, the addition reaction products of unsaturated carboxylic acid esters and amides having a nucleophilic substituent such as a hydroxyl group, an amino group or a mercapto group with monofunctional or polyfunctional isocyanates or epoxies, and the dehydration condensation reaction products of unsaturated carboxylic acid esters and amides with monofunctional or polyfunctional carboxylic acids are also preferably used. Furthermore, the addition reaction products of unsaturated carboxylic acid esters or amides having an electrophilic substituent such as an isocyanate group or an epoxy group with monofunctional or polyfunctional alcohols, amines or thiols, and the substitution reaction products of unsaturated carboxylic acid esters or amides having a separable substituent such as a halogen group or a tosyloxy group with monofunctional or polyfunctional alcohols, amines or thiols are also preferably used. As another example, it is also possible to use compounds obtained by substituting the unsaturated carboxylic acids with unsaturated phosphonic acid, styrene, vinyl ether, etc.

The specific examples of the ester monomers of aliphatic polyhydric alcohol compounds and unsaturated carboxylic acids include, as acrylic esters, ethylene glycol diacrylate, triethylene glycol diacrylate, 1,3-butanediol diacrylate, tetramethylene glycol diacrylate, propylene glycol diacrylate, neopentyl glycol diacrylate, trimethylolpropane triacrylate, trimethylolpropane tri(acryloyloxypropyl) ether, rimethylolethane triacrylate, hexanediol diacrylate, 1,4-cyclohexanediol diacrylate, tetraethylene glycol diacrylate, pentaerythritol diacrylate, pentaerythritol triacrylate, pentaerythritol tetraacrylate, dipentaerythritol diacrylate, dipentaerythritol hexaacrylate, sorbitol triacrylate, sorbitol tetraacrylate, sorbitol pentaacrylate, sorbitol hexaacrylate, tri(acryloyloxyethyl) isocyanurate, polyester acrylate oligomer, isocyanuric acid EO-modified triacrylate, etc.

As methacrylic esters, the specific examples include tetramethylene glycol dimethacrylate, triethylene glycol dimethacrylate, neopentyl glycol dimethacrylate, trimethylolpropane trimethacrylate, trimethylolethane trimethacrylate, ethylene glycol dimethacrylate, 1,3-butanediol dimethacrylate, hexanediol dimethacrylate, pentaerythritol dimethacrylate, pentaerythritol trimethacrylate, pentaerythritol tetramethacrylate, dipentaerythritol dimethacrylate, dipentaerythritol hexamethacrylate, sorbitol trimethacrylate, sorbitol tetramethacrylate, bis[p-(3-methacryloxy-2-hydroxypropoxy)-phenyl]dimethylmethane, bis[p-(methacryloxyethoxy)phenyl]-dimethylmethane, etc.

As itaconic esters, the specific examples include ethylene glycol diitaconate, propylene glycol diitaconate, 1,3-butanediol diitaconate, 1,4-butanediol diitaconate, tetramethylene glycol diitaconate, pentaerythritol diitaconate, sorbitol tetraitaconate, etc. As crotonic esters, the specific examples include ethylene glycol dicrotonate, tetramethylene glycol dicrotonate, pentaerythritol dicrotonate, sorbitol tetradicrotonate, etc. As isocrotonic esters, the specific examples include ethylene glycol diisocrotonate, pentaerythritol diisocrotonate, sorbitol tetraisocrotonate, etc. As maleic esters, the specific examples include ethylene glycol dimaleate, triethylene glycol dimaleate, pentaerythritol dimaleate, sorbitol tetramaleate, etc.

As the examples of other esters, e.g., the aliphatic alcohol esters disclosed in JP-B-51-47334 and JP-A-57-196231, the esters having an aromatic skeleton disclosed in JP-A-59-5240, JP-A-59-5241 and JP-A-2-226149, and the esters having an amino group disclosed in JP-A-1-165613 are also preferably used in the invention. The above ester monomers can also be used as mixtures.

Further, the specific examples of the amide monomers of aliphatic polyhydric amine compounds and unsaturated carboxylic acids include methylenebis-acrylamide, methylenebis-methacrylamide, 1,6-hexamethylenebis-acrylamide, 1,6-hexamethylenebis-methacrylamide, diethylenetriaminetris-acrylamide, xylylenebis-acrylamide, xylylenebis-methacrylamide, etc. As other preferred amide monomers, the amide monomers having a cyclohexylene structure disclosed in JP-B-54-21726 can be exemplified.

Further, urethane-based addition polymerizable compounds manufactured by the addition reaction of isocyanate and hydroxyl groups are also preferably used. As the specific example of such a compound, as disclosed in JP-B-48-41708, a vinyl urethane compound containing two or more polymerizable vinyl groups in one molecule obtained by the addition of a vinyl monomer having a hydroxyl group represented by the following formula (a) to a polyisocyanate compound having two or more isocyanate groups in one molecule is exemplified.
CH₂═C(R₄)COOCH₂CH(R₅)OH (a)
wherein R₄ and R₅ each represents H or CH₃.

The urethane acrylates disclosed in JP-A-51-37193, JP-B-2-32293 and JP-B-2-16765, and the urethane compounds having an ethylene oxide skeleton disclosed in JP-B-58-49860, JP-B-56-17654, JP-B-62-39417 and JP-B-62-39418 are also preferably used in the invention. In addition, extremely high speed photopolymerizable compositions can be obtained by using addition polymerizable compounds having an amino structure or a sulfide structure in the molecule as disclosed in JP-A-63-277653, JP-A-63-260909 and JP-A-1-105238.

As other examples of polymerizable monomers, polyfunctional acrylates and methacrylates, such as polyester acrylates, and epoxy acrylates obtained by reacting epoxy resins with (meth)acrylic acids as disclosed in JP-A-48-64183, JP-B-49-43191 and JP-B-52-30490 can be exemplified. The specific unsaturated compounds disclosed in JP-B-46-43946, JP-B-1-40337 and JP-B-1-40336, and the vinyl sulfonic acid compounds disclosed in JP-A-2-25493 can also be exemplified. Further, in some cases, the structures containing a perfluoroalkyl group disclosed in JP-A-61-22048 are preferably used. In addition, the compounds introduced as the photo-curable monomers and oligomers into Bulletin of Nippon Setchaku Kyokai, Vol. 20, No. 7, pp. 300-308 (1984) can also be used.

The details in usage of these addition polymerizable compounds, e.g., what structure is to be used, whether the compounds are to be used alone or in combination, or what an amount is to be used, can be optionally set up according to the final design of the performances of the lithographic printing plate precursor. For example, these conditions are selected on the basis of the following aspects.

In the point of sensitivity, the structure containing many unsaturated groups per a molecule is preferred and bifunctional or higher functional groups are preferred in many cases. For increasing the strength of an image area, i.e., a hardened film, trifunctional or higher functional groups are preferred, and it is also effective to use different functional numbers and different polymerizable groups (e.g., acrylic ester, methacrylic ester, styrene compounds, vinyl ether compounds) in combination to control both speed and strength.

In addition, the selection and usage of addition polymerizable compounds are important factors for the compatibility with other constituents in an image-forming layer (e.g., a binder polymer, a polymerization initiator, a colorant) and dispersibility, for example, in some cases compatibility can be improved by using low purity compounds or two or more compounds in combination. Further, it is also possible to select a compound having a specific structure for the purpose of improving the adhesion property to a support and a protective layer described later.

Polymerizable compounds are used preferably in an amount of from 5 to 80 mass % to the nonvolatile components in an image-forming layer, and more preferably from 25 to 75 mass %. Polymerizable compounds may be used alone, or two or more compounds may be used in combination. In addition, the structure, blending and addition amount of addition polymerizable compounds can be properly selected in view of the degree of polymerization hindrance by oxygen, resolution, a fogging property, refractive index change and surface stickiness and, further, in some cases, a layer constitution and a coating method of undercoating and upper coating may be taken.

### Radical Polymerization Initiator

The radical polymerization initiators that can be used in the invention are compounds capable of generating a radical by light or heat, or both energies, to thereby initiate and accelerate polymerization of a compound having a polymerizable unsaturated group. As the polymerization initiators that can be used in the invention, well-known thermal polymerization initiators, compounds having small bond-dissociating energy, and photopolymerization initiators are exemplified. The radical polymerization initiators that can be preferably used in the invention are compounds generating radicals by heat energy. The radical polymerization initiators used in the invention are specifically described below. Such radical polymerization initiators can be used alone or two or more can be used in combination.

As such radical polymerization initiators, e.g., organic halogen compounds, carbonyl compounds, organic peroxides, azo compounds, azide compounds, metallocene compounds, hexaaryl-biimidazole compounds, organic boron compounds, disulfone compounds, oxime ester compounds, and onium salt compounds are exemplified.

As the organic halogen compounds, specifically, the compounds described in Wakabayashi et al., Bull. Chem. Soc. Japan, 42, 2924 (1969), U.S. Pat. No. 3,905,815, JP-B-46-4605, JP-A-48-36281, JP-A-53-133428, JP-A-55-32070, JP-A-60-239736, JP-A-61-169835, JP-A-61-169837, JP-A-62-58241, JP-A-62-212401, JP-A-63-70243, JP-A-63-298339, and M. P. Hutt, Journal of Heterocyclic Chemistry, 1 (No. 3) (1970) are exemplified. Of these compounds, oxazole compounds substituted with a trihalomethyl group and s-triazine compounds are preferably used.

More preferably, s-triazine derivatives in which at least one mono-, di- or tri-halogen-substituted methyl group is bonded to the s-triazine ring, specifically, e.g., 2,4,6-tris(monochloromethyl)-s-triazine, 2,4,6-tris(dichloro-methyl)-s-triazine, 2,4,6-tris(trichloromethyl)-s-triazine, 2-methyl-4,6-bis(trichloromethyl)-s-triazine, 2-n-propyl-4,6-bis(trichloromethyl)-s-triazine, 2-(α,α,β-trichloro-ethyl)-4,6-bis(trichloromethyl)-s-triazine, 2-phenyl-4,6-bis(trichloromethyl)-s-triazine, 2-(p-methoxyphenyl)-4,6-bis(trichloromethyl)-s-triazine, 2-(3,4-epoxyphenyl)-4,6-bis(trichloromethyl)-s-triazine, 2-(p-chlorophenyl)-4,6-bis(trichloromethyl)-s-triazine, 2-[1-(p-methoxyphenyl)-2,4-butadienyl]-4,6-bis(trichloromethyl)-s-triazine, 2-styryl-4,6-bis(trichloromethyl)-s-triazine, 2-(p-methoxy-styryl)-4,6-bis(trichloromethyl)-s-triazine, 2-(p-1-propyl-oxystyryl)-4,6-bis(trichloromethyl)-s-triazine, 2-(p-tolyl)-4,6-bis(trichloromethyl)-s-triazine, 2-(4-methoxy-naphthyl)-4,6-bis(trichloromethyl)-s-triazine, 2-phenylthio-4,6-bis(trichloromethyl)-s-triazine, 2-benzylthio-4,6-bis(trichloromethyl)-s-triazine, 2,4,6-tris(dibromomethyl)-s-triazine, 2,4,6-tris(tribromomethyl)-s-triazine, 2-methyl-4,6-bis(tribromomethyl)-s-triazine, and 2-methoxy-4,6-bis(tribromomethyl)-s-triazine are exemplified.

As the carbonyl compounds, benzophenone derivatives, e.g., benzophenone, Michler's ketone, 2-methylbenzophenone, 3-methylbenzophenone, 4-methylbenzophenone, 2-chlorobenzo-phenone, 4-bromobenzophenone, and 2-carboxybenzophenone, acetophenone derivatives, e.g., 2,2-dimethoxy-2-phenyl-acetophenone, 2,2-diethoxyacetophenone, 1-hydroxycyclohexyl phenyl ketone, a-hydroxy-2-methylphenylpropanone, 1-hydroxy-1-methylethyl-(p-isopropylphenyl) ketone, 1-hydroxy-1-(p-dodecylphenyl) ketone, 2-methyl-[4′-(methylthio)phenyl]-2-morpholino-1-propanone, and 1,1,1-trichloromethyl-(p-butyl-phenyl) ketone, thioxanthone derivatives, e.g., thioxanthone, 2-ethylthioxanthone, 2-isopropylthioxanthone, 2-chloro-thioxanthone, 2,4-dimethylthioxanthone, 2,4-diethylthio-xanthone, and 2,4-diisopropylthioxanthone, and benzoic ester derivatives, e.g., ethyl p-dimethylaminobenzoate and ethyl p-diethylaminobenzoate are exemplified.

As the azo compounds, the azo compounds disclosed in JP-A-8-108621 are exemplified.

As the organic peroxides, e.g., trimethylcyclohexanone peroxide, acetylacetone peroxide, 1,1-bis(tert-butylperoxy)-3,3,5-trimethylcyclohexane, 1,1-bis(tert-butylperoxy)cyclohexane, 2,2-bis(tert-butylperoxy)butane, tert-butyl hydro-peroxide, cumene hydroperoxide, diisopropylbenzene hydro-peroxide, 2,5-dimethylhexane-2,5-dihydroperoxide, 1,1,3,3-tetramethylbutyl hydroperoxide, tert-butylcumyl peroxide, dicumyl peroxide, 2,5-dimethyl-2,5-di(tert-butylperoxy)-hexane, 2,5-oxanoyl peroxide, succinic acid peroxide, benzoyl peroxide, 2,4-dichlorobenzoyl peroxide, diisopropylperoxy dicarbonate, di-2-ethylhexylperoxy dicarbonate, di-2-ethoxy-ethylperoxy dicarbonate, dimethoxyisopropylperoxy carbonate, di(3-methyl-3-methoxybutyl)peroxy dicarbonate, tert-butyl-peroxy acetate, tert-butylperoxy pivalate, tert-butylperoxy neodecanoate, tert-butylperoxy octanoate, tert-butylperoxy laurate, tersyl carbonate, 3,3′,4,4′-tetra(t-butylperoxy-carbonyl)benzophenone, 3,3′,4,4′-tetra(t-hexylperoxycarbonyl)benzophenone, 3,3′,4,4′-tetra(p-isopropylcumyl-peroxycarbonyl)benzophenone, carbonyldi(t-butylperoxy-dihydrogendiphthalate), and carbonyldi(t-hexylperoxy-dihydrogendiphthalate) are exemplified.

As the metallocene compounds, various titanocene compounds disclosed in JP-A-59-152396, JP-A-61-151197, JP-A-63-41484, JP-A-2-249, JP-A-2-4705 and JP-A-5-83588, e.g., dicyclopentadienyl-Ti-bis-phenyl, dicyclopentadienyl-Ti-bis-2,6-difluorophen-1-yl, dicyclopentadienyl-Ti-bis-2,4-difluorophen-1-yl, dicyclopentadienyl-Ti-bis-2,4,6-trifluorophen-1-yl, dicyclopentadienyl-Ti-bis-2,3,5,6-tetrafluorophen-1-yl, dicyclopentadienyl-Ti-bis-2,3,4,5,6-pentafluorophen-1-yl, dimethylcyclopentadienyl-Ti-bis-2,6-difluorophen-1-yl, dimethylcyclopentadienyl-Ti-bis-2,4,6-trifluorophen-1-yl, dimethylcyclopentadienyl-Ti-bis-2,3,5,6-tetrafluorophen-1-yl, dimethylcyclopentadienyl-Ti-bis-2,3,4,5,6-pentafluorophen-1-yl, and the iron-allene complexes disclosed in JP-A-1-304453 and JP-A-1-152109 are exemplified.

As the hexaarylbiimidazole compounds, various compounds disclosed in JP-B-6-29285, U.S. Pat. Nos. 3,479,185, 4,311,783 and 4,622,286, specifically, e.g., 2,2′-bis(o-chlorophenyl)-4,4′,5,5′-tetraphenylbiimidazole, 2,2′-bis(o-bromophenyl)-4,4′,5,5′-tetraphenylbiimidazole, 2,2′-bis(o,p-dichloro-phenyl)-4,4′,5,5′-tetraphenylbiimidazole, 2,2′-bis-(o-chlorophenyl)-4,4′,5,5′-tetra(m-methoxyphenyl)biimidazole, 2,2′-bis(o,o′-dichlorophenyl)-4,4′,5,5′-tetraphenyl-biimidazole, 2,2′-bis(o-nitrophenyl)-4,4′,5,5′-tetraphenyl-biimidazole, 2,2′-bis(o-methylphenyl)-4,4′,5,5′-tetra-phenylbiimidazole, and 2,2′-bis(o-trifluorophenyl)-4,4′,5,5′-tetraphenylbiimidazole are exemplified.

As the organic boron compounds, e.g., the organic borates disclosed in JP-A-62-143044, JP-A-62-150242, JP-A-9-188685, JP-A-9-188686, JP-A-9-188710, JP-A-2000-131837, JP-A-2002-107916, Japanese Patent No. 2764769, JP-A-2002-116539, and Kunz, Martin, “Rad Tech '98 Proceeding Apr. 19-22, 1998, Chicago”, the organic boron sulfonium complexes or the organic boron oxosulfonium complexes disclosed in JP-A-6-157623, JP-A-6-175564 and JP-A-6-175561, the organic boron iodonium complexes disclosed in JP-A-6-175554 and JP-A-6-175553, the organic boron phosphonium complexes disclosed in JP-A-9-188710, and the organic boron transition metal coordination complexes disclosed in JP-A-6-348011, JP-A-7-128785, JP-A-7-140589, JP-A-7-306527 and JP-A-7-292014 are exemplified.

As the disulfone compounds, the compounds disclosed in JP-A-61-166544 and JP-A-2003-328465 are exemplified.

As the oxime ester compounds, the compounds described in J. C. S. Perkin II, 1653-1660 (1979), J. C. S. Perkin II, 156-162 (1979), Journal of Photopolymer Science and Technology, 202-232 (1995), and JP-A-2000-66385, and the compounds disclosed in JP-A-2000-80068, specifically the compounds represented by the following formulae are exemplified.

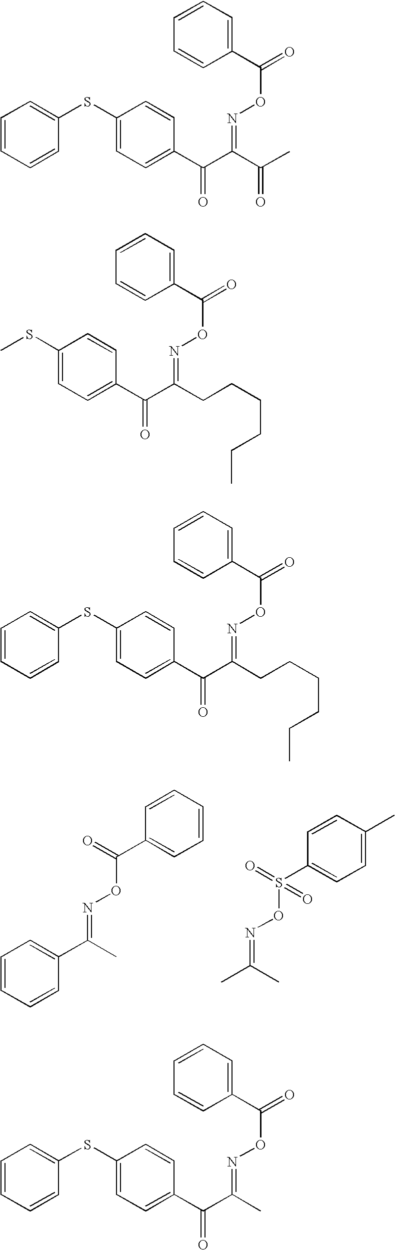

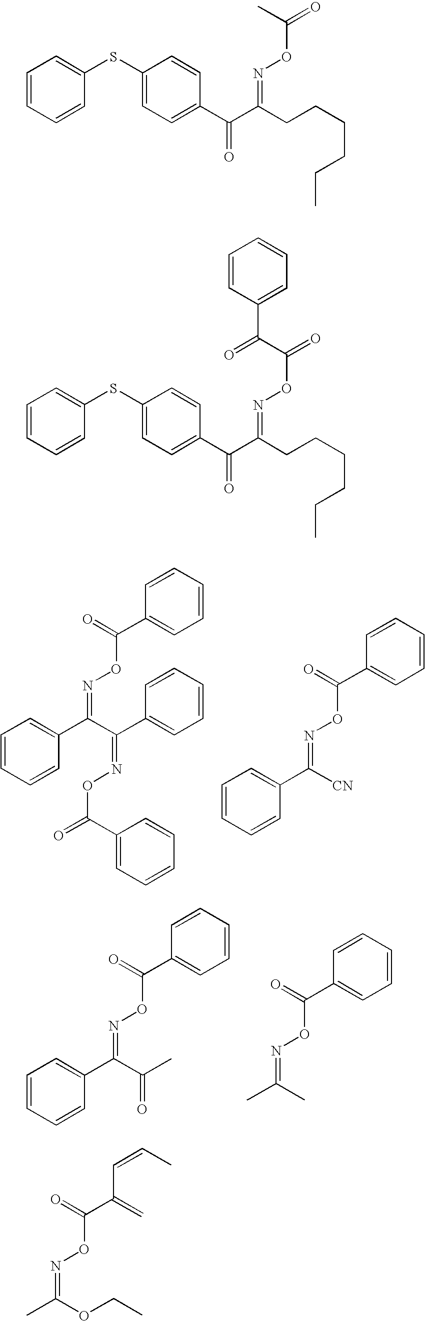

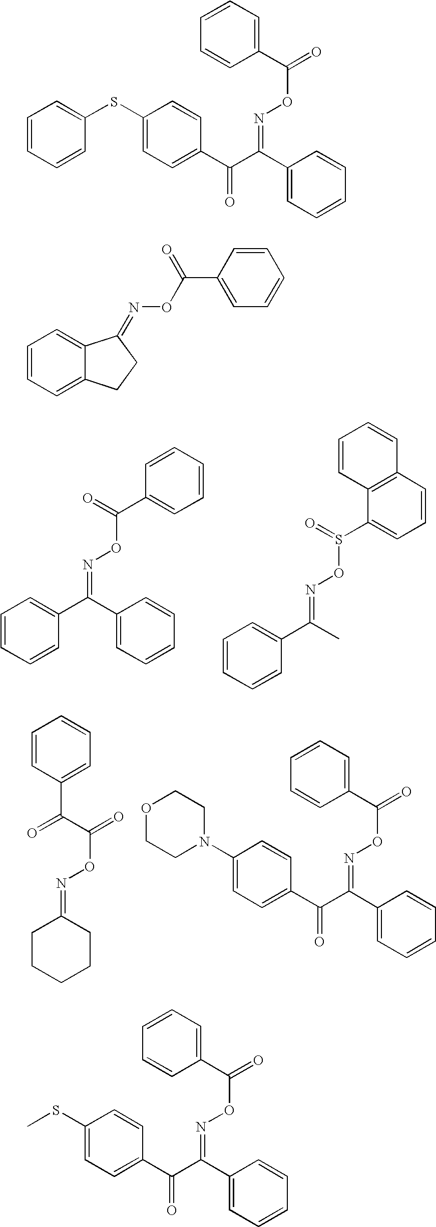

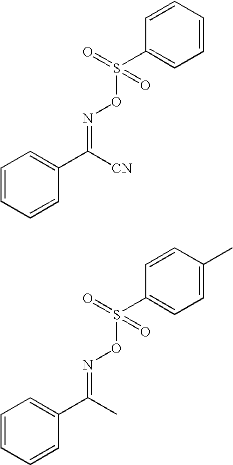

As the onium salt compounds, the onium salt compounds described above as acid generators are exemplified as preferred compounds.

As radical polymerization initiators especially preferred from the aspects of reactivity and stability, the above oxime ester compounds and the onium salts represented by formula (RI-I), (RI-II) or (RI-III) are exemplified.

The addition amount of radical polymerization initiators is from 0.1 to 50 mass % based on the total solids content constituting the layer to be added, preferably from 0.5 to 30 mass %, and especially preferably from 1 to 20 mass %. In this range of the amount, press life is further improved. Radical polymerization initiators may be used alone or two or more compounds may be used in combination. Radical polymerization initiators may be added to the same layer with other constituents, or a different layer may be provided for the addition of radical polymerization initiators.

### Other Image-Forming Layer Constituents

If necessary, additives such as binder polymers, surfactants, colorants, polymerization inhibitors, higher fatty acid derivatives, plasticizers, inorganic fine particles and low molecular weight hydrophilic compounds may further be added to the radical polymerization series image forming layer of the invention. These additives are described below.

### Binder Polymer

Binder polymers can be used in the image-forming layer in the invention. Well-known binder polymers can be used in the invention with no restriction, and linear organic polymers having a film-forming property are preferably used. The examples of such binder polymers include acrylic resins, polyvinyl acetal resins, polyurethane resins, polyurea resins, polyimide resins, polyamide resins, epoxy resins, methacrylic resins, polystyrene resins, novolak type phenolic resins, polyester resin, synthetic rubbers and natural rubbers.

It is preferred that binder polymers have a crosslinking property for the purpose of improving the layer strength of an image area. For giving a crosslinkable property to binder polymers, it is effective to introduce a crosslinkable functional group such as an ethylenic unsaturated bond into the main chain or side chain of binder polymers. The crosslinkable functional group may be introduced by copolymerization.

As the examples of polymers having an ethylenic unsaturated bond in the main chain of the molecule, poly-1,4-butadiene and poly-1,4-isoprene are exemplified.

As the examples of polymers having an ethylenic unsaturated bond in the side chain of the molecule, polymers of esters or amides of acrylic acid or methacrylic acid, wherein the residue of the esters or amides (R of —COOR or —CONHR) has an ethylenic unsaturated bond are exemplified.

The examples of the residues having an ethylenic unsaturated bond (the above-described R) include, —(CH₂)ₙCR¹═CR²R³, —(CH₂O)ₙCH₂CR¹═CR²R³, —(CH₂CH₂O)ₙCH₂CR¹═CR²R³, —(CH₂)ₙNH—CO—O—CH₂CR¹═CR²R³, —(CH₂)ₙ—O—CO—CR¹═CR²R³, and —(CH₂CH₂O)₂—X (wherein R¹, R² and R³ each represents a hydrogen atom, a halogen atom, an alkyl group having from 1 to 20 carbon atoms, an aryl group, an alkoxyl group or an aryloxy group, and R¹ and R² or R³ may be bonded to each other to form a ring, n represents an integer of from 1 to 10, and X represents a dicyclopentadienyl residue).

The specific examples of the ester residues include —CH₂CH═CH₂ (disclosed in JP-B-7-21633), —CH₂CH₂O—CH₂CH═CH₂, —CH₂C(CH₃)═CH₂, —CH₂CH═CH—C₆H₅, —CH₂CH₂OCOCH═CH—C₆H₅, —CH₂CH₂—NHCOO—CH₂CH═CH₂, and —CH₂CH₂O—X (wherein X represents a dicyclopentadienyl residue).

The examples of the amido residues include —CH₂CH═CH₂, —CH₂CH₂—Y (wherein Y represents a cyclohexene residue), and —CH₂CH₂—OCO—CH═CH₂.

When free radicals (polymerization initiation radicals or the grown radicals of a polymerizable monomer in the polymerization process) are added to the crosslinkable functional groups of a binder polymer having a crosslinking property, addition polymerization occurs directly between the polymers or via the polymerization chains of the polymerizable monomer, as a result, crosslinking is formed between the molecules of the polymer and the binder polymer is hardened. Alternatively, the atoms in the polymer (e.g., the hydrogen atoms on the carbon atoms contiguous to crosslinkable functional groups) are extracted by free radicals and polymer radicals are grown, the polymer radicals are bonded to each other, whereby crosslinking is formed between the polymer molecules, so that the binder polymer is hardened.

The content of crosslinkable groups in a binder polymer (the content of radical polymerizable unsaturated double bonds by an iodometric titration method) is preferably from 0.1 to 10.0 mmol per gram of the binder polymer, more preferably from 1.0 to 7.0 mmol, and most preferably from 2.0 to 5.5 mmol. Good sensitivity and good preservation stability can be obtained with this range of the content of crosslinkable groups.

From the viewpoint of the improvement of an on-press developing property, it is preferred that binder polymers have high solubility and dispersibility in ink and/or a fountain solution. For improving the solubility and dispersibility in ink, binder polymers are preferably lipophilic, and for improving the solubility and dispersibility in a fountain solution, binder polymers are preferably hydrophilic. Therefore in the invention, it is also effective to use a lipophilic binder polymer and a hydrophilic binder polymer in combination.

As hydrophilic binder polymers, binder polymers having a hydrophilic group, e.g., a hydroxyl group, a carboxyl group, a carboxylate group, a hydroxyethyl group, a polyoxyethyl group, a hydroxypropyl group, a polyoxypropyl group, an amino group, an aminoethyl group, an aminopropyl group, an ammonium group, an amido group, a carboxymethyl group, a sulfonic acid group and a phosphoric acid group are preferably exemplified.

The specific examples of binder polymers include gum arabic, casein, gelatin, starch derivatives, carboxymethyl cellulose and the sodium salt thereof, cellulose acetate, sodium alginate, vinyl acetate-maleic acid copolymers, styrene-maleic acid copolymers, polyacrylic acids and the salts of them, polymethacrylic acids and the salts of them, homopolymers and copolymers of hydroxyethyl methacrylate, homopolymers and copolymers of hydroxyethyl acrylate, homopolymers and copolymers of hydroxypropyl methacrylate, homopolymers and copolymers of hydroxypropyl acrylate, homopolymers and copolymers of hydroxybutyl methacrylate, homopolymers and copolymers of hydroxybutyl acrylate, polyethylene glycols, hydroxypropylene polymers, polyvinyl alcohols, hydrolyzed polyvinyl acetate having a degree of hydrolysis of 60 mol % or more, preferably 80 mol % or more, polyvinyl formal, polyvinyl butyral, polyvinyl pyrrolidone, homopolymers and copolymers of acrylamide, homopolymers and copolymers of methacrylamide, homopolymers and copolymers of N-methylolacrylamide, polyvinyl pyrrolidone, alcohol-soluble nylon, and polyether of 2,2-bis(4-hydroxyphenyl)propane and epichlorohydrin.

The binder polymers preferably have a mass average molecular weight of preferably 5,000 or higher, more preferably from 10,000 to 300,000, and a number average molecular weight of preferably 1,000 or higher, more preferably from 2,000 to 250,000. The polydisperse degree (mass average molecular weight/number average molecular weight) is preferably from 1.1 to 10.

Binder polymers may be any of random polymers, block polymers and graft polymers, but random polymers are preferred. Binder polymers may be used alone or as a mixture of two or more.

Binder polymers can be synthesized by well-known methods. As the solvents for use in the synthesis, e.g., tetrahydrofuran, ethylene dichloride, cyclohexanone, methyl ethyl ketone, acetone, methanol, ethanol, ethylene glycol monomethyl ether, ethylene glycol monoethyl ether, 2-methoxyethyl acetate, diethylene glycol dimethyl ether, 1-methoxy-2-propanol, 1-methoxy-2-propyl acetate, N,N-dimethylformamide, N,N-dimethylacetamide, toluene, ethyl acetate, methyl lactate, ethyl lactate, dimethyl sulfoxide, and water are exemplified. These solvents may be used alone or two or more solvents may be used as a mixture.

As the radical polymerization initiators used in the synthesis of binder polymers, well-known compounds, e.g., azo initiators and peroxide initiators can be used.

Binder polymers are used in an amount of preferably from 10 to 90 mass % to the total solids content of the image-forming layer, more preferably from 20 to 80 mass %, and still more preferably from 30 to 70 mass %. When binder polymers are used in this range, preferred strength of an image area and good image-forming property can be obtained.

It is preferred to use a polymerizable monomer and a binder polymer in mass ratio of from 1/9 to 7/3.

### Surfactant

In the invention, it is preferred to use a surfactant in an image-forming layer to accelerate on-press development property at the time of initiating printing and to improve the layer surface conditions. As the surfactants for these purposes, nonionic surfactants, anionic surfactants, cationic surfactants, ampholytic surfactants and fluorine surfactants are used. Surfactants may be used alone or two or more surfactants may be used in combination.

The nonionic surfactants for use in the invention are not especially restricted and conventionally well-known surfactants can be used, e.g., polyoxyethylene alkyl ethers, polyoxyethylene alkyl phenyl ethers, polyoxyethylene polystyryl phenyl ethers, polyoxyethylene polyoxypropylene alkyl ethers, glycerol fatty acid partial esters, sorbitan fatty acid partial esters, pentaerythritol fatty acid partial esters, propylene glycol fatty acid monoesters, sucrose fatty acid partial esters, polyoxyethylene sorbitan fatty acid partial esters, polyoxyethylene sorbitol fatty acid partial esters, polyethylene glycol fatty acid esters, polyglycerol fatty acid partial esters, polyoxyethylenated castor oils, polyoxyethylene glycerol fatty acid partial esters, fatty acid diethanolamides, N,N-bis-2-hydroxyalkylamines, polyoxyethylene alkylamine, triethanolamine fatty acid esters, trialkylamine oxide, polyethylene glycol, and copolymers of polyethylene glycol and polypropylene glycol are exemplified.

The anionic surfactants for use in the invention are not particularly restricted and conventionally well-known surfactants can be used, e.g., fatty acid salts, abietates, hydroxyalkanesulfonates, alkanesulfonates, dialkylsulfo-succinates, straight chain alkylbenzenesulfonates, branched chain alkylbenzenesulfonates, alkylnaphthalenesulfonates, alkylphenoxypolyoxyethylenepropylsulfonates, polyoxyethylene alkyl sulfophenyl ethers, sodium N-methyl-N-oleyltaurine, disodium N-alkylsulfosuccinic acid monoamide, petroleum sulfonates, sulfated beef tallow, sulfuric esters of fatty acid alkyl ester, alkylsulfuric esters, polyoxyethylene alkyl ether sulfuric esters, fatty acid monoglyceride sulfuric esters, polyoxyethylene alkyl phenyl ether sulfuric esters, polyoxyethylene styryl phenyl ether sulfuric esters, alkylphosphoric esters, polyoxyethylene alkyl ether phosphoric esters, polyoxyethylene alkyl phenyl ether phosphoric esters, partial saponification products of styrene/maleic anhydride copolymers, partial saponification products of olefin/maleic anhydride copolymers, and naphthalene sulfonate formaldehyde condensation products are exemplified.

The cationic surfactants for use in the invention are not particularly restricted and conventionally well-known surfactants can be used, e.g., alkylamine salts, quaternary ammonium salts, polyoxyethyene alkylamine salts, and polyethylenepolyamine derivatives are exemplified.

The ampholytic surfactants for use in the invention are not particularly restricted and conventionally well-known surfactants can be used, e.g., carboxybetaines, amino-carboxylic acids, sulfobetaines, aminosulfuric esters and imidazolines are exemplified.

In the above surfactants, “polyoxyethylene” can be taken as “polyoxyalkylene” such as polyoxymethylene, polyoxy-propylene, and polyoxybutylene, and these surfactants can also be used in the invention.

As more preferred surfactants, fluorine surfactants containing a perfluoroalkyl group in the molecule are exemplified. As such surfactants, anionic surfactants, e.g., perfluoroalkylcarboxylate, perfluoroalkylsulfonate, and perfluoroalkylphosphate; ampholytic surfactants, e.g., perfluoroalkylbetaine; cationic surfactants, e.g., perfluoroalkyltrimethylammonium salt; and nonionic surfactants, e.g., perfluoroalkylamine oxide, perfluoroalkyl ethylene oxide addition products, oligomers containing a perfluoroalkyl group and a hydrophilic group, oligomers containing a perfluoroalkyl group and a lipophilic group, oligomers containing a perfluoroalkyl group, a hydrophilic group and a lipophilic group, and urethane containing a perfluoroalkyl group and a lipophilic group are exemplified. Further, the fluorine surfactants disclosed in JP-A-62-170950, JP-A-62-226143 and JP-A-60-168144 are also preferably used.

Surfactants can be used alone, or two or more surfactants can be used in combination.

Surfactants are preferably used in an amount of from 0.001 to 10 mass % to all the solids content of the image-forming layer, more preferably from 0.01 to 7 mass %.

### Colorant

If necessary, dyes having great absorption in the visible ray region can be used as the colorants of images in the invention. Specifically, Oil Yellow #101, Oil Yellow #103, Oil Pink #312, Oil Green BG, Oil Blue BOS, Oil Blue #603, Oil Black BY, Oil Black BS, Oil Black T-505 (the products of Orient Chemical Industry Co., Ltd.), Victoria Pure Blue, Crystal Violet (C.I. 42555), Methyl Violet (C.I. 42535), Ethyl Violet, Rhodamine B (C.I. 145170B), Malachite Green (C.I. 42000), Methylene Blue (C.I. 52015), and the dyes disclosed in JP-A-62-293247 can be exemplified. In addition, pigments such as phthalocyanine pigments, azo pigments, carbon black and titanium oxide are also preferably used.

These colorants are preferably added to discriminate an image area from a non-image area after image formation. The addition amount of colorants is preferably in proportion of from 0.01 to 10 mass % to the total solids content of the image-forming layer.

### Polymerization Inhibitor (Thermal Polymerization Preventive)

It is preferred that a small amount of thermal polymerization inhibitor be added to an image-forming layer in the invention for the prevention of unnecessary thermal polymerization of radical polymerizable monomers during manufacture or preservation of the image-forming layer.

As the thermal polymerization inhibitors, e.g., hydroquinone, p-methoxyphenol, di-t-butyl-p-cresol, pyrogallol, t-butylcatechol, benzoquinone, 4,4′-thiobis(3-methyl-6-t-butylphenol), 2,2′-methylenebis(4-methyl-6-t-butylphenol), and N-nitroso-N-phenylhydroxylamine aluminum salt are exemplified.

The addition amount of the thermal polymerization preventive is preferably from about 0.01 to about 5 mass % to the total solids content of an image-forming layer.

### Higher Fatty Acid Derivative and the Like

For preventing the polymerization hindrance due to oxygen, higher fatty acid derivatives, e.g., behenic acid and behenic acid amide, may be added to an image-forming layer in the invention and locally exist on the surface of the image-forming layer in the drying process after coating. The addition amount of the higher fatty acid derivatives is preferably from about 0.1 to about 10 mass % to the total solids content of the image-forming layer.

### Plasticizer

An image-forming layer in the invention may contain a plasticizer to improve an on-press developing property.

The examples of plasticizers include phthalic esters, e.g., dimethyl phthalate, diethyl phthalate, dibutyl phthalate, diisobutyl phthalate, dioctyl phthalate, octylcapryl phthalate, dicyclohexyl phthalate, ditridecyl phthalate, butylbenzyl phthalate, diisodecyl phthalate, and diallyl phthalate; glycol esters, e.g., dimethylglycol phthalate, ethylphthalyl ethylglycolate, methylphthalyl ethylglycolate, butylphthalyl butylglycolate, and triethylene glycol dicaprylate; phosphoric esters, e.g., tricresyl phosphate and triphenyl phosphate; aliphatic dibasic esters, e.g., diisobutyl adipate, dioctyl adipate, dimethyl sebacate, dibutyl sebacate, dioctyl azelate, and dibutyl maleate; and polyglycidyl methacrylate, triethyl citrate, glycerol triacetyl ester and butyl laurate.

The amount of plasticizers is preferably about 30 mass % or less to the total solids content of the image-forming layer.

### Inorganic Fine Particles

For the improvement of the hardened layer strength of an image area and the on-press developing property of a non-image area, an image-forming layer may contain inorganic fine particles.

As the inorganic fine particles, e.g., silica, alumina, magnesium oxide, titanium oxide, magnesium carbonate, calcium alginate and mixtures of these fine particles are preferably used. Even when inorganic fine particles are not light/heat convertible, they can be used for layer strengthening and the reinforcement of interfacial adhesion by surface roughening.

The average particle size of the inorganic fine particles is preferably from 5 nm to 10 μm, more preferably from 0.5 to 3 μm. When the average particle size is in this range, the inorganic fine particles are stably dispersed in the image-forming layer, and the layer strength of the image-forming layer can be sufficiently maintained, so that a non-image area difficult to be soiled and excellent in hydrophilicity can be formed.

These inorganic fine particles are easily available as commercial products of colloidal silica dispersion and the like.

The addition amount of the inorganic fine particles is preferably 20 mass % or less to the total solids content of the image-forming layer, more preferably 10 mass % or less.

### Low Molecular Weight Hydrophilic Compound

For the improvement of an on-press developing property, an image-forming layer in the invention may contain hydrophilic low molecular weight compounds. As the hydrophilic low molecular weight compounds, water-soluble organic compounds, such as glycols, e.g., ethylene glycol, diethylene glycol, triethylene glycol, propylene glycol, dipropylene glycol, tripropylene glycol, and ether or ester derivatives of these glycols, polyhydroxies, e.g., glycerol and pentaerythritol, organic amines, e.g., triethanolamine, diethanolamine and monoethanolamine, and salts thereof, organic sulfonic acids, e.g., toluenesulfonic acid and benzenesulfonic acid, and salts thereof, organic phosphonic acids, e.g., phenylphosphonic acid, and salts thereof, and organic carboxylic acids, e.g., tartaric acid, oxalic acid, citric acid, malic acid, lactic acid, gluconic acid and amino acid, and salts of these organic carboxylic acids are exemplified.

### Formation of Radical Polymerization Type Image-Forming Layer

For adding the above constituents of image-forming layer to an image-forming layer, some methods can be used in the invention. One means is dissolving the constituents in an appropriate solvent and coating as disclosed in JP-A-2002-287334, and another means is encapsulating the constituents in microcapsules and adding to an image-forming layer (a microcapsule-type image-forming layer) as disclosed in JP-A-2001-277740 and JP-A-2001-277742. In addition, in a microcapsule-type image-forming layer, the constituents may also be contained outside of the microcapsules. In a microcapsule-type image-forming layer, it is preferred to contain hydrophobic constituents in microcapsules and hydrophilic constituents outside of the microcapsules.

The constituents of an image-forming layer can be microencapsulated by well-known methods. For example, as the manufacturing method of microcapsules, a method making use of coacervation as disclosed in U.S. Pat. Nos. 2,800,457 and 2,800,458, an interfacial polymerization method as disclosed in U.S. Pat. No. 3,287,154, JP-B-38-19574 and JP-B-42-446, a method by the precipitation of a polymer as disclosed in U.S. Pat. Nos. 3,418,250 and 3,660,304, a method of using isocyanate polyol wall materials as disclosed in U.S. Pat. No. 3,796,669, a method of using isocyanate wall materials as disclosed in U.S. Pat. No. 3,914,511, a method of using urea-formaldehyde or urea-formaldehyde-resorcinol wall materials as disclosed in U.S. Pat. Nos. 4,001,140, 4,087,376 and 4,089,802, a method of using melamine-formaldehyde resin or hydroxy cellulose wall materials as disclosed in U.S. Pat. No. 4,025,445, a monomer polymerization in situ method as disclosed in JP-B-36-9163 and JP-B-51-9079, a spray drying method as disclosed in British Patent 930,422 and U.S. Pat. No. 3,111,407, and an electrolytic dispersion cooling method as disclosed in British Patents 952,807 and 967,074 can be exemplified, but the invention is not limited to these methods.

The microcapsule walls preferably used in the invention have a three dimensional crosslinking structure and a property of swelling by a solvent. From this point of view, polyurea, polyurethane, polyester, polycarbonate, polyamide, and the mixtures of these compounds are preferably used as the microcapsule wall materials, and polyurea and polyurethane are particularly preferred. Compounds having crosslinkable functional groups such as ethylenic unsaturated bonds that can be introduced into the above binder polymers may be used in microcapsule walls.

The average particle size of the microcapsules is preferably from 0.01 to 3.0 μm, more preferably from 0.05 to 2.0 μm, and especially preferably from 0.10 to 1.0 μm. Good resolution and aging stability can be obtained in this range of the particle size.

In the invention, each constituent of an image-forming layer, especially preferably the above infrared absorber and compound represented by formula (1) may be encapsulated in resin fine particles.

This embodiment can be achieved by using resin fine particle dispersion prepared by dissolving each constituent in a solvent and blending with a polymer solution (preferably an aqueous solution of a polymer) by a homogenizer.

As the solvents that can be used at this time, ethyl acetate, methyl ethyl ketone (MEK), diisopropyl ether, dichloromethane, chloroform, toluene, dichloroethane, and mixed solvents of these solvents are exemplified.

As the above polymers, polyvinyl alcohol (PVA), polyacrylic acid, sodium polyacrylate, polyacrylamide, polymethacrylic acid, sodium polymethacrylate, polymethacrylamide, polystyrenesulfonic acid, sodium polystyrenesulfonate, acrylic acid-methyl acrylate copolymer, methacrylic acid-methyl methacrylate copolymer, and styrene-sodium styrenesulfonate copolymer are exemplified.

An image-forming layer in the invention is formed by coating a coating solution prepared by dispersing or dissolving the above necessary constituents in a solvent. As the solvents used here, ethylene dichloride, cyclohexanone, methyl ethyl ketone, methanol, ethanol, propanol, ethylene glycol monomethyl ether, 1-methoxy-2-propanol, 2-methoxyethyl acetate, 1-methoxy-2-propyl acetate, dimethoxyethane, methyl lactate, ethyl lactate, N,N-dimethylacetamide, N,N-dimethyl-formamide, tetramethylurea, N-methylpyrrolidone, dimethyl sulfoxide, sulforan, γ-butyrolactone, toluene, and water are exemplified, but the solvents are not limited thereto. These solvents are used alone or as mixture. The concentration of the solids content of the coating solution is preferably from 1 to 50 mass %.

It is also possible to form an image-forming layer in the invention by preparing a plurality of coating solutions by dispersing or dissolving the same or different constituents in the same or different solvents, and repeating the coating and drying a plurality of times.

The coating amount of an image-forming layer (solids content) obtained on a support after coating and drying is generally preferably from 0.3 to 3.0 g/m², although the coating amount differs depending upon the usage of the image-forming layer. Good sensitivity and good layer properties of the image-forming layer can be obtained in this range of the coating amount.

As the coating method, various coating methods can be used, e.g., bar coating, rotary coating, spray coating, curtain coating, dip coating, air knife coating, blade coating, and roll coating can be used.

(B) Image-Forming Constituent of Hydrophobitizing Precursor:

### Hydrophobitizing Precursor

Hydrophobilizing precursors in the invention are fine particles capable of converting a hydrophilic image-forming layer to hydrophobic upon heating. Such fine particles are preferably at least fine particles selected from thermoplastic polymer fine particles and thermo-reactive polymer fine particles. Further, the fine particles may be microcapsules encapsulating a compound having a thermo-reactive group.

As the thermoplastic polymer fine particles used in an image-forming layer in the invention, the thermoplastic polymer fine particles described in Research Disclosure, No. 33303, January (1992), JP-A-9-123387, JP-A-9-131850, JP-A-9-171249, JP-A-9-171250, and EP 931,647 can be exemplified as preferred polymer fine particles. The specific examples of the polymers constituting these polymer fine particles include homopolymers or copolymers of monomers such as ethylene, styrene, vinyl chloride, methyl acrylate, ethyl acrylate, methyl methacrylate, ethyl methacrylate, vinylidene chloride, acrylonitrile, and vinyl carbazole, and mixtures thereof. Of these polymers, polystyrene and polymethyl methacrylate are more preferred.

The average particle size of the thermoplastic polymer fine particles for use in the invention is preferably from 0.01 to 2.0 μm. As the synthesizing methods of these thermoplastic polymer fine particles, a method of dissolving the above compounds in a non-aqueous organic solvent, mixing and emulsifying the solution with an aqueous solution containing a dispersant, and applying heat to the emulsion to thereby solidify the emulsion to a fine particle state with volatizing the organic solvent (a dissolution dispersion method) can be used, in addition to an emulsion polymerization method and a suspension polymerization method.

As the thermo-reactive polymer fine particles used in the invention, thermosetting polymer fine particles and polymer fine particles having a thermo-reactive group are exemplified.

As the thermosetting polymers, resins having a phenolic skeleton, urea resins (e.g., resins obtained by the resinification of urea or urea derivatives such as methoxymethylated urea, with aldehydes, e.g., formaldehyde), melamine resins (e.g., resins obtained by the resinification of melamine or melamine derivatives with aldehydes, e.g., formaldehyde), alkyd resins, unsaturated polyester resins, polyurethane resins, and epoxy resins can be exemplified. Of these resins, resins having a phenolic skeleton, melamine resins, urea resins and epoxy resins are especially preferred.

As preferred resins having a phenolic skeleton, e.g., phenolic resins obtained by resinifying phenol or cresol with aldehydes, e.g., formaldehyde, hydroxystyrene resins, and polymers and copolymers of methacrylamide or acrylamide or methacrylate or acrylate having a phenolic skeleton such as N-(p-hydroxyphenyl)methacrylamide and p-hydroxyphenyl methacrylate can be exemplified.

The average particle size of the thermosetting polymer fine particles for use in the invention is preferably from 0.01 to 2.0 μm. These thermosetting polymer fine particles can be easily obtained by a dissolution dispersion method, but a thermosetting polymer may be made fine particles when the thermosetting polymer is synthesized. The invention is not limited to these methods.

As the thermo-reactive groups of the polymer fine particles having a thermo-reactive group used in the invention, functional groups showing any reaction can be used so long as chemical bonds are formed. Ethylenic unsaturated groups showing a radical polymerization reaction (e.g., an acryloyl group, a methacryloyl group, a vinyl group, an allyl group, etc.), cationic polymerizable groups (e.g., a vinyl group, a vinyloxy group, etc.), isocyanate groups showing an addition reaction or blocks thereof, epoxy groups, vinyloxy groups and functional groups having active hydrogen atoms of the other side compounds of the reaction (e.g., an amino group, a hydroxyl group, a carboxyl group, etc.), carboxyl groups showing a condensation reaction and hydroxyl groups and amino groups of the other side compounds of the reaction, and acid anhydrides showing a ring opening addition reaction and amino groups and hydroxyl groups of the other side compounds of the reaction can be preferably exemplified.

These functional groups may be introduced into polymer fine particles in the time of polymerization or they may be added after polymerization by a polymer reaction.

When functional groups are introduced in the time of polymerization, it is preferred that the monomers having these functional groups are emulsion polymerized or suspension polymerized. The specific examples of the monomers having the functional groups include allyl methacrylate, allyl acrylate, vinyl methacrylate, vinyl acrylate, 2-(vinyloxy)ethyl methacrylate, p-vinyloxystyrene, p-[2-(vinyloxy)ethyl]-styrene, glycidyl methacrylate, glycidyl acrylate, 2-isocyanate ethyl methacrylate or block isocyanate thereof by alcohol, 2-isocyanate ethyl acrylate or block isocyanate thereof by alcohol, 2-aminoethyl methacrylate, 2-aminoethyl acrylate, 2-hydroxyethyl methacrylate, 2-hydroxyethyl acrylate, acrylic acid, methacrylic acid, maleic anhydride, bifunctional acrylate, and bifunctional methacrylate, but the invention is not limited to these compounds.

In the invention, copolymers of these monomers and monomers copolymerizable with these monomers not having thermo-reactive groups can also be used. As the examples of copolymerizable monomers not having thermo-reactive groups, styrene, alkyl acrylate, alkyl methacrylate, acrylonitrile and vinyl acetate can be exemplified, for instance, but monomers not having thermo-reactive groups are not limited to these monomers.

As the polymer reaction used in the case where the thermo-reactive groups are introduced after polymerization, the polymer reactions disclosed in WO 96/34316 can be exemplified.

Of the above polymer fine particles having thermo-reactive groups, polymers fine particles that are coalesced with each other by heat are preferred, and those having hydrophilic surfaces and dispersible in water are especially preferred. It is preferred that the contact angle of a film (a water droplet in air) prepared by coating only polymer fine particles, and drying the particles by a temperature lower than the solidification temperature is lower than the contact angle of a film (a water droplet in air) prepared by drying by a temperature higher than the solidification temperature. For making the surfaces of polymer fine particles hydrophilic, it is effective to let a hydrophilic polymer or oligomer, e.g., polyvinyl alcohol or polyethylene glycol, or a low molecular weight compound be adsorbed onto the surfaces of the polymer fine particles. However, the methods of surface hydrophilization treatment are not limited thereto.

The solidification temperature of these polymer fine particles having thermo-reactive groups is preferably 70° C. or higher, but considering the aging stability, 100° C. or higher is more preferred. The average particle size of the polymer fine particles is preferably from 0.01 to 2.0 μm, more preferably from 0.05 to 2.0 μm, and especially preferably from 0.1 to 1.0 μm. Good resolution and aging stability can be obtained in this range of average particle size.

As the thermo-reactive groups in the microcapsules encapsulating a compound having a thermo-reactive group for use in the invention, the same thermo-reactive groups as used in the polymer fine particles having thermo-reactive groups are preferably exemplified. Compounds having a thermo-reactive group are described below.

As the compound having a radical polymerizable unsaturated group, the same compounds as shown in the radical polymerizable microcapsules are preferably used.

As the compound having a vinyloxy group preferably used in the invention, the compounds disclosed in JP-A-2002-29162 are exemplified. As the specific examples, tetramethylene glycol divinyl ether, trimethylolpropane trivinyl ether, tetraethylene glycol divinyl ether, pentaerythritol divinyl ether, pentaerythritol trivinyl ether, pentaerythritol tetravinyl ether, 1,4-bis[2-(vinyloxy)ethyloxy]benzene, 1,2-bis[2-(vinyloxy)ethyloxy]benzene, 1,3-bis[2-(vinyloxy)ethyloxy]benzene, 1,3,5-tris[2-(vinyloxy)ethyloxy]benzene, 4,4′-bis[2-(vinyloxy)ethyloxy]biphenyl, 4,4′-bis[2-(vinyloxy)ethyloxy]diphenyl ether, 4,4′-bis[2-(vinyloxy)ethyloxy]diphenylmethane, 1,4-bis[2-(vinyloxy)ethyloxy]naphthalene, 2,5-bis[2-(vinyloxy)ethyloxy]furan, 2,5-bis[2-(vinyloxy)ethyloxy]thiophene, 2,5-bis[2-(vinyloxy)ethyloxy]imidazole, 2,2-bis {4-[2-(vinyloxy)ethyloxy]phenyl}propane [bis(vinyloxyethyl)ether of bisphenol A], 2,2-bis[4-(vinyloxymethyloxy)phenyl]propane, and 2,2-bis[4-(vinyloxy)phenyl]propane are exemplified, but the invention is not limited to these compounds.

As the compound having an epoxy group suitably used in the invention, compounds having 2 or more epoxy groups are preferred, and glycidyl ether compounds obtained by the reaction of polyhydric alcohol or polyhydric phenol with epichlorohydrin and prepolymers thereof, and polymers and copolymers of glycidyl acrylate or glycidyl methacrylate can be exemplified.

The specific examples thereof include propylene glycol diglycidyl ether, tripropylene glycol diglycidyl ether, polypropylene glycol diglycidyl ether, neopentyl glycol diglycidyl ether, trimethylolpropane triglycidyl ether, diglycidyl ether of hydrogenated bisphenol A, hydroquinone diglycidyl ether, resorcinol diglycidyl ether, diglycidyl ether of bisphenol A or epichlorohydrin polyaddition products, diglycidyl ether of bisphenol F or epichlorohydrin polyaddition products, diglycidyl ether of halogenated bisphenol A or epichlorohydrin polyaddition products, diglycidyl ether of biphenyl-type bisphenol or epichlorohydrin polyaddition products, glycidyl etherified products of novolak resins, methyl methacrylate/glycidyl methacrylate copolymers, and ethyl methacrylate/glycidyl methacrylate copolymers.

Commercially available products of these compounds include, e.g., Epicote 1001 (molecular weight: about 900, epoxy equivalence: 450-500), Epicote 1002 (molecular weight: about 1,600, epoxy equivalence: 600-700), Epicote 1004 (molecular weight: about 1,060, epoxy equivalence: 875-975), Epicote 1007 (molecular weight: about 2,900, epoxy equivalence: 2,000), Epicote 1009 (molecular weight: about 3,750, epoxy equivalence: 3,000), Epicote 1010 (molecular weight: about 5,500, epoxy equivalence: 4,000), Epicote 1100L (epoxy equivalence: 4,000), Epicote YX31575 (epoxy equivalence: 1,200) (all of the above Epicote series products are manufactured by Japan Epoxy Resin Co., Ltd.), Sumiepoxy ESCN-195×HN, ESCN-195XL and ESCN-195XF (manufactured by Sumitomo Chemical Co., Ltd.), etc.

As the isocyanate compounds preferably used in the invention, tolylene diisocyanate, diphenylmethane diisocyanate, polymethylene polyphenyl polyisocyanate, xylylene diisocyanate, naphthalene diisocyanate, cyclohexane phenylene diisocyanate, isophorone diisocyanate, hexamethylene diisocyanate, cyclohexyl diisocyanate, and blocked products of these compounds with alcohol or amine can be exemplified.

As amine compounds preferably used in the invention, ethylenediamine, diethylenetriamine, triethylenetetramine, hexamethylenediamine, propylenediamine and polyethyleneimine are exemplified.

As the compounds having a hydroxyl group preferably used in the invention, compounds having methylol groups at terminals, polyhydric alcohols such as pentaerythritol and bisphenol polyphenols are exemplified.

As the compounds having a carboxyl group preferably used in the invention, aromatic polycarboxylic acids, e.g., pyromellitic acid, trimellitic acid, and phthalic acid, and aliphatic polycarboxylic acids, e.g., adipic acid, are exemplified. As the acid anhydrides preferably used in the invention, pyromellitic anhydride and benzophenone-tetracarboxylic anhydride are exemplified.

The compounds having a thermo-reactive group can be microencapsulated by the well-known methods described above in the radical polymerization.

### Other Image-Forming Layer Constituents

For the purpose of improving an on-press developing property and the layer strength of an image-forming layer itself, the image-forming layer in the invention can contain hydrophilic resins. As the hydrophilic resins, resins having a hydrophilic group, e.g., a hydroxyl group, an amino group, a carboxyl group, a phosphoric acid group, a sulfonic acid group, or an amido group are preferred. Further, since hydrophilic resins are crosslinked by the reaction with the thermo-reactive group of a hydrophobitizing precursor to thereby increase image strength and resistance to press, it is preferred that the hydrophilic resins have a group reactive with thermo-reactive groups. For example, when hydrophobitizing precursors have a vinyloxy group or an epoxy group, hydrophilic resins having a hydroxyl group, a carboxyl group, a phosphoric acid group or a sulfonic acid group are preferred. Hydrophilic resins having a hydroxyl group or a carboxyl group are especially preferred.

The specific examples of the hydrophilic resins include gum arabic, casein, gelatin, starch derivative, soya gum, hydroxypropyl cellulose, methyl cellulose, carboxymethyl cellulose and sodium salts thereof, cellulose acetate, sodium alginate, vinyl acetate-maleic acid copolymers, styrene-maleic acid copolymers, polyacrylic acids and salts of them, polymethacrylic acids and salts of them, homopolymers and copolymers of hydroxyethyl methacrylate, homopolymers and copolymers of hydroxyethyl acrylate, homopolymers and copolymers of hydroxypropyl methacrylate, homopolymers and copolymers of hydroxypropyl acrylate, homopolymers and copolymers of hydroxybutyl methacrylate, homopolymers and copolymers of hydroxybutyl acrylate, polyethylene glycols, hydroxypropylene polymers, polyvinyl alcohols, hydrolyzed polyvinyl acetate having a hydrolysis degree of at least 60 mol %, preferably at least 80 mol %, polyvinyl formal, polyvinyl pyrrolidone, homopolymers and copolymers of acrylamide, homopolymers and copolymers of methacrylamide, homopolymers and copolymers of N-methylolacrylamide, homopolymers and copolymers of 2-acrylamide-2-methyl-1-propanesulfonic acid, and homopolymers and copolymers of 2-methacryloyloxyethyl-sulfonic acid.

The addition amount of the hydrophilic resins to an image forming layer is preferably 20 mass % or less, more preferably 10 mass % or less.

The hydrophilic resins may be crosslinked in advance in such a degree that an unexposed area can be subjected to on-press development. The examples of the crosslinking agents include aldehydes, e.g., glyoxal, melamine-formaldehyde resin, and urea-formaldehyde resin, methylol compounds, e.g., N-methylolurea, N-methylolmelamine, and methylolated polyamide resin, active vinyl compounds, e.g., divinylsulfone and bis(P-hydroxyethylsulfonic acid), epoxy compounds, e.g., epichlorohydrin, polyethylene glycol diglycidyl ether, polyamide, polyamine, epichlorohydrin addition products, and polyamide-epichlorohydrin resins, ester compounds, e.g., monochloroacetic ester and thioglycolic ester, polycarboxylic acids, e.g., polyacrylic acid and methyl vinyl ether/maleic acid copolymers, inorganic crosslinking agents, e.g., boric acid, titanyl sulfate, Cu, Al, Sn, V, Cr salts, and modified polyamide-polyimide resins. In addition, crosslinking catalysts such as ammonium chloride, silane coupling agents, and titanate coupling agents can be used in combination.

An image-forming layer in the invention can contain reaction accelerators for initiating or accelerating the reaction of the thermo-reactive groups. As such reaction accelerators, the photo-acid generators or radical generators in the discoloration system and radical polymerization initiators in the polymerization system can be exemplified as preferred accelerators.

The reaction accelerators can be used in combination of two or more. The reaction accelerators may be directly added to an image-forming layer coating solution, or may be added to the polymer fine particles. The content of the reaction accelerators in an image-forming layer is preferably from 0.01 to 20 mass % of the total solids content of the image-forming layer, more preferably from 0.1 to 10 mass %. On-press developing properties are not impaired and good reaction initiation and accelerating effect can be ensured in this range of the reaction accelerator content.

In the image-forming layer utilizing hydrophobitizing precursor series of the invention, polyfunctional monomers can be added to the matrix of the image-forming layer for further increasing the press life. As the polyfunctional monomers, the polymerizable monomers exemplified above can be used. Trimethylolpropane triacrylate and pentaerythritol triacrylate are exemplified as especially preferred monomers.

Further, if necessary, the hydrophobitizing precursor series image-forming layer can contain additives such as the surfactants, polymerization inhibitors, higher fatty acid derivatives, plasticizers, inorganic fine particles and low molecular weight hydrophilic compounds described in the item of “Other Image-Forming Layer Constituents” in the polymerization series image-forming layer.

### Formation of Hydrophobitizing Precursor Series Image-Forming Layer

Similarly to the case of the radical polymerization series image-forming layer, the hydrophobitizing precursor series image-forming layer in the invention is formed by preparing a coating solution by dispersing or dissolving the above necessary constituents in a solvent, and coating the coating solution on a support and drying.

The coating weight (solids content) of the image-forming layer on a support obtained after coating and drying is generally preferably from 0.5 to 5.0 g/m², although it differs according to the use.

A lithographic printing plate precursor capable of on-press development can be manufactured by using the hydrophobitizing precursor series image-forming layer.

On the other hand, by making the hydrophobitizing precursor series image-forming layer “a hydrophilic layer having a crosslinking structure” having sufficient resistance to press even when the image-forming layer is unexposed, the lithographic printing plate precursor in the invention can be applied to a non-processing (non-development) type lithographic printing plate precursor.

It is preferred for a hydrophilic layer having such a crosslinking structure to contain at least one kind of a hydrophilic resin having a crosslinking structure and an inorganic hydrophilic binder resin formed by sol/gel conversion. Of these resins, the hydrophilic resin is described first. By the addition of the hydrophilic resin, the affinity of the hydrophilic layer layer for the hydrophilic constituents in emulsion ink is increased and, at the same time, the film strength of the image-forming layer itself is also improved. As the hydrophilic resins, resins having a hydrophilic group, e.g., hydroxyl, carboxyl, hydroxyethyl, hydroxypropyl, amino, aminoethyl, aminopropyl and carboxymethyl groups, are preferred.

The specific examples of the hydrophilic resins include gum arabic, casein, gelatin, starch derivative, carboxymethyl cellulose and sodium salts thereof, cellulose acetate, sodium alginate, vinyl acetate-maleic acid copolymers, styrene-maleic acid copolymers, polyacrylic acids and salts thereof, polymethacrylic acids and salts thereof, homopolymers and copolymers of hydroxyethyl methacrylate, homopolymers and copolymers of hydroxyethyl acrylate, homopolymers and copolymers of hydroxypropyl methacrylate, homopolymers and copolymers of hydroxypropyl acrylate, homopolymers and copolymers of hydroxybutyl methacrylate, homopolymers and copolymers of hydroxybutyl acrylate, polyethylene glycols, hydroxypropylene polymers, polyvinyl alcohols, hydrolyzed polyvinyl acetate having a hydrolysis degree of at least 60 mol %, preferably at least 80 mol %, polyvinyl formal, polyvinyl butyral, polyvinyl pyrrolidone, homopolymers and copolymers of acrylamide, homopolymers and copolymers of methacrylamide, and homopolymers and copolymers of N-methylolacrylamide.

When the hydrophilic resin is used in an image-forming layer in the invention, it is effective to use the hydrophilic resin by crosslinking. As crosslinking agents for forming a crosslinking structure, the compounds exemplified above as the crosslinking agents are used.

As a preferred non-processing (non-development) type image-forming layer, an image-forming layer containing an inorganic hydrophilic binder resin formed by sol/gel conversion can be exemplified. Preferred sol/gel convertible binder resins are polymers wherein the bonding groups of polyvalent elements form a network structure, i.e., a three-dimensional crosslinking structure, via oxygen atoms and, at the same time, polyvalent metals also have hydroxyl groups and alkoxyl groups not bonded and they are mixed and form resinous structure. The systems are in a sol state at a stage abundant in alkoxyl groups and hydroxyl groups, and the network resinous structure comes to heighten with the advancement of dehydration condensation. The polyvalent bonding elements of the compounds having sol/gel convertible hydroxyl groups and alkoxyl groups are aluminum, silicon, titanium and zirconium, and all of which can be used in the invention. More preferred sol/gel convertible systems are those using silicon, and particularly preferred system is a sol/gel convertible system containing a silane compound having at least one silanol group. A sol/gel convertible system using silicon is described below. Sol/gel conversions using aluminum, titanium and zirconium can also be carried out by the substitution of the silicon in the following description with respective elements.

Sol/gel convertible binder resins are preferably resins having a siloxane bond and a silanol group, and a coating solution of sol system containing a compound having at least one silanol group is used in an image-forming layer in the invention. Condensation and gelation of the silanol group progress during coating and drying processes, and the structure of a siloxane skeleton is formed.

In an image-forming layer containing a sol/gel convertible binder resin, the above hydrophilic resins and crosslinking agents can be used in combination for the purpose of the improvement of physical properties, e.g., layer strength and the flexibility of the layer, and the betterment of coating property.

A siloxane resin for forming a gel structure is represented by the following formula (II), and a silane compound having at least one silanol group is represented by the following formula (III). A material added to an image-forming layer need not be a silane compound represented by formula (III) alone and, in general, the material may comprise an oligomer of a silane compound partially condensed, or may be mixture of a silane compound represented by formula (III) and the oligomer.

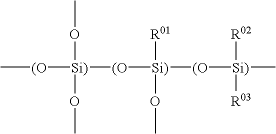

A siloxane resin represented by formula (II) is formed by sol/gel conversion from dispersion containing at least one silane compound represented by formula (III). In formula (II), at least one of R⁰¹, R⁰² and R⁰³ represents a hydroxyl group, and the remaining represent an organic residue selected from R⁰ and Y in formula (III).
(R⁰)ₙSi(Y)₄₋ₙ (III)

In formula (III), R⁰ represents a hydroxyl group, a hydrocarbon group or a heterocyclic group; Y represents a hydrogen atom, a halogen atom, —OR¹, —OCOR² or —N(R³)(R⁴); R¹ and R² each represents a hydrocarbon group; R³ and R⁴, which may be the same or different, each represents a hydrocarbon group or a hydrogen atom; and n represents 0, 1, 2 or 3.

The examples of the hydrocarbon group or the heterocyclic group represented by R⁰ include, e.g., a straight chain or branched alkyl group having from 1 to 12 carbon atoms which may be substituted (e.g., a methyl group, an ethyl group, a propyl group, a butyl group, a pentyl group, a hexyl group, a heptyl group, an octyl group, a nonyl group, a decyl group, a dodecyl group, etc., as the substituents of these groups, a halogen atom (a chlorine atom, a fluorine atom, a bromine atom), a hydroxyl group, a thiol group, a carboxyl group, a sulfo group, a cyano group, an epoxy group, an —OR′ group (R′ represents a methyl group, an ethyl group, a propyl group, a butyl group, a heptyl group, a hexyl group, an octyl group, a decyl group, a propenyl group, a butenyl group, a hexenyl group, an octenyl group, a 2-hydroxyethyl group, a 3-chloropropyl group, a 2-cyanoethyl group, an N,N-dimethylaminoethyl group, a 2-bromoethyl group, a 2-(2-methoxyethyl)oxyethyl group, a 2-methoxycarbonylethyl group, a 3-carboxyethyl group, a 3-carboxypropyl group, a benzyl group, etc.), an —OCOR″ group (R″ has the same meaning as R′ above), a —COOR″ group, a —COR″ group, an —N(R′″)(R′″) group (R′″ represents a hydrogen atom or the same meaning as R′, and two R′″ may be the same or different), an —NHCONHR″ group, an —NHCOOR″ group, an —Si(R″)₃ group, and a —CONHR″ group are exemplified, and a plurality of substituents may be substituted on the alkyl group); a straight chain or branched alkenyl group having from 2 to 12 carbon atoms which may be substituted (e.g., a vinyl group, a propenyl group, a butenyl group, a pentenyl group, a hexenyl group, an octenyl group, a decenyl group, a dodecenyl group, etc., as the substituents of these groups, the same groups described above as the substituents of the alkyl group can be exemplified); an aralkyl group having from 7 to 14 carbon atoms which may be substituted (e.g., a benzyl group, a phenethyl group, a 3-phenylpropyl group, a naphthylmethyl group, a 2-naphthylethyl group, as the substituents of these groups, the same groups described above as the substituents of the alkyl group can be exemplified, and a plurality of substituents may be substituted on the aralkyl group); an alicyclic group having from 5 to 10 carbon atoms which may be substituted (e.g., a cyclopentyl group, a cyclohexyl group, a 2-cyclohexylethyl group, a norbornyl group, an adamantyl group, etc., as the substituents of these groups, the same groups described above as the substituents of the alkyl group can be exemplified, and a plurality of substituents may be substituted on the alicyclic group); an aryl group having from 6 to 12 carbon atoms which may be substituted (e.g., a phenyl group, a naphthyl group, and as the substituents of these groups, the same groups described above as the substituents of the alkyl group can be exemplified, and a plurality of substituents may be substituted on the aryl group); and a heterocyclic group containing at least one atom selected from a nitrogen atom, an oxygen atom and a sulfur atom which may be condensed (e.g., a pyran ring, a furan ring, a thiophene ring, a morpholine ring, a pyrrole ring, a thiazole ring, an oxazole ring, a pyridine ring, a piperidine ring, a pyrrolidone ring, a benzothiazole ring, a benzoxazole ring, a quinoline ring, a tetrahydrofuran ring, etc., each of which may have a substituent, and as the substituents of these groups, the same groups described above as the substituents of the alkyl group can be exemplified, and a plurality of substituents may be substituted).

The substituents of the —OR¹ group, —OCOR² group or —N(R³)(R⁴) group represented by Y in formula (III) are as follows. In the —OR¹ group, R¹ represents an aliphatic group having from 1 to 10 carbon atoms which may be substituted (e.g., a methyl group, an ethyl group, a propyl group, a butyl group, a heptyl group, a hexyl group, a pentyl group, an octyl group, a nonyl group, a decyl group, a propenyl group, a butenyl group, a heptenyl group, a hexenyl group, an octenyl group, a decenyl group, a 2-hydroxyethyl group, a 2-hydroxypropyl group, a 2-methoxyethyl group, a 2-(2-methoxyethyl)oxyethyl group, a 2-(N,N-dimethylamino)ethyl group, a 2-methoxypropyl group, a 2-cyanoethyl group, a 3-methyloxypropyl group, a 2-chloroethyl group, a cyclohexyl group, a cyclopentyl group, a cyclooctyl group, a chlorocyclohexyl group, a methoxycyclohexyl group, a benzyl group, a phenethyl group, a dimethoxybenzyl group, a methylbenzyl group, a bromobenzyl group, etc.).

In the —OCOR² group, R² represents an aliphatic group of the same meaning as in R¹, or an aromatic group having from 6 to 12 carbon atoms which may be substituted (as the aromatic group, those described above in the aryl group represented by R can be exemplified). In the —N(R³)(R⁴) group, R³ and R⁴, which may be the same or different, each represents a hydrogen atom or an aliphatic group having from 1 to 10 carbon atoms which may be substituted (e.g., the same groups described in R¹ of the —OR¹ group can be exemplified). More preferably, the total number of the carbon atoms of R³ and R⁴ is not more than 16. As the specific examples of the silane compounds represented by formula (III), the following compounds can be exemplified, but the invention is not limited to these compounds.

The specific examples of the silane compounds include tetrachlorosilane, tetramethoxysilane, tetraethoxysilane, tetraisopropoxysilane, tetra-n-propylsilane, methyltrichlorosilane, methyltrimethoxysilane, methyltriethoxysilane, ethyltrichlorosilane, ethyltrimethoxysilane, ethyltriethoxysilane, n-propyltrichlorosilane, n-propyltrimethoxysilane, n-hexyltrimethoxysilane, n-decyltrimethoxysilane, phenyltrichlorosilane, phenyltrimethoxysilane, dimethoxyditriethoxysilane, dimethyldichlorosilane, dimethyldimethoxysilane, diphenyldimethoxysilane, phenylmethyldimethoxysilane, triethoxyhydrosilane, trimethoxyhydrosilane, vinyltrichlorosilane, vinyltrimethoxysilane, trifluoropropyltrimethoxysilane, γ-glycidoxypropylmethyldimethoxysilane, γ-glycidoxypropylmethyldiethoxysilane, γ-glycidoxypropyltriethoxysilane, γ-methacryloxypropyltrimethoxysilane, γ-aminopropylmethyldimethoxysilane, γ-aminopropyltriethoxysilane, γ-mercaptopropylmethyldimethoxysilane, γ-mercaptopropyltrimethoxysilane, γ-mercaptopropyltriethoxysilane, and β-(3,4-epoxycyclohexyl)ethyltrimethoxysilane.

Together with a silane compound represented by formula (III), metallic compounds capable of conjoining with resins to form a film at the time of sol/gel conversion, e.g., Ti, Zn, Sn, Zr, Al, etc., can be used in an image-forming layer in combination. The examples of the metallic compounds for use for this purpose include, e.g., Ti(OR″)₄, TiCl₄, Zn(OR″)₂, Zn(CH₃COCHCOCH₃)₂, Sn(OR″)₄, Sn(CH₃COCHCOCH₃)₄, Sn(OCOR″)₄, SnCl₄, Zr(OR″)₄, Zr(CH₃COCHCOCH₃)₄, (NH₄)₂ZrO(CO₃)₂, Al(OR″)₃, Al(CH₃COCHCOCH₃)₃, etc. (wherein R″ represents a methyl group, an ethyl group, a propyl group, a butyl group, a pentyl group, or a hexyl group).

For accelerating the hydrolysis and polycondensation reaction of the silane compound represented by formula (III) and the above metallic compound to be used in combination, it is preferred to use an acidic catalyst or a basic catalyst conjointly. As the catalyst, an acidic or basic compound may be used as it is, or may be dissolved in a solvent, e.g., water or alcohol (hereinafter referred to as an acidic catalyst or a basic catalyst). The concentration of catalyst is not particularly restricted but when the concentration is high, hydrolysis and polycondensation reaction are liable to become fast. However, when a basic catalyst in high concentration is used, a precipitate is formed in the sol solution in some cases, so that the concentration of basic catalyst is preferably 1N (in terms of the concentration in an aqueous solution) or less.

The specific examples of the acidic catalysts include hydroghalogenic acid such as hydrochloric acid, carboxylic acids such as nitric acid, sulfuric acid, sulfurous acid, hydrogen sulfide, perchloric acid, hydrogen peroxide, carbonic acid, formic acid and acetic acid, and and sulfonic acid such as benzenesulfonic acid. The specific examples of the basic catalysts include ammoniacal bases such as aqueous ammonia, and amines such as ethylamine and aniline, but the catalysts are not limited to these compounds.

An image-forming layer produced by the sol/gel method described above is particularly preferred as the constitution of the image-forming layer according to the present invention. The details of the sol/gel method are described in Sumio Sakka, Sol/Gel Ho no Kagaku (Chemistry of Sol/Gel Method), Agune Shofu-Sha Co. (1988), and Hiroshi Hirashima, Saishin Sol/Gel Ho ni yoru Kino-Sei Hakumaku Sakusei Gijutsu (Producing Techniques of Functional Thin Films by the Latest Sol/Gel Methods), Sogo Gijutsu Center (1992).

The addition amount of the hydrophilic resins to an image forming layer having a crosslinking structure is preferably from 5 to 70 mass % of the solids content of the image-forming layer, more preferably from 5 to 50 mass %.

The thickness of the image-forming layer is preferably from 0.1 to 10 μm, more preferably from 0.5 to 5 μm, in the point of press life.

### Support

Supports for use in the lithographic printing plate precursor in the invention are not especially restricted and any materials can be used so long as they are hydrophilic and dimensionally stable plate-like materials. For example, paper, paper laminated with plastics (e.g., polyethylene, polypropylene, polystyrene, etc.), metal plates (e.g., aluminum, zinc, copper, etc.), plastic films (e.g., cellulose diacetate, cellulose triacetate, cellulose propionate, cellulose butyrate, cellulose acetate butyrate, cellulose nitrate, polyethylene terephthalate, polyethylene, polystyrene, polypropylene, polycarbonate, polyvinyl acetal, etc.), and paper and plastic films laminated or deposited with the above metals can be exemplified as the materials of the support. Preferred supports are a polyester film and an aluminum plate. Above all, aluminum plates, which are dimensionally stable and comparatively inexpensive, are preferred.

Aluminum plates are a pure aluminum plate, alloy plates containing aluminum as a main component and a trace amount of different elements, and aluminum or aluminum alloy thin films laminated with plastics. The examples of different elements contained in aluminum alloys include silicon, iron, manganese, copper, magnesium, chromium, zinc, bismuth, nickel, titanium, etc. The different element content in aluminum alloys is preferably 10 mass % or less. In the invention, a pure aluminum plate is preferred but 100% pure aluminum is difficult to produce from the refining technique, accordingly an extremely small amount of different elements may be contained. Thus, the compositions of aluminum plates used in the invention are not specified, and aluminum plates of conventionally well known and commonly used materials can be optionally used.

A support for use in the invention has a thickness of preferably from 0.1 to 0.6 mm, more preferably from 0.15 to 0.4 mm, and still more preferably from 0.2 to 0.3 mm.

Prior to the use of an aluminum plate, it is preferred for the aluminum plate to be subjected to surface treatment, e.g., surface roughening treatment and hydrophilic film forming treatment. By surface treatment, the improvement of hydrophilicity and the security of the adhesion of an image forming layer and a support become easy. Prior to the surface roughening treatment of an aluminum plate, if necessary, degreasing treatment with a surfactant, an organic solvent or an alkaline aqueous solution is carried out to remove the rolling oil on the surface of an aluminum plate.

### Surface Roughening Treatment

Surface roughening treatment of the surface of an aluminum plate is performed by various methods, e.g., mechanical surface roughening treatment, electrochemical surface roughening treatment (surface roughening treatment of electrochemically dissolving the surface), and chemical surface roughening treatment (surface roughening treatment of chemically selectively dissolving the surface) are exemplified.

As the method of mechanical surface roughening treatment, well-known methods, e.g., a ball rubbing method, a brush abrading method, a blast abrading method, or a buffing method, can be used.

As the method of electrochemical surface roughening treatment, a method of roughening in an electrolyte containing an acid such as a hydrochloric acid or a nitric acid by alternating current or direct current can be used. Further, a method of using mixed acids can be used as disclosed in JP-A-54-63902.

### Formation of Hydrophilic Layer

The aluminum plate having been subjected to the surface roughening treatment and other treatments according to necessity is subjected to the treatment for forming a hydrophilic layer having low thermal conductivity. The thermal conductivity of the hydrophilic layer in the layer thickness direction is 0.05 W/mK or more, preferably from 0.08 to 0.5 W/mK, more preferably 0.3 W/mK or less, and still more preferably 0.2 W/mK or less. When the thermal conductivity of the hydrophilic layer in the layer thickness direction is from 0.05 to 0.5 W/mK, the diffusion of the heat generated in the image-forming layer by laser exposure to the support can be prevented. As a result, when the lithographic printing plate precursor is used as an on-press development type or non-processing type lithographic printing plate precursor, the heat generated by laser exposure can be effectively used, so that high sensitivity, sufficient printing image formation and printing-out image formation become possible.

The thermal conductivity of a hydrophilic film in the thickness direction prescribed in the invention is described below. Various measuring methods of thermal conductivity of a thin film have so far been reported. ONO et al. have reported the thermal conductivity of a thin film in the plane direction by using a thermograph in 1986. Further, a trial to apply an alternating current heating method to the measurement of thermal physical properties of a thin film is reported. The origin of the alternating current heating method can be retroactive to the report in 1863. Various measuring methods are proposed in recent years by the development of a heating method by laser and by the combination with Fourier transform. Apparatus using a laser angstrom method are really now on the market. All of these methods are to find the thermal conductivity of a thin film in the plane direction (in-plane direction).

However, thermal diffusion in the depth direction is a rather important factor in considering the thermal conduction of a thin film. It is said that the thermal conductivity of a thin film is not isotropic as reported variously, and in particular in the case of the invention, the direct measurement of the thermal conductivity of a thin film in the layer thickness direction is very important. From this point of view, as a trial to measure the thermal physical properties of a thin film in the layer thickness direction, the method using a thermocomparator is reported in Lambropoulos et al., J. Appl. Phys., 66 (9) (1 Nov. 1989) and Henager et al., Applied Optics, Vol. 32, No. 1 (1 Jan. 1993).

Further, in recent years, a method of measuring thermal diffusivity of a polymer thin film by the temperature wave thermal analysis applying Fourier analysis is reported in Hashimoto et al, Netsu Sokutei (Thermal Measurement), 27 (3) (2000).

The thermal conductivity of a hydrophilic film in the thickness direction prescribed in the invention is measured by the above method of using a thermocomparator. The measuring method of the above method is specifically described below, but the fundamental principles of the method are described in detail in the article of Lambropoulos et al. and the article of Henager et al. In the invention, measurement was performed with a thermocomparator shown in FIG. 3 in JP-A-2003-103951 and according to the method disclosed in the same patent.

The relationships between each temperature and the heat conductivities of the film are as shown be the following equation (1).

$$\frac{( {T}_{r} - {T}_{b} )}{( {T}_{r} - {T}_{t} )} = ( \frac{4 {K}_{1} {r}_{1}}{{K}_{tf} {A}_{3}} ) t + [ 1 + ( \frac{4 {K}_{1} {r}_{1}}{{K}_{2} {A}_{2}} ) {t}_{2} + ( \frac{{K}_{1} {r}_{1}}{{K}_{4} {r}_{1}} ) ]$$

The signs in the equation are as follows.

Tₜ: Temperature at the tip of chip

T_{b}: Temperature of heat sink

Tᵣ: Temperature of reservoir

K_{tf}: Thermal conductivity of film

K₁: Thermal conductivity of reservoir

K₂: Thermal conductivity of chip (in the case of oxygen free copper: 400 W/mK)

K₄: Thermal conductivity of metal substrate (in the case of not having a thin film)

r₁: Radius of curvature of the tip of chip

A₂: Contact area of reservoir and chip

A₃: Contact area of chip and film

t: Thickness of film

t₂: Contact thickness (about 0)

By measuring each temperature (Tₜ, T_{b} and Tᵣ) and plotting with changing the film thickness (t), the gradient of equation (1) and the thermal conductivity of the film (K_{tf}) can be found. That is, as is apparent from equation (1), the gradient is a value determined by the thermal conductivity of the reservoir (K₁), the radius of curvature of the tip of the chip (r1), the thermal conductivity of the film (K_{tf}), and the contact area of the chip and the film (A₃), and K₁, r1 and A₃ are already known values, so that K_{tf} can be obtained from the gradient.

The present inventors searched for the thermal conductivity of the hydrophilic film (an anodic oxide film Al₂O₃) formed on the aluminum substrate according to the above measuring method. The temperature was measured with changing the film thickness, and the thermal conductivity of Al₂O₃ found from the gradient of the resulted graph was 0.69 W/mK. This value well coincides with the results in the article of Lambropoulos et al., and this result also shows that the thermal physical value of the thin film is different from the thermal physical value of the bulk (the thermal conductivity of Al₂O₃ of bulk is 28 W/mK).

When the above measuring method is used in the measurement of the thermal conductivity in the thickness direction of a hydrophilic film of a lithographic printing plate precursor in the invention, a result free of dispersion can be preferably obtained even with a roughened surface for lithographic printing by making the tip of a chip minute and maintaining the pressing load constant. It is preferred to find the value of thermal conductivity as the average value of measurement at a plurality of different points on a sample, e.g., at five points.

From the aspects of scratch resistance and press life, the thickness of a hydrophilic film is preferably 0.1 μm or more, more preferably 0.3 μm or more, and especially preferably 0.6 μm or more, and considering from the manufacturing costs that a great energy is required for forming a thick film, the thickness is preferably 5 μm or less, more preferably 3 μm or less, and especially preferably 2 μm or less.

It is preferred that the hydrophilic film in the invention has a density of from 1,000 to 3,200 kg/m³ from the thermal insulating effect, film strength and soiling resistance in printing.

The density can be computed according to the following equation from the mass measured by a Mason method (a weighing method of anodic oxide film by dissolution with a chromic acid/phosphoric acid mixed solution) and the film thickness obtained by observing the cross section of a film with an SEM.
Density (kg/cm³)=(mass of a hydrophilic film per a unit area/film thickness)

The forming methods of a hydrophilic film are not especially restricted, and an anodizing method, a vacuum evaporation method, a CVD method, a sol/gel method, a sputtering method, an ion plating method, and a diffusing method can be arbitrarily used. Further, it is also possible to use a method of coating a solution obtained by mixing hollow particles in a hydrophilic resin or a sol/gel solution.

A process of producing an oxide by anodization, that is, using an anodizing process, is most preferred. Anodizing process can be carried out by the methods conventionally used in the industry. Specifically, by the application of DC or AC to an aluminum plate in an aqueous solution or nonaqueous solution comprising sulfuric acid, phosphoric acid, chromic acid, oxalic acid, sulfamic acid or benzenesulfonic acid alone or in combination of two or more, an anodic oxide film that is a hydrophilic film can be formed on the surface of the aluminum plate. The conditions of anodizing process change variously by the electrolytes used and cannot be determined unconditionally, but generally the concentration of an electrolyte of from 1 to 80 mass %, a liquid temperature of from 5 to 70° C., electric current density of from 0.5 to 60 A/dm², voltage of from 1 to 200 V, and electrolysis time of from 1 to 1,000 seconds are preferred. Of the anodizing processes, the anodizing process in a sulfuric acid electrolyte by high electric current density as disclosed in British Patent 1,412,768, and the anodizing process with a phosphoric acid as the electrolytic bath as disclosed in U.S. Pat. No. 3,511,661 are preferred. It is also possible to perform a multi-stage anodizing process comprising anodization in a sulfuric acid electrolyte and further anodization in a phosphoric acid.

In the points of scratch resistance and press life, the anodic oxide film in the invention is preferably 0.1 g/m² or more, more preferably 0.3 g/m² or more, still more preferably 2 g/m² or more, and especially preferably 3.2 g/m² or more. Considering that a great energy is required for forming a thick film, the anodic oxide film in the invention is preferably 100 g/m² or less, more preferably 40 g/m² or less, and especially preferably 20 g/m² or less.

Minute concavities called micro pores evenly distributed are formed on the surface of an anodic oxide film. The density of micro pores on the surface of an anodic oxide film can be controlled by arbitrarily selecting the processing conditions. The thermal conductivity in the thickness direction of an anodic oxide film can be made from 0.05 to 0.5 W/mK by increasing the density of micro pores. In addition, the diameter of micro pores can be adjusted by arbitrarily selecting the processing conditions. The thermal conductivity in the thickness direction of an anodic oxide film can be made from 0.05 to 0.5 W/mK by making the diameter of micro pores larger.

It is preferred in the invention to perform a pore widening process of enlarging the pore diameter of micro pores after anodizing process for the purpose of lowering the thermal conductivity. The pore widening process is a process of dissolving an anodic oxide film by immersing an aluminum substrate on which an anodic oxide film is formed in an acid aqueous solution or an alkali aqueous solution to thereby enlarge the pore diameter of micro pores. The pore widening process is performed in the range of the dissolving amount of an anodic oxide film of preferably from 0.01 to 20 g/m², more preferably from 0.1 to 5 g/m², and particularly preferably from 0.2 to 4 g/m².

When an acid solution is used in a pore widening process, it is preferred to use an aqueous solution of inorganic acid such as sulfuric acid, phosphoric acid, nitric acid or hydrochloric acid, or an aqueous solution of the mixture of these acids. The concentration of an acid aqueous solution is preferably from 10 to 1,000 g/liter, more preferably from 20 to 500 g/liter. The temperature of an acid aqueous solution is preferably from 10 to 90° C., more preferably from 30 to 70° C. The time of immersion in an acid aqueous solution is preferably from 1 to 300 seconds, more preferably from 2 to 100 seconds. On the other hand, when an alkali aqueous solution is used in a pore widening process, it is preferred to use an aqueous solution containing at least one alkali selected from the group consisting of sodium hydroxide, potassium hydroxide and lithium hydroxide. The pH of an alkali aqueous solution is preferably from 10 to 13, more preferably from 11.5 to 13.0. The temperature of an alkali aqueous solution is preferably from 10 to 90° C., more preferably from 30 to 50° C. The time of immersion in an alkali aqueous solution is preferably from 1 to 500 seconds, more preferably from 2 to 100 seconds. However, too large an enlargement of the micro pore diameter on the outermost surface results in the deterioration of soiling resistance in printing, so that the micro pore diameter on the outermost surface is preferably 40 nm or less, more preferably 20 nm or less, and most preferably 10 nm or less. Accordingly, heat insulating property and soiling resistance can be compatible. As more preferred anodic oxide film, a surface micro pore diameter is from 0 to 40 nm and an inside micro pore diameter is from 20 to 300 nm. It is known that when the kind of the electrolyte is the same, the pore diameter of the pore that occurs by the electrolysis is proportional to the electrolytic voltage at the time of electrolysis. By making use of the nature, a method of forming pores having a widened bottom part can be used by gradually increasing electrolytic voltage. It is also known that a pore diameter changes by changing the kind of electrolyte, and a pore diameter becomes larger in the order of a sulfuric acid, an oxalic acid, and a phosphoric acid. Accordingly, a method of anodization of using a sulfuric acid in the electrolyte of the first stage and a phosphoric acid in the second stage can be used. In addition, a support for a lithographic printing plate obtained by an anodizing process and/or a pore widening process may be subjected to a sealing process described later.

In addition to the above anodic oxide film, a hydrophilic film may be an inorganic film formed by a sputtering method, a CVD method, etc. As the compounds constituting an inorganic film, e.g., oxide, nitride, silicide, boride and carbide are exemplified. An inorganic film may be composed of a single substance of a compound alone or may be composed of a mixture of compounds. As the compounds constituting an inorganic film, aluminum oxide, silicon oxide, titanium oxide, zirconium oxide, hafnium oxide, vanadium oxide, niobium oxide, tantalum oxide, molybdenum oxide, tungsten oxide, chromium oxide; aluminum nitride, silicon nitride, titanium nitride, zirconium nitride, hafnium nitride, vanadium nitride, niobium nitride, tantalum nitride, molybdenum nitride, tungsten nitride, chromium nitride, silicon nitride, boron nitride; titanium silicide, zirconium silicide, hafnium silicide, vanadium silicide, niobium silicide, tantalum silicide, molybdenum silicide, tungsten silicide, chromium silicide; titanium boride, zirconium boride, hafnium boride, vanadium boride, niobium boride, tantalum boride, molybdenum boride, tungsten boride, chromium boride; aluminum carbide, silicon carbide, titanium carbide, zirconium carbide, hafnium carbide, vanadium carbide, niobium carbide, tantalum carbide, molybdenum carbide, tungsten carbide, chromium carbide are specifically exemplified.

### Sealing Process

As described above, in the invention, a support for a lithographic printing plate provided with a hydrophilic film may be subjected to a sealing process. As the sealing process used in the invention, sealing processes of an anodic oxide film by steam sealing under pressure and boiling water sealing as disclosed in JP-A-4-176690 and JP-A-11-301135 are exemplified. Well-known sealing processes can also be used in the invention, e.g., a silicate process, a bichromate aqueous solution process, a nitrite process, an ammonium acetate process, an electrodeposition sealing process, a triethanolamine process, a barium carbonate process, and a sealing process by boiling water containing a trace amount of phosphate, can be used. A forming system of a sealing process film varies according to the manner of sealing process, for example, a sealing process film is formed from the bottom of a pore when sealing is performed by an electrodeposition sealing process and a sealing process film is formed from the top of a pore when steam sealing is performed. In addition, an immersing process in a solution, a spraying process, a coating process, a vacuum deposition process, sputtering, ion plating, flame spray coating and metal plating are exemplified as sealing processes, but the process of sealing is not especially restricted in the invention. As a particularly preferred process, a sealing process using particles having an average particle size of from 8 to 800 nm as disclosed in JP-A-2002-214764 is exemplified.

The average particle size of the particles used in the sealing process using particles is from 8 to 800 nm, preferably from 10 to 500 nm, and more preferably from 10 to 150 nm. When sealing is performed with this range of particles, there is no possibility of the particles entering into the micro pores on a hydrophilic film and the effect of increasing sensitivity can be sufficiently obtained, further, the adhesion of a support with an image-forming layer is sufficient and excellent press life can be ensured. The thickness of a particle layer is preferably from 8 to 800 nm, and more preferably from 10 to 500 nm.

The thermal conductivity of the particles used in the invention is preferably 60 W/mK or less, more preferably 40 W/mK or less, and particularly preferably from 0.3 to 10 W/mK. When the thermal conductivity is 60 W/mK or less, the diffusion of heat to an aluminum substrate can be sufficiently controlled and the effect of increasing sensitivity can be sufficiently obtained.

As the method of forming a particle layer, e.g., an immersing process in a solution, a spraying process, a coating process, an electrolytic process, a vacuum deposition process, sputtering, ion plating, flame spray coating and metal plating are exemplified, but the method is not especially restricted.

An electrolytic process is performed with DC or AC. As the waveforms of AC used in the electrolytic process, a sine wave, a rectangular wave, a triangular wave and a trapezoidal wave are exemplified. From the viewpoint of the manufacturing costs of an electric power unit, the frequencies of AC are preferably from 30 to 200 Hz, more preferably from 40 to 120 Hz. When a trapezoidal wave is used as the waveform of AC, the time required for the electric current to reach the peak from 0 (tp) is preferably from 0.1 to 2 msec, more preferably from 0.3 to 1.5 msec. When tp is less than 0.1 msec, great source voltage is required in the time of the rise of current waveform by the influence of impedance of power circuit, so that installation costs of electric source sometimes becomes high.

As hydrophilic particles, it is preferred to use Al₂O₃, TiO₂, SiO₂ or ZrO₂ alone or in combination of two or more. An electrolyte can be obtained by suspending the above hydrophilic particles in water and the like so that the content of the particles becomes from 0.01 to 20 mass % of the total content. The pH of an electrolyte can be adjusted by adding, e.g., a sulfuric acid, to be charged positively or negatively. Electrolytic process is performed, e.g., by using DC with an aluminum plate as the cathode and with the above electrolyte on the conditions of the voltage of from 10 to 200 V for 1 to 600 seconds. According to this method, micro pores can be easily sealed while leaving voids in the micro pores on the anodic oxide film.

As sealing processes, the methods of providing any of the following layers by coating are exemplified, e.g., a layer comprising a compound having at least one amino group, and at least one group selected from the group consisting of a carboxyl group and a group of the salt thereof, a sulfo group and a group of the salt thereof as disclosed in JP-A-60-149491, a layer comprising a compound having at least one amino group and at least one hydroxyl group, and a compound selected from the salts thereof as disclosed in JP-A-60-232998, a layer containing a phosphate as disclosed in JP-A-62-19494, and a layer comprising a polymer compound having at least one monomer unit having a sulfo group as the repeating unit in the molecule as disclosed in JP-A-59-101651.

The methods of providing a layer of a compound selected from the following compounds are also exemplified, e.g., carboxymethyl cellulose; dextrin; gum arabic; phosphonic acids having an amino group such as 2-aminoethylphosphonic acid; organic phosphonic acids such as phenylphosphonic acid, naphthylphosphonic acid, alkylphosphonic acid, glycerophosphonic acid, methylenediphosphonic acid, ethylene-diphosphonic acid, each of which may have a substituent; organic phosphoric esters such as phenylphosphoric ester, naphthylphosphoric ester, alkylphosphoric ester, glycero-phosphoric ester, each of which may have a substituent; organic phosphinic acids such as phenylphosphinic acid, naphthyl-phosphinic acid, alkylphosphinic acid, glycerophosphinic acid, each of which may have a substituent; amino acids such as glycine, β-alanine; and amine hydrochloride having a hydroxyl group such as triethanolamine hydrochloride.

Coating of a silane coupling agent having an unsaturated group can also be used in sealing process. The examples of silane coupling agents include N-3-(acryloxy-2-hydroxypropyl)-3-aminopropyltriethoxysilane, (3-acryloxypropyl)-dimethylmethoxysilane, (3-acryloxypropyl)methyldimethoxy-silane, (3-acryloxypropyl)trimethoxysilane, 3-(N-allylamino)propyltrimethoxysilane, allyldimethoxysilane, allyltriethoxysilane, allyltrimethoxysilane, 3-butenyl-triethoxysilane, 2-(chloromethyl)allyltrimethoxysilane, methacrylamidopropyltriethoxysilane, N-(3-methacryloxy-2-hydroxypropyl)-3-aminopropyltriethoxysilane, (methacryloxy-methyl)dimethyethoxysilane, methacryloxymethyltriethoxy-silane, methacryloxymethyltrimethoxysilane, methacryloxypropyldimethylethoxysilane, methacryloxypropyldimethyl-methoxysilane, methacryloxypropylmethyldiethoxysilane, methacryloxypropylmethyldimethoxysilane, methacryloxy-propylmethyltriethoxysilane, methacryloxypropylmethyl-trimethoxysilane, methacryloxypropyltris(methoxyethoxy)-silane, methoxydimethylvinylsilane, 1-methoxy-3-(trimethyl-siloxy)butadiene, styrylethyltrimethoxysilane, 3-(N-styrylmethyl-2-aminoethylamino)propyltrimethoxysilane hydrochloride, vinyldimethylethoxysilane, vinyldiphenyl-ethoxysilane, vinylmethyldiethoxysilane, vinylmethyl-dimethoxysilane, O-(vinyloxyethyl)-N-(triethoxysilyl-propyl)urethane, vinyltriethoxysilane, vinyltrimethoxy-silane, vinyltri-t-butoxysilane, vinyltriisopropoxysilane, vinyltriphenoxysilane, vinyltris(2-methoxyethoxy)silane, and diallylaminopropylmethoxysilane. Of these silane coupling agents, silane coupling agents having a methacryloyl group or an acryloyl group fast in the reactivity of an unsaturated group are preferred.

Besides the above, a sol/gel coating process as disclosed in JP-A-5-50779, a coating process of phosphonic acids as disclosed in JP-A-5-246171, a method of processing the material for back coating by coating as disclosed in JP-A-6-234284, JP-A-6-191173 and JP-A-6-230563, a process of phosphonic acids as disclosed in JP-A-6-262872, a coating process as disclosed in JP-A-6-297875, an anodizing process as disclosed in JP-A-10-109480, and an immersion processing method as disclosed in JP-A-2000-81704 and JP-A-2000-89466 are exemplified, and any method can be used.

After forming a hydrophilic film, if necessary, the surface of the aluminum plate is subjected to hydrophilizing process. As the hydrophilizing process, alkali metal silicate methods as disclosed in U.S. Pat. Nos. 2,714,066, 3,181,461, 3,280,734 and 3,902,734 are known. These methods comprise immersion processing of a support in an aqueous solution of sodium silicate, or electrolytic processing. In addition, a method of processing an aluminum plate with potassium fluorozirconate as disclosed in JP-B-36-22063, and methods of processing with polyvinylphosphonic acid as disclosed in U.S. Pat. Nos. 3,276,868, 4,153,461 and 4,689,272 are exemplified.

When a polyester film insufficient in a hydrophilic property of surface is used as a support in the invention, it is preferred to coat a hydrophilic layer to make the surface hydrophilic. As the hydrophilic layers, a hydrophilic layer provided by coating a coating solution containing the colloid of oxide or hydroxide of at least one element selected from beryllium, magnesium, aluminum, silicon, titanium, boron, germanium, tin, zirconium, iron, vanadium, antimony and transition metals as disclosed in JP-A-2001-199175, a hydrophilic layer having an organic hydrophilic matrix obtained by the crosslinking or pseudo-crosslinking of an organic hydrophilic polymer as disclosed in JP-A-2002-79772, a hydrophilic layer having an inorganic hydrophilic matrix obtained by sol/gel conversion comprising hydrolysis and condensation reaction of polyalkoxysilane, titanate, zirconate or aluminate, and a hydrophilic layer comprising an inorganic thin film having a surface containing a metallic oxide are preferred. Of these hydrophilic layers, a hydrophilic layer provided by coating a coating solution containing the colloid of oxide or hydroxide of silicon is preferred.

When a polyester film is used as a support in the invention, it is preferred to provide an antistatic layer on the hydrophilic layer side of the support, or on the opposite side to the hydrophilic layer, or on both sides. When an antistatic layer is provided between a support and a hydrophilic layer, the antistatic layer also contributes to the adhesion of the hydrophilic layer and the support. A polymer layer containing the dispersion of metallic oxide fine particles and a matting agent as disclosed in JP-A-2002-79772 can be used as the antistatic layer.

It is preferred that a support for use in the invention has a central line average surface roughness of from 0.10 to 1.2 μm. In this range of average surface roughness, good adhesion of the support and an image-forming layer, good press life and good soiling resistance can be obtained.

The color density of a support is preferably from 0.15 to 0.65 in terms of a reflection density value. A good image forming property due to antihalation in the time of image exposure and a good plate-detecting property after development can be obtained when the color density of a support is in this range.

### Back Coat Layer

After surface treatment of a support or after forming an undercoat layer, if necessary, a backcoat can be provided on the back surface of the support.

As the backcoat, e.g., coating layers comprising organic polymer compounds as disclosed in JP-A-5-45885, and coating layers comprising metallic oxides obtained by hydrolysis and polycondensation of organic or inorganic metallic compounds as disclosed in JP-A-6-35174 are preferably used. Alkoxy compounds of silicon, e.g., Si(OCH₃)₄, Si(OC₂H₅)₄, Si(OC₃H₇)₄, Si(OC₄H₉)₄, etc., are preferably used for the inexpensiveness and easy availability of the materials.

### Undercoat Layer

In the lithographic printing plate precursor in the invention, if necessary, an undercoat layer can be provided between an image-forming layer and a support. Since the undercoat layer functions as a heat insulating layer, the heat generated by infrared laser exposure does not diffuse to the support and is efficiently utilized, so that the improvement of sensitivity can be contrived. Further, the image-forming layer comes to be easily peeled off the support at an unexposed area, so that on-press developability is improved.

As the undercoat layer, specifically the silane coupling agent having an addition polymerizable ethylenic double bond reactive group disclosed in JP-A-10-282679, and the phosphorus compounds having an ethylenic double bond reactive group disclosed in JP-A-2-304441 are preferred.

The coating amount of an undercoat layer (solids content) is preferably from 0.1 to 100 mg/m², more preferably from 1 to 30 mg/m².

### Protective Layer

For preventing the generation of scratches on an image forming layer, for shielding oxygen, and for preventing ablation at the time of exposure with high intensity laser, if necessary, a protective layer may be provided on the image forming layer of the lithographic printing plate precursor of the invention.

Exposure is generally performed in the air in the invention, and the protective layer prevents the mixture into the image-forming layer of low molecular weight compounds such as oxygen and basic substance in the air that hinder the image forming reaction occurring in the image-forming layer by exposure, by which the hindrance of the image-forming reaction by exposure in the air can be prevented. Accordingly, the characteristics required of the protective layer are to be low in permeability of low molecular weight compounds such as oxygen, good in transmission of light used for exposure, excellent in adhesion with an image-forming layer, and capable of being removed easily by on-press development after exposure. Protective layers having such characteristics have so far been variously examined and they are disclosed in detail, e.g., in U.S. Pat. No. 3,458,311 and JP-B-55-49729.

As the materials that are used for the protective layer, for example, water-soluble polymer compounds relatively excellent in crystallizability are exemplified. Specifically, water-soluble polymers, e.g., polyvinyl alcohol, polyvinyl pyrrolidone, acid celluloses, gelatin, gum arabic, and polyacrylic acid are exemplified. Above all, when polyvinyl alcohol (PVA) is used as the main component, the best results can be given to the fundamental characteristics such as an oxygen-shielding property and the removal by development. Polyvinyl alcohols may be partially substituted with ester, ether or acetal, or may partially contain other copolymer component so long as they contain an unsubstituted vinyl alcohol unit for imparting an oxygen-shielding property and solubility in water that are necessary to the protective layer.

As the specific examples of polyvinyl alcohols, those having a hydrolyzed rate of from 71 to 100 mol % and the degree of polymerization of from 300 to 2,400 are preferably exemplified. Specifically, PVA-105, PVA-110, PVA-117, PVA-117H, PVA-120, PVA-124, PVA-124H, PVA-CS, PVA-CST, PVA-HC, PVA-203, PVA-204, PVA-205, PVA-210, PVA-217, PVA-220, PVA-224, PVA-217EE, PVA-217E, PVA-220E, PVA-224E, PVA-405, PVA-420, PVA-613, and L-8 (manufactured by Kuraray Co., Ltd.) are exemplified.

The constituents of the protective layer (the selection of PVA, the use of additives, etc.), and the coating amounts are suitably selected by considering fogging characteristic, adhesion and scratch resistance besides the oxygen shielding property and the removal by development. In general, the higher the hydrolyzing rate of PVA (that is, the higher the unsubstituted vinyl alcohol unit content in the protective layer), and the higher the layer thickness, the higher is the oxygen-shielding property, thus advantageous in the point of sensitivity. For the prevention of the generation of unnecessary polymerization reaction during manufacture and storage, and the generation of unnecessary fog and thickening of image lines in image exposure, it is preferred that an oxygen-permeating property is not too high. Therefore, oxygen permeability A at 25° C. under 1 atm is preferably, 0.2≦A≦20 (ml/m²·day).

As other constituents of the protective layer, glycerol, dipropylene glycol and the like can be added in an amount of several mass % to the water-soluble polymer compounds to provid flexibility, and further, anionic surfactants, e.g., sodium alkylsulfate and sodium alkylsulfonate; ampholytic surfactants, e.g., alkylaminocarboxylate and alkylaminodi-carboxylate; and nonionic surfactants, e.g., polyoxyethylene alkyl phenyl ether, can be added to the (co)polymers each in an amount of several mass %.

The adhesion of a protective layer with an image part and scratch resistance are also very important in treating a lithographic printing plate precursor. That is, when a protective layer that is hydrophilic owing to the water-soluble polymer compound contained is laminated on a lipophilic image-forming layer, layer peeling of the protective layer is liable to occur by insufficient adhesion, and sometimes a defect such as film hardening failure attributing to polymerization hindrance by oxygen is caused at the peeled part.

Various countermeasures have been proposed for improving the adhesion of an image-forming layer and a protective layer. For example, it is disclosed in JP-A-49-70702 that sufficient adhesion can be obtained by mixing from 20 to 60 mass % of an acrylic emulsion or a water-insoluble vinyl pyrrolidone/vinyl acetate copolymer with a hydrophilic polymer mainly comprising polyvinyl alcohol and laminating the resulting product on an image-forming layer. Any of such well-known techniques can be used in the invention.

In the invention, the printing-out image-forming constituents (compounds discolored by the function of radicals, radical polymerization initiators, infrared absorbers) can be added to a protective layer. It is preferred to put these printing-out image-forming constituents in a protective layer not in an image-forming layer for the reason that the printing-out image-forming reaction is separated from the polymerization reaction in the image-forming layer, so that the hindrance of the other reaction can be avoided. It is also preferred that these printing-out image-forming constituents are contained in a protective layer in the form of encapsulation in microcapsules. For enhancing a printing-out image, the printing-out image-forming constituents may be added to both protective layer and image-forming layer.

Further, other functions can be imparted to a protective layer. For example, by the addition of colorants excellent in transmission of infrared rays that are used in exposure and capable of efficiently absorbing lights of other wavelengths (e.g., water-soluble dyes), safelight aptitude can be improved without causing sensitivity reduction.

The thickness of a protective layer is preferably from 0.1 to 5 μm, and particularly preferably from 0.2 to 2 μm. The coating methods of a protective layer are disclosed in detail, e.g., in U.S. Pat. No. 3,458,311 and JP-B-55-49729.

### Exposure

The lithographic printing plate precursor in the invention is used by imagewise exposure with an infrared laser.

The infrared lasers used in this time are not especially restricted, but solid state lasers and semiconductor lasers radiating the infrared rays of the wavelengths of from 760 to 1,200 nm are preferably used. The output of infrared lasers is preferably 100 mW or higher. It is preferred to use a multi-beam laser device for expediting exposure.

The exposure time per a pixel is preferably not longer than 20 μsec. The quantity of irradiation energy is preferably from 10 to 300 mJ/cm².

### Printing Method

The lithographic printing plate precursor in the invention can be used for printing after image exposure with infrared laser beams by supplying oily ink and an aqueous component without being subjected to development process.

Specifically, a method of subjecting a lithographic printing plate precursor to infrared laser exposure, and then mounting the exposed printing plate precursor on a printing press without undergoing development process and performing printing, and a method of mounting a lithographic printing plate precursor on a printing press, and then exposing the printing plate precursor with infrared laser on the printing press, and performing printing without undergoing development process are exemplified.

For example, in an embodiment of a negative on-press type lithographic printing plate precursor, when a lithographic printing plate precursor is imagewise exposed with infrared laser and printing is performed by supplying oily ink and an aqueous component without being subjected to development processing such as wet development process, the image-forming layer hardened by exposure forms an oily ink-accepting area having a lipophilic surface at the exposed area of the image-forming layer. On the other hand, at the unexposed area, an unhardened image-forming layer is dissolved or dispersed with the supplied aqueous component and/or oily ink and removed, whereby a hydrophilic surface is bared at that area.

As a result, the aqueous component adheres to the bared hydrophilic surface, the oily ink adheres to the image-forming layer in the exposed area, and printing is initiated. Here, the one that is supplied first to the printing plate may be an aqueous component or may be oily ink, but for preventing the aqueous component from becoming dirty by the image-forming layer at the unexposed area, it is preferred to supply oily ink in the first place. As the aqueous component and the oily ink, fountain solutions and oily inks used in ordinary lithographic printing are used.

Thus, the lithographic printing plate precursor is subjected to on-press development on an offset printing press and subsequently used in printing of a plenty of sheets.

### EXAMPLE

The invention will be described in more detail with reference to Examples, but the invention is not limited thereto.

### Example 1

### Manufacture of Hydrophilic Support

The following processes (a) to (k) were carried out in this order to process an aluminum plate according to JIS-A-1050 having a thickness of 0.3 mm.

(a) Mechanical Surfface Roughening Treatment

Mechanical surface roughening treatment of the aluminum plate was performed by supplying an abrasive slurry of a suspension comprising water and an abrasive (silica sand) having a specific gravity of 1.12 on the surface of the aluminum plate with a rotating roller-like nylon brush. The average particle size of the abrasive was 8 μm, and the maximum particle size was 50 μm. The material of the nylon brush was 6,10 nylon, the hair length was 50 mm, and the hair diameter was 0.3 mm. A stainless steel barrel having a diameter of 300 mm was perforated and nylon hair was planted densely to prepare a nylon brush. Three rotary brushes were used. The distance between two supporting rollers (φ200 mm) at the lower part of each brush was 300 mm. The brush rollers were pressed against the aluminum plate until the load of the driving motor rotating the brushes came to the value of the load before pressing the brush rollers against the aluminum plate plus 7 kW. The direction of rotation of brushes was the same with the moving direction of the aluminum plate. The rotation number of the brushes was 200 rpm.

(b) Alkali Etching Treatment

The above aluminum plate subjected to mechanical surface roughening treatment was subjected to spray etching treatment with an NaOH aqueous solution (concentration: 2.6 mass %, and an aluminum ion in concentration: 6.5 mass %) at 70° C., whereby 6 g/m² of the aluminum plate was dissolved. The plate was then washed with well water by spraying.

(c) Desmutting Treatment

The aluminum plate was subjected to spray desmutting treatment with an aqueous solution containing a nitric acid in concentration of 1 mass % (containing 0.5 mass % of an aluminum ion) at 30° C., and then the plate was washed with water by spraying. The aqueous solution of nitric acid used in the desmutting treatment was the waste solution in the process of electrochemical surface roughening treatment by alternating current in the nitric acid aqueous solution.

(d) Electrochemical Surface Roughening Treatment

Electrochemical surface roughening treatment was carried out continuously by alternating voltage of 60 Hz. The electrolyte at this time was an aqueous solution containing 10.5 g/liter of a nitric acid (containing 5 g/liter of an aluminum ion), and the temperature was 50° C. As the alternating current electric source waveform, trapezoidal rectangular waveform alternating current was used, the time TP required for the electric current value to reach the peak from 0 was 0.8 msec, the duty ratio was 1/1, and electrochemical surface roughening treatment was carried out with a carbon electrode as the counter electrode. Ferrite was used as the auxiliary anode. A radial cell type bath was used as the electrolytic bath. The electric current density was 30 A/dm² at the peak value of electric current, and the quantity of electricity was 220 C/dm² in the sum total of quantity of electricity in the case where the aluminum plate was the anode. Five percent of the electric current from the electric source was diverted to the auxiliary anode. The aluminum plate was then washed with well water by spraying.

(e) Alkali Etching Treatment

The aluminum plate was subjected to etching treatment by spraying with an aqueous solution comprising a sodium hydroxide in concentration of 26 mass % and an aluminum ion in concentration of 6.5 mass % at 32° C., whereby 0.20 g/m² of the aluminum plate was dissolved. A smut component mainly comprising an aluminum hydroxide which was formed when the electrochemical surface roughening treatment was performed by alternating voltage in the prior stage was removed, and also the edge parts of the pits formed were dissolved to smooth the edge parts, and then the aluminum plate was washed with well water by spraying. The etched amount was 3.5 g/m².

(f) Desmutting Treatment

Desmutting treatment by spraying was performed with an aqueous solution containing a nitric acid in concentration of 15 mass % (containing 4.5 mass % of an aluminum ion) at 30° C., and then the aluminum plate was washed with well water by spraying. The aqueous solution of nitric acid used in the desmutting treatment was the waste solution in the process of electrochemical surface roughening treatment by alternating current in the nitric acid aqueous solution.

(g) Electrochemical Surface Roughening Treatment

Electrochemical surface roughening treatment was carried out continuously by alternating voltage of 60 Hz. The electrolyte at this time was an aqueous solution containing 7.5 g/liter of a hydrochloric acid (containing 5 g/liter of an aluminum ion), and the temperature was 35° C. The alternating current electric source waveform was rectangular wave, and electrochemical surface roughening treatment was carried out with a carbon electrode as the counter electrode. Ferrite was used as the auxiliary anode. A radial cell type bath was used as the electrolytic bath. The electric current density was 25 A/dm² at the peak value of electric current, and the quantity of electricity was 50 C/dm² in the sum total of quantity of electricity in the case where the aluminum plate was the anode. The aluminum plate was then washed with well water by spraying.

(h) Alkali Etching Treatment

The aluminum plate was subjected to etching treatment by spraying with an aqueous solution comprising a sodium hydroxide in concentration of 26 mass % and an aluminum ion in concentration of 6.5 mass % at 32° C., whereby 0.10 g/m² of the aluminum plate was dissolved. A smut component mainly comprising an aluminum hydroxide which was formed when the electrochemical surface roughening treatment was performed by alternating voltage in the prior stage was removed, and also the edge parts of the pits formed were dissolved to smooth the edge parts, and then the aluminum plate was washed with well water by spraying.

(i) Desmutting Treatment

Desmutting treatment by spraying was performed with an aqueous solution containing a sulfuric acid in concentration of 25 mass % (containing 0.5 mass % of an aluminum ion) at 60° C., and then the aluminum plate was washed with well water by spraying.

(j) Anodizing Treatment

A sulfuric acid was used as the electrolyte. The electrolyte contained a sulfuric acid in concentration of 170 g/liter (containing 0.5 mass % of an aluminum ion), and the temperature was 43° C. The aluminum plate was then washed with well water by spraying. The electric current density was about 30 A/dm². The final amount of the oxide film was 2.7 g/m2.

(k) Alkali Metal Silicate Treatment

Alkali metal silicate treatment (silicate treatment) was performed by the immersion of the obtained aluminum plate in a treatment bath of 1 mass % aqueous solution of disodium trisilicate at 30° C. for 10 seconds. The aluminum plate was then washed with well water by spraying to prepare an aluminum support. The adhered amount of silicate was 3.6 mg/m².

### Formation of Image-Forming Layer

The image-forming layer coating solution (1) shown below was coated on the obtained hydrophilic support with wire bar coating and dried at 80° C. for 60 seconds, whereby an image forming layer was formed. The coating amount was 1.0 g/m².

Composition of image-forming layer coating solution (1):

| | | |
|---|---|---|
| Infrared absorbing dye (D-1) | 2 | mass parts |
| shown below | | |
| Radical polymerization initiator (I-1) | 10 | mass parts |
| shown below | | |
| Dipentaerythritol hexaacrylate | 55 | mass parts |
| (NK Ester A-DPH, manufactured by | | |
| Shin-Nakamura Chemical Co., Ltd.) | | |
| Binder polymer (B-1) shown below | 37 | mass parts |
| Compound (C-1) represented by | 10 | mass parts |
| formula (1) | | |
| Fluorine surfactant (W-1) shown below | 6 | mass parts |
| Methyl ethyl ketone | 900 | mass parts |

Infrared Absorbing Dye (D-1)

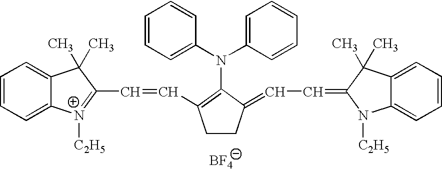

Radical Polymerization Initiator (I-1): solubility in water of 40 or more

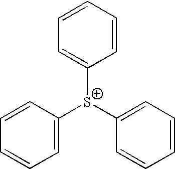

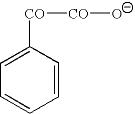

Binder Polymer (B-1)

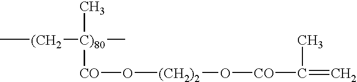

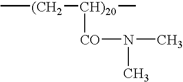

weight average molecular weight: 65,000
Fluorine Surfactant (W-1)

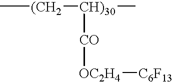

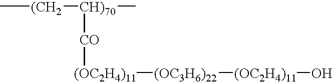

### Evaluation of Lithographic Printing Plate Precursor

The obtained lithographic printing plate precursor was subjected to image exposure with a test pattern with a plate setter (Trendsetter 3244VX, manufactured by Creo Products Incorporated) on the conditions of beam intensity of 10.2 W, and drum revolution speed of 150 rpm. The contrast between the exposed area and the unexposed area, that is, the easiness of seeing image (visibility), was evaluated. The case where discoloration was observed in the exposed area was graded “Good” and the case where discoloration was not observed in the exposed area was graded “Failure”. The exposed printing plate precursor was mounted on the cylinder of a printing press (SPRINT S26, manufactured by Komori Corporation) without development. A 4% dilute solution of the stock solution of a commercially available fountain solution (IF-102, a product manufactured by Fuji Photo Film Co., Ltd.) was supplied as the fountain solution, black ink (Values-G, manufactured by Dainippon Ink and Chemicals Inc.) was supplied as the ink, further printing papers were fed and printing was performed. The number of sheets of papers required until good printed matter could be obtained (on-press developability), and the number of sheets of papers that could be printed without generating soiling or blurring of images (press life) were evaluated. The results obtained are shown in Table 1 below.

### Example 2

A lithographic printing plate precursor was manufactured in the same manner as in Example 1 except that compound (C-2) was used in place of compound (C-1). The obtained lithographic printing plate precursor was evaluated in the same manner as in Example 1. The results obtained are shown in Table 1 below.

### Example 3

A lithographic printing plate precursor was manufactured in the same manner as in Example 1 except that compound (C-4) was used in place of compound (C-1). The obtained lithographic printing plate precursor was evaluated in the same manner as in Example 1. The results obtained are shown in Table 1 below.

### Comparative Example 1

A lithographic printing plate precursor was manufactured in the same manner as in Example 1 except that compound (C-1) was not used. The obtained lithographic printing plate precursor was evaluated in the same manner as in Example 1. The results obtained are shown in Table 1 below.

TABLE 1

| Lithographic | | On-Press | |
|---|---|---|---|
| Printing | | Developability | Press Life |
| Plate | | (number of | (number of |
| Precursor | Visibility | sheets) | sheets) |
| Example 1 | Good | 70 | 7,000 |
| Example 2 | Good | 70 | 7,000 |
| Example 3 | Good | 60 | 8,000 |
| Comparative | Failure | 70 | 7,000 |
| Example 1 | | | |

It is apparent trom the results in Table 1 that the lithographic printing plate precursors in the invention are excellent in visibility, on-press developability and press life.

### Example 4

The image-forming layer coating solution (2) shown below was coated on the support obtained in Example 1 with wire bar coating and dried at 80° C. for 60 seconds, whereby an image forming layer was formed. The coating amount was 1.0 g/m².

Composition of image-forming layer coating solution (2):

| | |
|---|---|
| Infrared absorbing dye (D-1) | 2 mass parts |
| shown above | |
| Radical polymerization initiator (I-1) | 10 mass parts |
| shown above | |
| Dipentaerythritol hexaacrylate | 55 mass parts |
| (NK Ester A-DPH, manufactured by | |
| Shin-Nakamura Chemical Co., Ltd.) | |
| Binder polymer (B-1) shown above | 37 mass parts |
| Fluorine surfactant (W-1) shown above | 6 mass parts |
| Methyl ethyl ketone | 900 mass parts |

The protective layer coating solution (1) shown below was coated on the image-forming layer (2) in a dry coating amount of 1.5 g/m² with wire bar coating and dried at 100° C. for 90 seconds, whereby a lithographic printing plate precursor was obtained.

Composition of protective layer coating solution (1):

| | | |
|---|---|---|
| Polyvinyl alcohol (degree of | 95 | mass parts |
| saponification: 98 mol %, degree of | | |
| polymerization: 500) | | |
| Polyvinyl pyrrolidone/vinyl acetate | 4 | mass parts |
| copolymer (Luvitec VA 64W, manufactured | | |
| by BASF Japan Ltd.) | | |
| Nonionic surfactant (EMALEX 710, | 1 | mass part |
| manufactured by Nihon Emulsion Co., Ltd.) | | |
| Infrared absorbing dye (D-2) shown below | 1 | mass part |
| Compound (C-9) represented by | 10 | mass parts |
| formula (1) | | |
| Pure water | 2,150 | mass parts |

Infrared Absorbing Dye (D-2)

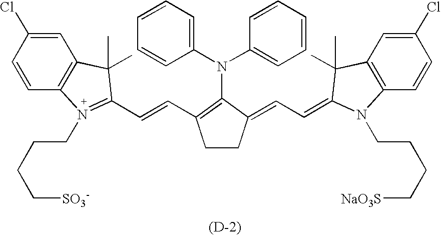

The obtained lithographic printing plate precursor was evaluated in the same manner as in Example 1. The results obtained are shown in Table 2 below.

### Example 5

A lithographic printing plate precursor was manufactured in the same manner as in Example 4 except that compound (C-10) was used in place of compound (C-9) represented by formula (1). The obtained lithographic printing plate precursor was evaluated in the same manner as in Example 1. The results obtained are shown in Table 2 below.

### Example 6

A lithographic printing plate precursor was manufactured in the same manner as in Example 4 except that compound (C-11) was used in place of compound (C-9). The obtained lithographic printing plate precursor was evaluated in the same manner as in Example 1. The results obtained are shown in Table 2 below.

### Comparative Example 2

A lithographic printing plate precursor was manufactured in the same manner as in Example 4 except that compound (C-9) was not used. The obtained lithographic printing plate precursor was evaluated in the same manner as in Example 1. The results obtained are shown in Table 2 below.

TABLE 2

| Lithographic | | On-Press | |
|---|---|---|---|
| Printing | | Developability | Press Life |
| Plate | | (number of | (number of |
| Precursor | Visibility | sheets) | sheets) |
| Example 4 | Good | 80 | 7,000 |
| Example 5 | Good | 70 | 7,000 |
| Example 6 | Good | 70 | 8,000 |
| Comparative | Failure | 80 | 7,000 |
| Example 2 | | | |

It is apparent trom the results in Table 2 that the lithographic printing plate precursors in the invention are excellent in visibility, on-press developability and press life.

### Example 7

### Preparation of Microcapsule Dispersion (1)

As the oil phase component, 10 mass parts of the 1/3 addition product (in molar ratio) of trimethylolpropane and xylylene diisocyanate (Takenate D-110N, manufactured by Mitsui Takeda Chemicals Inc., containing 25 mass % of ethyl acetate), 4 mass parts of compound (C-12), 0.6 mass parts of the following infrared absorbing dye (D-3), 1.5 mass parts of tricresyl phosphate, and 0.1 mass parts of anionic surfactant (Pionin P-A41C, manufactured by Takemoto Oil & Fat) were dissolved and dispersed in 16.5 mass parts of ethyl acetate.

As the aqueous phase component, 37.5 mass parts of a 4 mass % aqueous solution of polyvinyl alcohol (PVA-205, manufactured by Kuraray Co., Ltd.) was prepared.

The oil phase component and the aqueous phase component were mixed, and emulsified with a homogenizer at 12,000 rpm for 10 minutes while cooling with water. Water (24.5 mass parts) was added to the obtained emulsified product, and the mixture was stirred at room temperature for 30 minutes, and further stirred at 40° C. for 3 hours. The dispersion was diluted with pure water to reach the concentration of solids content of 15 mass % to prepare microcapsule dispersion (1). The average particle size of the microcapsule was 0.30 μm.

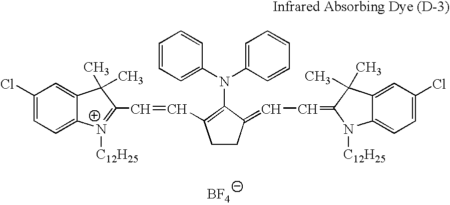

### Formation of Image-Forming Layer

In the first place, the image-forming layer coating solution (3) shown below was coated on the support obtained in Example 1 with wire bar coating and dried at 80° C. for 60 seconds, whereby an image-forming layer was formed. The coating amount was 1.0 g/m².

Composition of image-forming layer coating solution (3):

| | | |
|---|---|---|
| Infrared absorbing dye (D-1) | 2 | mass parts |
| shown above | | |
| Radical polymerization initiator (I-1) | 10 | mass parts |
| shown above | | |
| Dipentaerythritol hexaacrylate | 55 | mass parts |
| (NK Ester A-DPH, manufactured by | | |
| Shin-Nakamura Chemical Co., Ltd.) | | |
| Binder polymer (B-1) shown above | 37 | mass parts |
| Fluorine surfactant (W-1) shown above | 1 | mass part |
| Methyl ethyl ketone | 900 | mass parts |

In the next place, the protective layer coating solution (2) shown below was coated on the image-forming layer (3) in a dry coating amount of 1.5 g/m² with wire bar coating and dried at 100° C. for 90 seconds, whereby a lithographic printing plate precursor was obtained. The obtained lithographic printing plate precursor was evaluated in the same manner as in Example 1. The results obtained are shown in Table 3 below.

Composition of protective layer coating solution (2):

| | | |
|---|---|---|
| Polyvinyl alcohol (degree of | 95 | mass parts |
| saponification: 98 mol %, degree of | | |
| polymerization: 500) | | |
| Polyvinyl pyrrolidone/vinyl acetate | 4 | mass parts |
| copolymer (Luvitec VA 64W, manufactured | | |
| by BASF Japan Ltd.) | | |
| Nonionic surfactant (EMALEX 710, | 1 | mass part |
| manufactured by Nihon Emulsion Co., | | |
| Ltd.) | | |
| Microcapsule dispersion (1) | 1,000 | mass parts |
| Pure water | 2,150 | mass parts |

### Example 8

The image-forming layer coating solution (4) shown below was coated on the support obtained in Example 1 with wire bar coating and dried at 80° C. for 60 seconds to form an image-forming layer. The coating amount was 1.0 g/m². The obtained lithographic printing plate precursor was evaluated in the same manner as in Example 1. The results obtained are shown in Table 3 below.

Composition of image-forming layer coating solution (4):

| | | |
|---|---|---|
| Infrared absorbing dye (D-1) | 2 | mass parts |
| shown above | | |
| Radical polymerization initiator (I-1) | 10 | mass parts |
| shown above | | |
| Dipentaerythritol hexaacrylate | 40 | mass parts |
| (NK Ester A-DPH, manufactured by | | |
| Shin-Nakamura Chemical Co., Ltd.) | | |
| Binder polymer (B-1) shown above | 16 | mass parts |
| Microcapsule dispersion (1) | 300 | mass parts |
| shown above | | |
| Fluorine surfactant (W-1) shown above | 1 | mass part |
| Methyl ethyl ketone | 100 | mass parts |
| 1-Methoxy-2-propanol | 850 | mass parts |
| Pure water | 200 | mass parts |

TABLE 3

| Lithographic | | On-Press | |
|---|---|---|---|
| Printing | | Developability | Press Life |
| Plate | | (number of | (number of |
| Precursor | Visibility | sheets) | sheets) |
| Example 7 | Good | 30 | 10,000 |
| Example 8 | Good | 30 | 10,000 |

It is apparent trom the results in Table 3 that the lithographic printing plate precursors in the invention are excellent in visibility, on-press developability and press life.

### Example 9

### Manufacture of Aluminum Support

For removing the rolling oil of the surface, an aluminum plate having a thickness of 0.3 mm (material 1050) was subjected to degreasing treatment with a 10 mass % sodium alminate aqueous solution at 50° C. for 30 seconds, and after degreasing the aluminum surface was subjected to brush-graining with three nylon brushes planted with hairs having a hair diameter of 0.3 mm and a suspension of pumice stone and water of a median diameter of 25 μm (the specific gravity: 1.1 g/cm³), and the surface of the plate was thoroughly washed with water. The plate was immersed in a 25% sodium hydroxide aqueous solution at 45° C. for 9 seconds for etching, and then washed with water. After water washing, the plate was further immersed in a 20% nitric acid aqueous solution at 60° C. for 20 seconds, followed by washing with water. The etched amount of the surface by graining was about 3 g/m².

Electrochemical surface roughening treatment was performed continuously by alternating voltage of 60 Hz. The electrolyte at this time was an aqueous solution containing 1 mass % of a nitric acid (containing a 0.5 mass % of an aluminum ion) and the liquid temperature was 50° C. As the alternating current electric source waveform, trapezoidal rectangular waveform alternating current was used, the time TP required for the electric current value to reach the peak from 0 was 0.8 msec, the duty ratio was 1/1, and electrochemical surface roughening treatment was performed with a carbon electrode as the counter electrode. Ferrite was used as the auxiliary anode. The electric current density was 30 A/dm² at a peak value of electric current, and 5% of the electric current from the electric source was diverted to the auxiliary anode. The quantity of electricity was 175 C/dm² in the quantity of electricity in the case where the aluminum plate was the anode. The aluminum plate was then washed with water by spraying.

Subsequently, electrochemical surface roughening treatment of the aluminum plate was performed in the same manner as in the above nitric acid electrolysis with an electrolyte containing a 0.5 mass % hydrochloric acid aqueous solution (containing 0.5 mass % of an aluminum ion) at a liquid temperature of 50° C. on the condition of 50 C/dm² of the quantity of electricity in the case where the aluminum plate was the anode, and the plate was then subjected to spray washing. The plate was provided with 2.5 g/m² of a direct current anodic oxide film with a 15% sulfuric acid aqueous solution (containing 0.5 mass % of an aluminum ion) as the electrolyte and the electric current density of 15 A/dm², washed with water, dried, and further subjected to treatment with a 2.5 mass % sodium silicate aqueous solution at 30° C. for 10 seconds. The central line average surface roughness (Ra) of the plate measured with a needle having a diameter of 2 μm was 0.51 μm.

### Formation of Undercoat Layer

The undercoat layer coating solution (1) having the composition shown below was coated on the above support with bar coating, dried at 80° C. for 20 seconds in an oven, whereby an undercoat layer having a dry coating weight of 0.005 g/m² was formed.

Undercoat layer coating solution (1):

| | | |
|---|---|---|
| Water | 10 | g |
| Methanol | 90 | g |
| Polymer (1) shown below | 0.09 | g |

Polymer (1)

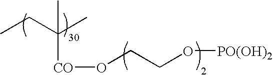

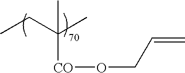

The image-forming layer coating solution (5) having the composition shown below was coated on the above undercoat layer with bar coating, dried at 70° C. for 60 seconds in an oven, whereby an image-forming layer having a dry coating weight of 1.0 g/m² was formed, whereby a lithographic printing plate precursor was obtained.

Image-forming layer coating solution (5):

| | |
|---|---|
| Water | 50 g |
| Propylene glycol monomethyl ether | 50 g |
| Microcapsule dispersion (2) shown below | 6 g |
| (in terms of solids content) | |
| Microcapsule dispersion (3) shown below | 2.5 g |
| (in terms of solids content) | |
| Radical polymerization initiator (I-1) | 1 g |
| shown above | |
| Isocyanuric acid EO-modified triacrylate | 0.5 g |
| (NK Ester M-315, manufactured by | |
| Shin-Nakamura Chemical Co., Ltd.) | |
| Fluorine surfactant (W-1) shown above | 0.1 g |

### Preparation of Microcapsule (2)

As the oil phase component, 8.7 g of the addition product of trimethylolpropane and xylylene diisocyanate (Takenate D-110N, manufactured by Mitsui Takeda Chemicals Inc.), 1 g of 2-methacryloyloxyethyl isocyanate (Karenz MOI, manufactured by Showa Denko K.K.), 5.5 g of isocyanuric acid EO-modified triacrylate (NK Ester M-315, manufactured by Shin-Nakamura Chemical Co., Ltd.), 0.5 g of infrared absorbing dye (D-3), and 0.1 g of sodium dodecylbenzenesulfonate (Pionin A-41C, manufactured by Takemoto Oil & Fat) were dissolved in 17 g of ethyl acetate. As the aqueous phase component, 40 g of a 4 mass % aqueous solution of PVA-205 was prepared. The oil phase component and the aqueous phase component were mixed, and emulsified with a homogenizer at 12,000 rpm for 10 minutes. Distilled water (25 g) was added to the obtained emulsified product, and the mixture was stirred at room temperature for 30 minutes, and then at 40° C. for 3 hours. The concentration of the solids content of the obtained microcapsule solution was diluted to reach 20 mass % with distilled water. The average particle size was 0.3 μm.

### Synthesis of 1,3-Dihydro-6′-piperidino-1,3,3-trimethylspiro-[2H-indole-2,3′-[3H]-naphtho[2,1-b][1,4]oxazine]

1-Nitroso-2-naphthol (130 g) was dissolved in 1,000 ml of methanol, and while refluxing with heating, 150 ml of methanol solution containing 128 g of piperidine was dripped to the above solution over 30 minutes, followed by refluxing with heating for 1 hour. A methanol solution (375 ml) containing 130 g of 2-methylene-1,3,3-trimethylindoline was added to the above solution. After refluxing the reaction solution for 6 hours with heating, the precipitated crystals were filtered. The filtered crystals were re-slurried three times with 1 liter of acetone, whereby 27 g of pale violet crystals of 1,3-dihydro-6′-piperidino-1,3,3-trimethylspiro-[2H-indole-2,3′-[3H]-naphtho[2,1-b][1,4]oxazine] having the structure shown below was obtained.

### 1,3-Dihydro-6′-piperidino-1,3,3-trimethylspiro-[2H-indole-2,3′-[3H]-naphtho[2,1-b][1,4]oxazine]

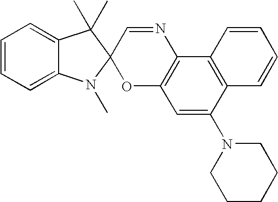

### Preparation of Microcapsule Dispersion (3)

As the oil phase component, 10 g of the addition product of trimethylolpropane and xylylene diisocyanate (Takenate D-110N, manufactured by Mitsui Takeda Chemicals Inc.), 5 g of 1,3-dihydro-6′-piperidino-1,3,3-trimethylspiro-[2H-indole-2,3′-[3H]-naphtho[2,1-b][1,4]oxazine], 1.0 g of an acid generator (1) shown below, 0.5 g of the above infrared absorbing dye (D-3), and 0.1 g of sodium dodecylbenzenesulfonate (Pionin A-41C, manufactured by Takemoto Oil & Fat) were dissolved in 17 g of ethyl acetate. As the aqueous phase component, 40 g of a 4 mass % aqueous solution of PVA-205 was prepared. The oil phase component and the aqueous phase component were mixed, and emulsified with a homogenizer at 12,000 rpm for 10 minutes. Tetraethylenepentamine (0.38 g) and 25 g of distilled water were added to the obtained emulsified product, and the mixture was stirred at room temperature for 30 minutes, and then at 65° C. for 3 hours. The concentration of the solids content of the obtained microcapsule solution was diluted to reach 20 mass % with distilled water. The average particle size was 0.3 μm.

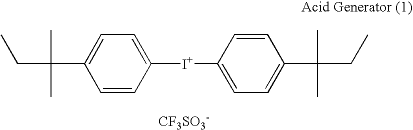

### Example 10

A lithographic printing plate precursor was manufactured in the same manner as in Example 9 except that the image-forming layer coating solution (6) having the composition shown below was coated with bar coating and dried at 100° C. for 60 seconds in an oven to form an image-forming layer having a dry coating weight of 1.0 g/m².

Composition of image-forming layer coating solution (6):

| | | |
|---|---|---|
| Infrared absorbing dye (D-3) shown above | 0.3 | g |
| Radical polymerization initiator (I-1) | 0.9 | g |
| shown above | | |
| Acid generator (1) shown above | 0.9 | g |
| Binder polymer (B-2) shown below | 2.5 | g |
| Polymerizable monomer | 5.4 | g |
| Isocyanuric acid EO-modified triacrylate | | |
| (NK Ester M-315, manufactured by Shin-Naka- | | |
| mura Chemical Co., Ltd.) | | |
| 1,3-Dihydro-6′-piperidino-1,3,3-trimethylspiro- | 0.8 | g |
| [2H-indole-2,3′-[3H]-naphtho[2,1-b]]1,4]oxazine] | | |
| Fluorine surfactant (W-1) shown above | 0.1 | g |
| Methanol | 4 | g |
| Methyl ethyl ketone | 96 | g |

Binder Polymer (B-2)

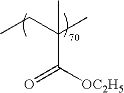

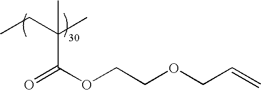

### Example 11

A lithographic printing plate precursor was manufactured in the same manner as in Example 9 except that the image-forming layer coating solution (7) having the composition shown below was coated in place of the image-forming layer coating solution (5) with bar coating and dried at 80° C. for 60 seconds in an oven to form an image-forming layer having a dry coating weight of 1.0 g/m².

Composition of image-forming layer coating solution (7):

| | |
|---|---|
| Infrared absorbing dye (D-2) shown above | 0.3 g |
| Radical polymerization initiator (I-1) | 0.9 g |
| shown above | |
| Binder polymer (B-2) shown above | 2.5 g |
| Polymerizable monomer | 5.4 g |
| Pentaerythritol triacrylate (SR444, | |
| manufactured by Nippon Kayaku Co., Ltd.) | |
| Microcapsule Dispersion (3) shown above | 2.5 g |
| (in terms of solids content) | |
| Fluorine surfactant (W-1) shown above | 0.1 g |
| Methanol | 10 g |
| Water | 35 g |
| Propylene glycol monomethyl ether | 50 g |

### Example 12

A lithographic printing plate precursor was manufactured in the same manner as in Example 9 except that the image-forming layer coating solution (8) having the composition shown below was coated in place of the image-forming layer coating solution (5) with bar coating and dried at 100° C. for 60 seconds in an oven to form an image-forming layer having a dry coating weight of 1.0 g/m².

Composition of image-forming layer coating solution (8):

| | |
|---|---|
| Infrared absorbing dye (D-2) shown above | 0.3 g |
| Radical polymerization initiator (I-1) | 0.9 g |
| shown above | |
| Binder polymer (B-2) shown above | 1.8 g |
| Polymerizable monomer | 2.0 g |
| Pentaerythritol triacrylate (SR444, | |
| manufactured by Nippon Kayaku Co., Ltd.) | |
| Microcapsule Dispersion (3) shown above | 2.5 g |
| (in terms of solids content) | |
| Microcapsule Dispersion (4) shown below | 2.5 g |
| (in terms of solids content) | |
| Fluorine surfactant (W-1) shown above | 0.1 g |
| Methanol | 10 g |
| Water | 35 g |
| Propylene glycol monomethyl ether | 50 g |

### Preparation of Microcapsule Dispersion (4)

As the oil phase component, 8.7 g of the addition product of trimethylolpropane and xylylene diisocyanate (Takenate D-110N, manufactured by Mitsui Takeda Chemicals Inc.), 1 g of 2-methacryloyloxyethyl isocyanate (Karenz MOI, manufactured by Showa Denko K.K.), 6 g of pentaerythritol triacrylate (SR444, manufactured by Nippon Kayaku Co., Ltd.), and 0.1 g of sodium dodecylbenzenesulfonate (Pionin A-41C, manufactured by Takemoto Oil & Fat) were dissolved in 17 g of ethyl acetate. As the aqueous phase component, 40 g of a 4 mass % aqueous solution of PVA-205 was prepared. The oil phase component and the aqueous phase component were mixed, and emulsified with a homogenizer at 12,000 rpm for 10 minutes. Distilled water (25 g) was added to the obtained emulsified product, and the mixture was stirred at room temperature for 30 minutes, and then at 40° C. for 3 hours. The concentration of the solids content of the obtained microcapsule solution was diluted to reach 20 mass % with distilled water. The average particle size was 0.3 μm.

### Example 13

A lithographic printing plate precursor was manufactured in the same manner as in Example 12 except that the protective layer coating solution (3) having the composition shown below was further coated on the image-forming layer in Example 12 with wire bar coating and dried at 100° C. for 60 seconds to form a protective layer having a dry coating weight of 0.5 g/m².

Composition of protective layer coating solution (3):

| | |
|---|---|
| Polyvinyl alcohol | 1.0 g |
| (degree of saponification: 98.5%) | |
| (PVA105, manufactured by Kuraray Co., Ltd.) | |
| Polyoxyethylene lauryl ether | 0.01 g |
| (EMALEX 710, manufactured by Nihon | |
| Emulsion Co., Ltd.) | |
| Water | 19.0 g |

### Comparative Example 3

A lithographic printing plate precursor was manufactured in the same manner as in Example 9 except that the microcapsule dispersion (3) in the image-forming layer coating solution (5) was entirely replaced with the microcapsule dispersion (5) shown below.

### Preparation of Microcapsule Dispersion (5)

As the oil phase component, 10 g of the addition product of trimethylolpropane and xylylene diisocyanate (Takenate D-110N, manufactured by Mitsui Takeda Chemicals Inc.), 5 g of 1′,3′,3′-trimethylspiro[indoline-2,3′-[3H]naphtho[2,1-b]-[1,4]oxazine] (manufactured by Tokyo Kasei Kogyo Co., Ltd.), 1.0 g of the above acid generator (1), 0.5 g of infrared absorbing dye (D-3), and 0.1 g of sodium dodecylbenzenesulfonate (Pionin A-41C, manufactured by Takemoto Oil & Fat) were dissolved in 17 g of ethyl acetate. As the aqueous phase component, 40 g of a 4 mass % aqueous solution of PVA-205 was prepared. The oil phase component and the aqueous phase component were mixed, and emulsified with a homogenizer at 12,000 rpm for 10 minute. Tetraethylenepentamine (0.38 g) and 25 g of distilled water were added to the obtained emulsified product, and the mixture was stirred at room temperature for 30 minutes, and then at 65° C. for 3 hours. The concentration of the solids content of the obtained microcapsule solution was diluted to reach 20 mass % with distilled water. The average particle size was 0.3 μm.

### Comparative Example 4

A lithographic printing plate precursor was manufactured in the same manner as in Example 10 except that the image forming layer coating solution (6) was replaced with the image-forming layer coating solution (9) having the composition shown below.

Composition of image-forming layer coating solution (9):

| | |
|---|---|
| Infrared absorbing dye (D-3) shown above | 0.3 g |
| Radical polymerization initiator (I-1) | 0.9 g |
| shown above | |
| Acid generator (1) shown above | 0.9 g |
| Binder polymer (B-2) shown above | 2.5 g |
| Polymerizable monomer | 5.4 g |
| Isocyanuric acid EO-modified triacrylate | |
| (NK Ester M-315, manufactured by Shin-Nakamura | |
| Chemical Co., Ltd.) | |
| 1′,3′,3′-Trimethylspiro[indoline-2,3′- | 5.0 g |
| [3H]naphtho[2,1-b][1,4]oxazine] | |
| (manufactured by Tokyo Kasei Kogyo | |
| Co., Ltd.) | |
| Fluorine surfactant (W-1) shown above | 0.1 g |
| Methanol | 4.0 g |
| Methyl ethyl ketone | 96 g |

### Comparative Example 5

A lithographic printing plate precursor was manufactured in the same manner as in Example 11 except that the microcapsule dispersion (3) in the image-forming layer coating solution (7) was entirely replaced with the microcapsule dispersion (5) shown above.

### Comparative Example 6

A lithographic printing plate precursor was manufactured in the same manner as in Example 11 except that the microcapsule dispersion (3) in the image-forming layer coating solution (8) was entirely replaced with the microcapsule dispersion (5) shown above.

### Comparative Example 7

A lithographic printing plate precursor was manufactured in the same manner as in Comparative Example 6 except that the protective layer coating solution (3) shown above was further coated on the image-forming layer in Comparative Example 6 with wire bar coating and dried at 100° C. for 60 seconds to form a protective layer having a dry coating weight of 0.5 g/m².

### Evaluation of Lithographic Printing Plate Precursors in Examples 9 to 13 and Comparative Examples 3 to 8

1. Measurement of the Difference in Color Brightness (ΔL) Between the Exposed Area and the Unexposed Area (Evaluation of Printing-Out Image)

Each lithographic printing plate precursor obtained was subjected to exposure with Trendsetter 3244VX (manufactured by Creo Products Incorporated) loading a water-cooling type 40 W infrared semiconductor laser on the conditions of the quantity of exposure energy on printing plate shown in Table 4 below, and the resolution of 2,400 dpi.

For the evaluation of printing out image, L* values in the exposed area and the unexposed area were measured with a color difference meter (Color difference meter CR-221, manufactured by KONICA MINOLTA HOLDINGS, INC.), and the difference in color brightness ΔL was searched from the absolute value of color difference.

The results obtained are shown in Table 4 in the indexes with the ΔL value in Example 9 of the invention as reference (100). The greater the ΔL index, the higher is the visibility and preferred.

As is apparent trom the results in Table 4, the lithographic printing plate precursors in the invention are good in the contrast between the exposed area and the unexposed area and fine lines and letters can be recognized.

2. Evaluation of On-Press Developability and Printing

The exposed printing plate precursor was mounted on the cylinder of printing press SOR-M (manufactured by Heidelberg Japan K.K.) without development process. A hundred of sheets were printed at a printing speed of 6,000 sheets per hour after supplying a fountain solution and ink. As the fountain solution and ink, a fountain solution comprising EU-3 (an etching solution manufactured by Fuji Photo Film Co., Ltd.)/water/isopropyl alcohol=1/89/10 (by volume) and TRANS-G (N) Chinese ink (manufactured by Dainippon Ink and Chemicals Inc.) were used respectively.

When the number of sheets required until the ink did not transfer to a printing paper after completion of the on-press development of the unexposed area of an image-forming layer were counted as on-press developability, a printed matter free from soiling of the non-image area could be obtained within 100 sheets of paper with the lithographic printing plate precursors of the invention.

Subsequently, 5,000 sheets of paper were printed. Good printed substances free from reductions of ink density in the image area and soiling in the non-image area could be obtained when the lithographic printing plate precursors of the invention were used.

TABLE 4
Results of Measurement of Difference in Color Brightness (ΔL)

| Lithographic | | Difference |
|---|---|---|
| Printing | Exposure | in Color |
| Plate | Energy | Brightness |
| Precursor | (mJ/cm²) | (ΔL) |
| Example 9 | 100 | 100 |
| Example 10 | 100 | 110 |
| Example 11 | 100 | 115 |
| Example 12 | 100 | 110 |
| Example 13 | 100 | 105 |
| Comparative | 100 | 20 |
| Example 3 | | |
| Comparative | 100 | 25 |
| Example 4 | | |
| Comparative | 100 | 25 |
| Example 5 | | |
| Comparative | 100 | 25 |
| Example 6 | | |
| Comparative | 100 | 25 |
| Example 7 | | |

This application is based on Japanese patent applications JP 2004-346976, filed on Nov. 30, 2004 and JP 2005-023390, filed on Jan. 31, 2005, the entire content of which is hereby incorporated by reference, the same as if set forth at length.

What is claimed is:

1. A lithographic printing plate precursor comprising a support and a layer containing a compound discolored by heat and represented by the following formula (1): 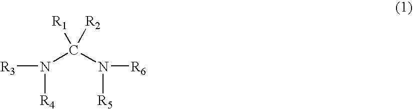
wherein R₁, R₂, R₃, R₄, R₅ and R₆ each represents a hydrogen atom, an alkyl group, an aryl group, an alkenyl group, an alkynyl group, an acyl group, an alkyloxy group, an alkenyloxy group, an alkynyloxy group, an aryloxy group, a sulfonyl group, a sulfinyl group, an alkoxycarbonyl group, an aryloxycarbonyl group, an alkylthio group, an arylthio group, an acyloxy group, a sulfonyloxy group, a carbamoyloxy group, an amino group, an imino group, a carbamoyl group, a sulfamoyl group, a hydroxyl group, a nitro group, a cyano group, a carboxyl group or a heterocyclic group, and arbitrary combination of R₁ to R₄ may be bonded to form a ring, provided that R₅ and R₆ may be bonded to each other to form a ring together, but R₅ and R₆ do not form a ring with any of R₁ to R₄.

2. The lithographic printing plate precursor as claimed in claim 1, wherein the compound discolored by heat and represented by formula (1) is represented by the following formula (1a): 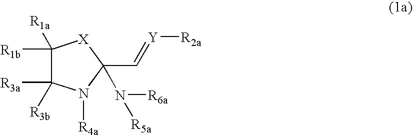
wherein R₁ₐ, R_{1b}, R₃ₐ and R_{3b} each represents a hydrogen atom, an alkyl group, an aryl group, an alkenyl group, an alkynyl group, an acyl group, an alkyloxy group, an alkenyloxy group, an alkynyloxy group, an aryloxy group, a sulfonyl group, a sulfinyl group, an alkoxycarbonyl group, an aryloxycarbonyl group, an alkylthio group, an arylthio group, an acyloxy group, a sulfonyloxy group, a carbamoyloxy group, an amino group, a carbamoyl group, a sulfamoyl group, a hydroxyl group, a nitro group, a cyano group, a carboxyl group, a heterocyclic group, or a halogen atom, and R₁ₐ, R_{1b}, R₃ₐ and R_{3b} may be bonded to each other to form a ring; R₂ₐ represents an alkyl group, an aryl group, an alkenyl group, an alkynyl group, an acyl group, an alkyloxy group, an alkenyloxy group, an alkynyloxy group, an aryloxy group, a sulfonyl group, a sulfinyl group, an alkoxycarbonyl group, an aryloxycarbonyl group, an alkylthio group, an arylthio group, an acyloxy group, a sulfonyloxy group, a carbamoyloxy group, an amino group, a carbamoyl group, a sulfamoyl group, a hydroxyl group, a nitro group, a cyano group, a carboxyl group, a heterocyclic group, or a halogen atom; R₄ₐ represents an alkyl group or an aryl group; R₅ₐ and R₆ₐ each represents a hydrogen atom or an alkyl group, and R₅ₐ and R₆ₐ may be bonded to each other to form a ring; X represents —C(CH₃)₂—, —O—, —S— or —N(R₇ₐ)—; R₇ₐ represents an alkyl group, an aryl group, an alkenyl group, an alkynyl group, an acyl group, an alkyloxy group, an alkenyloxy group, an alkynyloxy group, an aryloxy group, a sulfonyl group, a sulfinyl group, an alkoxycarbonyl group, an aryloxycarbonyl group, an alkylthio group, an arylthio group, an acyloxy group, a sulfonyloxy group, a carbamoyloxy group, an amino group, a carbamoyl group, a sulfamoyl group, a hydroxyl group, a nitro group, a cyano group, a carboxyl group, a heterocyclic group, or a halogen atom; and Y represents ═CH— or ═N—.

3. The lithographic printing plate precursor as claimed in claim 1, wherein the layer containing the compound discolored by heat and represented by formula (1) further contains an infrared absorber.

4. The lithographic printing plate precursor as claimed in claim 3, wherein the layer containing the compound discolored by heat and represented by formula (1) further contains a radical polymerization initiator and a radical polymerizable monomer.

5. The lithographic printing plate precursor as claimed in claim 4, wherein at least one of the compound discolored by heat and represented by formula (1), the infrared absorber, the radical polymerization initiator and the radical polymerizable monomer is encapsulated in a microcapsule.

6. The lithographic printing plate precursor as claimed in claim 1, which is capable of printing by being mounted on a printing press without undergoing development processing after image recording, or by image recording after being mounted on a printing press.

7. A lithographic printing plate precursor comprising a support and an image-forming layer containing a compound represented by the following formula (2): 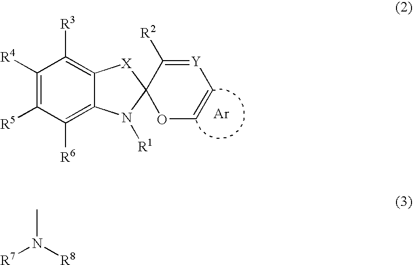
wherein X represents —C(CH₃)₂—, —S—, —SO₂—, —O—, —Se—, —Te— or —N(R¹)—; Y represents ═CH— or ═N—; Ar represents an aromatic ring or a heterocyclic aromatic ring, which contain at least one of an alkyloxy group, an aryloxy group, an alkylthio group, an arylthio group and a group represented by the above formula (3) in the ring; R², R³, R⁴, R⁵ and R⁶ each represents a hydrogen atom, an alkyl group, an alkenyl group, an alkynyl group, an alkyloxy group, an aryloxy group, an alkylcarbonyloxy group, an arylcarbonyloxy group, a hydroxyl group, an alkylthio group, an arylthio group, a mercapto group, an alkylcarbonyl group, an arylcarbonyl group, an alkyloxycarbonyl group, an aryloxycarbonyl group, a carboxyl group, an amino group, a cyano group, a nitro group, an amido group, a sulfo group, an alkylsulfonyl group, an arylsulfonyl group, an alkyloxy-sulfonyl group, an aryloxysulfonyl group, an alkylsulfonyloxy group, an arylsulfonyloxy group, a silyl group, a urea group, a urethane group or a halogen atom; R¹ represents a hydrogen atom, an alkyl group, an aryl group, an alkylcarbonyl group, an arylcarbonyl group, an alkyloxycarbonyl group, an aryloxycarbonyl group, a carboxyl group, a sulfo group, an alkylsulfonyl group, an arylsulfonyl group, an alkyloxy-sulfonyl group, an aryloxysulfonyl group, or a silyl group; R³ and R⁴, R⁴ and R⁵, R⁵ and R⁶, and R⁶ and R¹ may be bonded to each other to form a ring; and R⁷ and R⁸ each represents a hydrogen atom, an alkyl group, an aryl group, an alkylcarbonyl group, an arylcarbonyl group, an alkyloxycarbonyl group, an aryloxycarbonyl group, a carboxyl group, a sulfo group, an alkylsulfonyl group or an arylsulfonyl group, and R⁷ and R⁸ may be bonded to each other to form a ring.

8. The lithographic printing plate precursor as claimed in claim 7, wherein the image-forming layer further contains an acid generator.

9. The lithographic printing plate precursor as claimed in claim 7, wherein the image-forming layer is an image-forming layer capable of image recording upon infrared laser exposure, and the lithographic printing plate precursor is capable of printing by being mounted on a printing press without undergoing development processing after image recording, or by image recording after being mounted on a printing press.

10. The lithographic printing plate precursor as claimed in claim 7, wherein the image-forming layer further contains an infrared absorber, a radical polymerization initiator and a radical polymerizable monomer.

11. The lithographic printing plate precursor as claimed in claim 7, wherein at least one component contained in the image-forming layer is encapsulated in a microcapsule.

12. A plate-making method of a lithographic printing plate precursor, which comprises: mounting the lithographic printing plate precursor claimed in claim 7 on a printing press and imagewise exposing with an infrared laser or mounting the lithographic printing plate precursor on a printing press after imagewise exposure with an infrared laser; and then supplying printing ink and a fountain solution to the lithographic printing plate precursor to remove the infrared laser-unexposed area of the image-forming layer.

13. A lithographic printing method comprising: mounting the lithographic printing plate precursor claimed in claim 1 on a printing press and imagewise exposing with an infrared laser or mounting the lithographic printing plate precursor on a printing press after imagewise exposure with an infrared laser; supplying printing ink and a fountain solution to the lithographic printing plate precursor to remove the infrared laser-unexposed area of the image-forming layer; and performing printing with the obtained printing plate.

14. A lithographic printing method comprising: mounting the lithographic printing plate precursor claimed in claim 7 on a printing press and imagewise exposing with an infrared laser or mounting the lithographic printing plate precursor on a printing press after imagewise exposure with an infrared laser; supplying printing ink and a fountain solution to the lithographic printing plate precursor to remove the infrared laser-unexposed area of the image-forming layer; and performing printing with the obtained printing plate.
